(19) United States
(12) Patent Application Publication
(10) Pub. No.: US 2020/0268210 A1
(43) Pub. Date: Aug. 27, 2020

(54) Automatic kitchen system

(71) Applicant: Zhengxu He, Reno, NV (US)

(72) Inventor: Zhengxu He, Reno, NV (US)

(21) Appl. No.: 16/517,705

(22) Filed: Jul. 22, 2019

Related U.S. Application Data
(60) Provisional application No. 62/810,280, filed on Feb. 25, 2019.

(51) Int. Cl. A47J 44/00; A47J 47/02; A47J 36/32; A47J 47/01; B25J 11/00

(52) U.S. Cl. CPC A47J 44/00; A47J 47/02; B25J 11/0045; A47J 47/01; A47J 36/32

(57) ABSTRACT

The present application discloses an automated kitchen system comprising: a plurality of ingredient containers configured to contain or otherwise hold food ingredients; storage apparatuses comprising compartments configured to store ingredient containers; cap opening apparatuses configured to remove a cap from a container; transfer apparatuses configured to move a capped ingredient container from a storage apparatus to the cap opening apparatus; cooking systems configured to make cooked foods; a transport system comprising rail tracks and vehicles moving on the rail tracks configured to move ingredient containers, stopping mechanisms, charging mechanisms, and track switch mechanisms. The above mechanisms and apparatuses comprise electrical or electronic devices and sensors, which are configured to be connected to a computer system. The automated kitchen system saves labor cost and make cooked foods of consistent quality.

This application claims the benefit of U.S. Provisional Application Ser. No. 62/810,280, filed Feb. 25, 2019. Entire contents of the above application are incorporated herein by reference.

### CROSS-REFERENCE TO RELATED APPLICATIONS

### Us Provisional Patent Applications:

Ser. No. 62/810,280; Filed Feb. 25, 2019; Inventor: Zhengxu He.

### Us Patent Applications:

Ser. No. 16/155,895, filed on Oct. 10, 2018; Inventor: Zhengxu He.

### BACKGROUND OF THE INVENTION

The present application relates to automatic control techniques for storage, transportation and dispensing of food ingredients into a cookware of a cooking apparatus, and the related automatic control techniques in an automated kitchen.

During cooking of a food item, some ingredients need to be dispensed into a cookware. Traditionally, in commercial settings, food ingredients are packaged into plastic bags or other containers. They are transported to a storage (often a refrigerator) in a kitchen. Afterwards, these containers are partially, or entirely, handled by humans. The task of obtaining a certain quantity of a type of food ingredients from a large container is very hard and expensive to automate.

One may use vehicles and conveyors to transport a cooked food, with a human handling the loading and dispensing of food containers. Due to cost savings or the necessity to improve food safety, it is desirable to automate the process of transferring and dispensing of the food ingredients from the storage area to a cookware. Furthermore, there is a need for an algorithm to control this and related processes. In our invention, vehicles are used to transport food ingredients, and the loading and dispensing are fully automated.

### BRIEF SUMMARY OF THE INVENTION

The food ingredients are often prepared or processed at a processing location and then transported to a storage area (often refrigerated) in a kitchen, and then transferred out of the storage area and dispensed into a cookware during cooking. Our automated kitchen system may comprise one or more of the following: ingredient containers which may be capped with caps as to preserve freshness of ingredients; transport boxes to contain or otherwise hold capped ingredient containers; a transport apparatus configured to move the transport boxes; a storage apparatus comprising a plurality of compartments each configured to store capped ingredient containers; a cap opening apparatus configured to remove the cap from a container; a transfer apparatus configured to move an ingredient container from a storage apparatus or from a transport box to the cap opening location; and a transport system comprising (mini) vehicles; rail tracks for said vehicles.

The automated kitchen system comprises a plurality of cooking systems, each comprising one or more of the following: a cooking apparatus comprising a cookware configured to contain or otherwise hold food or food ingredients; a stirring motion mechanism configured to produce a motion in the cookware as to stir, mix or distribute the food or food ingredients contained in the cookware during a cooking process; and a dispensing apparatus configured to dispense the food ingredients from a container which is located at a certain position into the cookware.

Each apparatus or mechanism of the automated kitchen system may comprise: electrical or electronic devices including but not limited to: motors, refrigeration mechanisms, shut-off valves; inductive or other types of stoves, vacuum generators, etc.; sensors including but not limited to encoders, pressure sensors, locational sensors, infrared sensors, temperature sensors or other sensors.

The automated cooking system may further comprise a computer system comprising a first computer and a plurality of second computers (e.g., microcontrollers or programmable logic controllers commonly known as PLCs), wherein each second computer is configured to be connected to the first computer by wires or by wireless means so that the second computer may communicate with the first computer. Each second computer is configured to be connected to some electrical or electronic devices and sensors, so that the second computer may send and/or receive electrical or electronic signals to and/or from said devices and sensors.

Depending on the type of the electrical or electronic device(s), the connection between a second computer and an electrical or electronic device comprises a wire, a wireless communication device, a controller, a driver, a relay, a breaker, a contractor, and/or a switch. These components may be housed in an electrical cabinet.

In another general aspect, the present invention relates to an algorithm which may control the electrical or electronic devices via the computers.

These and other aspects, their implementations and other features are described in detail in the drawings, the description and the claims.

### BRIEF DESCRIPTION OF THE SEVERAL VIEWS OF THE DRAWINGS

FIG. 1A shows an aerial view of a computer comprising a plurality of input/output ports. FIG. 1B shows an aerial view of another computer which further comprises a plurality of input/output ports. FIG. 1C shows an aerial view of a computer system.

FIG. 2A shows an aerial view of a proximity switch and a target wherein the proximity switch senses the target. FIG. 2B shows an aerial view of a proximity switch.

FIG. 3A shows a side view of an ingredient container. FIG. 3B shows an aerial view of a cap. FIG. 3C shows an aerial view of a cap.

FIG. 4A shows a side view of a capped ingredient container. FIG. 4B shows a side view of a capped ingredient container.

FIG. 5A shows an aerial view of a storage sub-apparatus. FIG. 5B shows a cut view of the storage sub-apparatus.

FIG. 6 shows an aerial view of a transport cart.

FIG. 7 shows an aerial view of a transport cart positioned in a storage apparatus of FIGS. 5A-5B.

FIG. 8A shows an aerial view of a moving vehicle, FIG. 8B shows an aerial view of the moving vehicle which moves on tracks of the storage apparatus.

FIG. 9A shows an aerial view of a vacuum chuck. FIG. 9B shows an aerial view of parts of a vertical transfer mechanism. FIG. 9C shows an aerial view of the vertical transfer mechanism comprising the vacuum chuck. FIG. 9D shows an aerial view of a transfer apparatus comprising the vertical transfer mechanism and the moving vehicle wherein the vacuum chuck of the vertical transfer mechanism grips a capped container.

FIG. 10 shows an aerial view of a vertical motion mechanism.

FIG. 11 shows an aerial view of a gripping device.

FIG. 12 shows an aerial view of a gripping device.

FIG. 13 shows an aerial view of a container gripping mechanism comprising a pair of gripping devices.

FIG. 14 shows an aerial view of an aerial view of a container transfer apparatus comprising a vertical motion mechanism, a moving vehicle and a container gripping mechanism which grips a container.

FIG. 15 shows an aerial view of a cap gripping mechanism comprising a pair of gripping devices.

FIG. 16 shows an aerial view of a cap opening sub-apparatus comprising a vertical motion mechanism, a moving vehicle and a cap gripping mechanism which grips a cap of a container.

FIGS. 17A-17B show aerial views of parts of a gripping mechanism. FIG. 17C shows an aerial view of a container gripping mechanism which grips a container.

FIG. 18 shows an aerial views of a chain wheel mechanism. FIG. 19A shows an aerial view of a horizontal motion mechanism. FIG. 19B shows an aerial view of a sub-apparatus comprising the horizontal motion mechanism and the gripping mechanism.

FIGS. 20A-23 show aerial views of parts of a storage system.

FIG. 24 shows an aerial view of the storage system.

FIG. 25A shows an aerial view of a driving wheel mechanism. FIG. 25B shows an aerial view of a universal wheel mechanism. FIG. 25C shows an aerial view of a vehicle which may move on rail tracks. FIG. 25D shows an aerial view of parts of the vehicle. FIG. 25E shows an aerial view of the vehicle on a pair of rail tracks.

FIGS. 26A-26B show aerial views of a track switch sub-mechanism. FIGS. 26C-26D show aerial views of parts of the track switch sub-mechanism. FIG. 26E shows an aerial view of a device. FIG. 26F shows an aerial view of a device. FIG. 26G shows an aerial view of a track switch mechanism (type I). FIG. 26H shows an aerial view of a track switch mechanism (type II).

FIGS. 27A-27B show aerial views of a rotating mechanism.

FIG. 28 shows an aerial view of a stopping device.

FIG. 29 shows an aerial view of a stopping device.

FIG. 30 shows an aerial view of a stopping device.

FIG. 31 shows an aerial view of a stopping sub-mechanism.

FIG. 32 shows an aerial view of a stopping mechanism comprising a rotating mechanism, a stopping sub-mechanism, and a stopping device.

FIG. 33 shows an aerial view of a stopping mechanism comprising a rotating mechanism, a stopping sub-mechanism, and a stopping device.

FIG. 34 shows an aerial view of a stopping mechanism comprising a rotating mechanism, a stopping sub-mechanism, and a stopping device.

FIG. 35 shows an aerial view of a charging sub-mechanism.

FIG. 36 shows an aerial view of a charging mechanism.

FIG. 37A shows an aerial view of a detection mechanism. FIG. 37B shows a plane view of a rail track system comprising, a plurality of rail tracks, a plurality of track switch mechanism of type I, a plurality of track switch mechanisms (type II) and a plurality of detection mechanism. FIGS. 37C-37G show aerial views of parts of the rail track system.

FIG. 38 shows a plane view of a transport system comprising vehicles, stopping mechanisms, charging mechanisms and a rail track system.

FIGS. 39A-39B show aerial views of a container gripping mechanism.

FIG. 40 shows an aerial view of parts of a transfer sub-apparatus.

FIG. 41 shows an aerial view of the transfer sub-apparatus.

FIG. 42A shows an aerial view of a rotational motion mechanism. FIG. 42B shows an aerial view of a loading apparatus comprising the transfer sub-apparatus and the rotational motion mechanism.

FIG. 43 shows the unloading of an emptied container from a vehicle.

FIG. 44 shows an aerial view of the storage system and a part of the transport system near the storage system.

FIG. 45A shows a cut view of a storage room. FIG. 45B shows a view of a rotational motion mechanism of the storage room. FIG. 45C shows an aerial view of the storage room.

FIG. 46A shows a plane view of the storage room and the storage system and a part of transport system in the storage room. FIG. 46B shows an aerial cut view of the storage room.

FIG. 47A shows an aerial view of two gripping devices. FIG. 47B shows an aerial view of parts of a container gripping mechanism. FIG. 47C shows an aerial view of the container gripping mechanism. FIG. 47D shows an aerial view a rotational motion mechanism, with a horizontal rotational axis. FIG. 47E shows an aerial view of a dispensing apparatus configured to dispense food ingredients from an ingredient container.

FIG. 48A show an aerial view of a cooking sub-apparatus. FIG. 48B shows a cut view of the cooking sub-apparatus. FIG. 48C show an aerial view of a cooking apparatus comprising the cooking sub-apparatus. FIG. 48D shows an aerial view of the cooking apparatus when a cookware is turned as to dispense a cooked food.

FIGS. 49A-49B show aerial views of a receiving apparatus comprising a plurality of container holders on a rotatable turntable.

FIG. 50 shows an aerial view of a cooking sub-system comprising the receiving apparatus shown in FIGS. 49A-49B.

FIG. 51 shows a schematic view of a cooking system.

FIG. 52 shows a schematic view of a kitchen system comprising the cooking system.

FIG. 53 shows an aerial view of parts of the kitchen system.

FIG. 54 is a flow chart showing the procedures of the transfer of an ingredient container and dispensing of food ingredients from the container to a cookware in the kitchen system.

FIG. 55 is a flow chart showing the procedures of the computer system of the kitchen system in preparation of receiving an order for food item.

FIG. 56 is a flow chart showing the procedures of the computer system of the kitchen system for controlling the cooking of a food item, after a food item is ordered.

### DETAILED DESCRIPTION OF THE INVENTION

For the present patent application, a shaft always comprises an axis. A shaft can have different shapes at different sections. A sectional shape of a shaft can be round or rectangular, or of other shapes. For the present patent application, a rotational movement refers to a rotational movement around an axis. For the purpose of the present patent application, a motor comprises a powered-mechanism configured to produce a relative motion. A motor may be of a different type depending on the power source (e.g., electric, hydraulic, pneumatic, etc.). In our application, a motor always includes an electronic device which may be connected to a computer, and the computer may then be configured to control a motor, e.g. to control the timing, direction and speed of the motion.

In some applications or embodiments, a motor comprises a base component (e.g., a frame) which is a stationary member of the motor, and a shaft which is a moving member of the motor, so that the powered-mechanism of the motor can produce a rotation of the shaft relative to the base component around the axis of the shaft. A motor may be connected to a computer via wires, and/or through a driver, and/or a controller and/or a relay and/or a wireless communication device. The base component of a motor may be referred to as the support component of the motor.

Similarly, an encoder may comprise a base component, and a shaft which is rotatable relative to the base component, where the encoder can detect the degree of rotation of the shaft relative to the base component, and then inform a computer of the degree by sending signals to the computer.

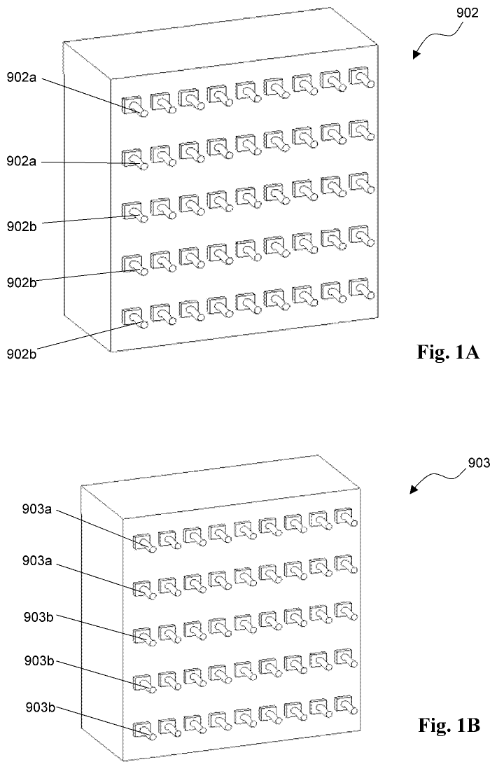

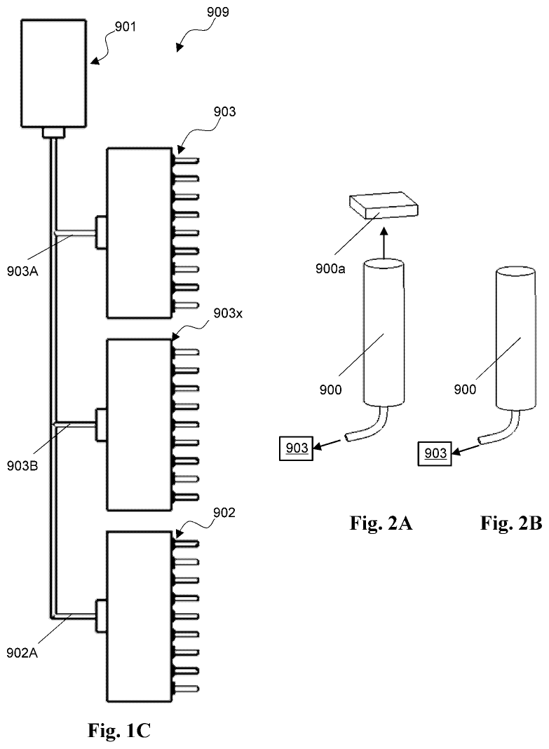

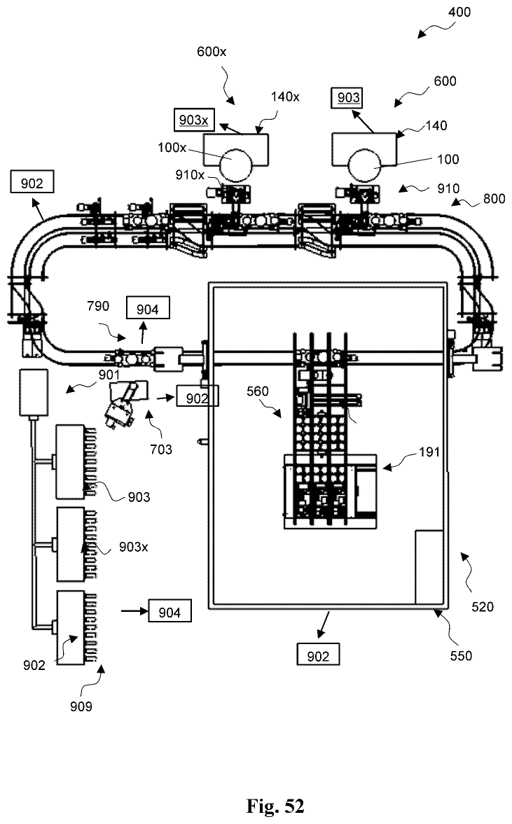

The elements of our invention will be described in detail in FIGS. 1A-51, and they are assembled into an automated kitchen system in FIG. 52.

Referring to FIG. 1A, a computer 902 comprises a plurality of i/o ports 902a and a plurality of i/o ports 902b. The i/o ports 902a of the computer 902 may be connected (either via wires or via wireless communication devices) to sensors, which can be encoders, pressure sensors, proximity switches, micro switches, infrared sensors, temperature sensors, etc. The i/o ports 902b of the computer 902 may be connected to electrical or electronic devices, which may comprise motors, stoves, refrigeration apparatus, etc. The signals of the sensors may be sent to the computer 902. The computer 902 may control the operations of the electrical or electronic devices by sending signals to the electrical or electronic devices.

Referring to FIG. 1B, a computer 903 comprises a plurality of i/o 903a and a plurality i/o ports 903b. The i/o ports 903a of the computer 903 may be connected (either via wires or via wireless communication devices) to sensors, and the i/o ports 903b of the computer 903 may be connected to electrical or electronic devices. The computer 903 may control the operations of the electrical or electronic devices by sending signals to the electrical or electronic devices through the i/o ports of the computer 903. The signals of the sensors may be sent back to the computer 903.

It should be noted that the computer 902 or 903 may comprise a programmable logic controller (in short, PLC). The computer 902 or 903 may alternatively comprise a microcontroller, a circuit board, and a plurality of other electronic or electric components which are connected to the circuit board.

Referring to FIG. 1C, a computer system 909 comprises a server 901 as a first computer, and computers 902, 903 and 903x as second computers, wherein the computer 903x is configured identically as the computer 903. The computer 902 can be configured differently than the computer 903. The computers 902, 903 and 903x are connected via wires 902A, 903A and 903B to the server 901, so that digital or analog data may be communicated between the server 901 and any of the computers 902, 903 and 903x.

It should be noted that the connection between the server 901 and the computer 902, 903 or 903x may be via RS485 wiring, or RS422 or RS232 wiring, etc., or alternatively, via wireless communication devices. The server 901 may be substituted by a PC, or workstation, or other type of computer.

Referring to FIGS. 2A-2B, a proximity switch 900 is configured to sense a target 900a when the target is positioned in a certain range relative to the proximity switch. The proximity switch 900 can be connected (via wires and/or wireless communication devices) to an i/o port of a computer 902, 903, or 903x. When the proximity switch 900 senses the target 900a, it sends a signal to the computer 902, 903, or 903x.

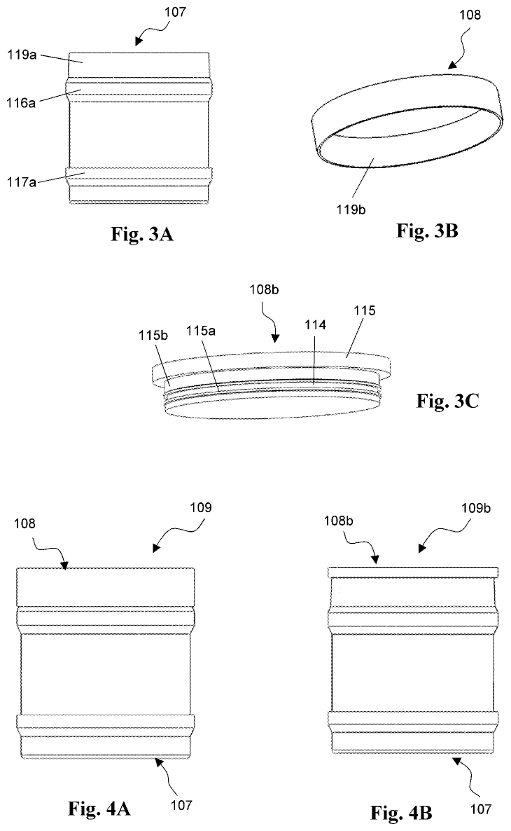

Referring to FIG. 3A, an ingredient container 107 comprises ring-shaped stiffeners 116a and 117a. The exterior surface of the ingredient container 107 comprises a partial conical surface 119a, some (partial) cylindrical surfaces, etc. The interior surface of the ingredient container 107 comprises a cylindrical surface and a flat bottom surface, and the axis of the cylindrical surface is referred to as the ‘axis of the ingredient container’ 107. The aperture of the partial conical surface 119a is configured to be relatively small, and not to exceed 12 degrees (although the limit of 12 degrees is not a strict requirement). The ingredient container 107 is configured to contain food ingredients. The ingredient container 107 further comprises a quick response (QR) code or barcode (not shown in figure) printed on the bottom surface, at the center, wherein the bottom surface is partially flat. The QR code or barcode of each ingredient container 107 is unique to that container. The QR code or barcode of an ingredient container 107 can be decoded using a device such as a camera or a scanner.

It should be noted that the partial conical surface 119a of the ingredient container 107 is a rotationally symmetric surface in the sense that the surface is invariant under any rotation around the axis of the cone which contains the partial conical surface 119a. The axis of the cone is referred to as ‘the axis of the rotationally symmetric surface.’

Referring to FIG. 3B, a cap 108 comprises an internal surface 119b of a partial conical surface which is configured to be geometrically similar as the partial conical surface 119a of the ingredient container 107. The exterior surface of the cap 108 is configured to be a part of a cylindrical surface, and the axis of the cylindrical surface is referred to as ‘the axis of the cap 108.’ The cap 108 also comprise a QR code or barcode (not shown in figure) printed on the top surface which is flat. The QR code or barcode of each cap 108 is unique to each cap. The QR code or barcode of a cap 108 can be decoded using a scanner, wherein said scanner may comprise a camera configured to take a digital image of the code.

Referring to FIG. 3C, a cap 108b is a solid comprising: a flat circular part 115 as a top part; a ring-shaped exterior 115b comprising a circular groove 115a; and a rubber (or silicone gel) ring 114 which is wrapped around the circular groove 115a. The axis of the flat circular part 115 is referred to as ‘the axis of the cap 108b.’ The cap 108b also comprise a QR code or barcode (not shown in figure) printed on the top surface (of the top part 115). The QR code or barcode of each cap 108b is unique to each cap and can be decoded using a scanner.

Referring to FIG. 4A, a capped ingredient container 109 comprises an ingredient container 107 and a cap 108 configured cap the ingredient container 107 when the surface 119b of the cap 108 touches and presses on the surface 119a of the ingredient container 107. The axis of the cap 108 is configured to coincide with the axis of the ingredient container 107. The partial conical surface 119b is configured to touch the partial conical surface 119a so that the air flow between the interior of the ingredient container 107 and the outside is restricted. Thus, the ingredient container 107 can be capped by the cap 108 so as to seal the interior of the ingredient container 107, wherein the interior may contain food ingredients. The aperture of the partial conical surface 119b may be configured to be the same or nearly the same as the aperture of the partial conical surface 119a. (The aperture of a part of a conical surface refers to the aperture of the conical surface.) The axis of the ingredient container 107 is also referred to as ‘the axis of the capped ingredient container’ 109. Due to the pressure of the surface 119b on the surface 119a in the capped ingredient container 109, the cap 108 caps on the ingredient container 107 tightly, and a force is needed to remove the cap 108 from the ingredient container 107 of the capped ingredient container 109.

Referring to FIG. 4B, a capped ingredient container 109b comprises an ingredient container 107 and a cap 108b configured cap the ingredient container 107. The axis of the cap 108b is configured to coincide with the axis of the ingredient container 107. The rubber (or silicone gel) ring 114 is configured to touch and press on the interior cylindrical surface of the ingredient container 107 so that the air flow between the interior of the ingredient container 107 and the outside is restricted or otherwise limited. Thus, the ingredient container 107 can be capped by the cap 108b so as to seal the interior of the ingredient container 107, wherein the interior may contain food ingredients. The axis of the ingredient container 107 is also referred to as ‘the axis of the capped ingredient container’ 109b. Due to the pressure of the rubber (or silicone gel) ring 114 on the interior cylindrical surface of the ingredient container 107 in the capped ingredient container 109b, the cap 108b caps on the ingredient container 107 tightly, and a force is needed to remove the cap 108b from the ingredient container 107 of the capped ingredient container 109b.

It should be noted the cap 108 (or 108b) can be removed from the ingredient container 107 by moving the cap linearly away from the ingredient container 107, in the linear direction which is parallel to the axis of the ingredient container 107. An ingredient container 107 can be capped by a cap 108 (or 108b) by moving the cap linearly towards the ingredient container 107, in the linear direction which is parallel to the axis of the ingredient container 107.

The interior surfaces of the ingredient containers 107 discussed above may have a textured or rugged surface. The ingredient containers 107 may be made from metal, plastics for example polycarbonate (PC), polypropylene (PP), and Teflon, etc., or other solid material. The interior surfaces of the ingredient container 107 may be coated with polytetrafluoroethylene or other non-stick coating.

At times, an ingredient container may be referred to as a container; and a capped ingredient container may be referred to as a ‘capped container.’ An ingredient container without a cap may also be referred to as an ‘uncapped ingredient container,’ or an ‘uncapped container.’

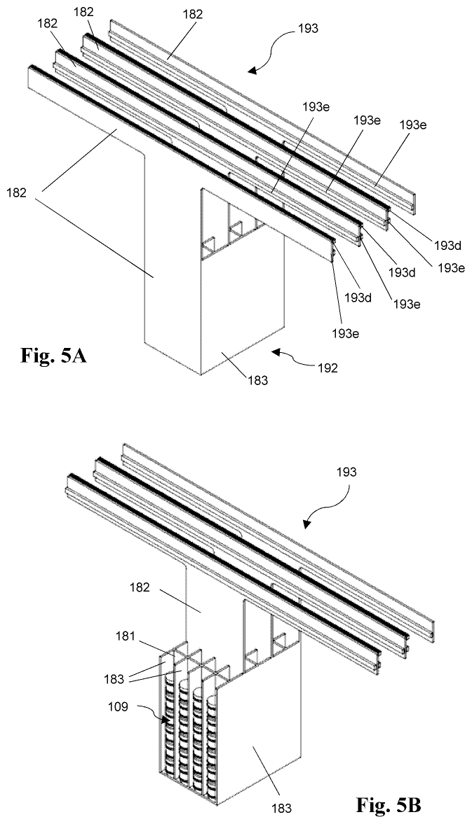

Referring to FIGS. 5A-5B, a storage sub-apparatus 193 comprises a storage box 192 comprising a plurality of compartments arranged in a square grid, wherein each compartment is configured to store a plurality of capped containers 109 (or 109b) wherein the capped containers 109 (or 109b) are stacked vertically in the compartment. The storage box 192 comprises vertical walls 181, 182, and 183, wherein the walls 183 are parallel to each other, and each wall 181 or 182 is perpendicular to the walls 183. The storage sub-apparatus 193 further comprises a plurality of racks 193d configured to be fixedly positioned relative to the storage box 192 and a plurality of tracks 193e configured to be fixedly connected to the storage box 192, all of racks 193d and tracks 193e are positioned along a horizontal direction. The walls 182 of the compartments are extended to fixedly connect to the tracks 193e and the racks 193d. The tracks and racks are parallel to each other. Each track 193e, as shown, can be a rail or rod of rectangular sectional shape.

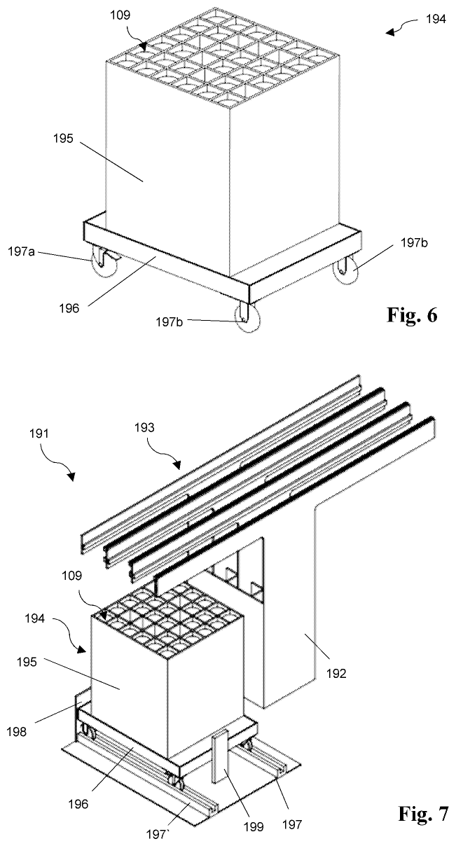

Referring to FIG. 6, a transport cart 194 comprises a transport box 195 comprising a plurality of compartments arranged in a square grid, wherein each compartment is configured to store a plurality of capped containers 109 (or 109b) where the capped containers 109 (or 109b) are stacked vertically in the compartment. Each compartment has a square shape if viewed from above. In addition, the inside of each compartment has the shape of a square cylinder. The transport cart 194 further comprises: a support member 196; two wheels 197a which are rotatable relative to the support member 196 around a same axis which is relatively fixed with respect to the support member 196; and two universal wheels 197b which are rotatable around an axis wherein said axis is itself rotatable relative to the support member 196. The transport cart 194 may be moved on the ground

It should also be noted that the storage box 192 may be assembled from flat boards of a material, including but not limited to metal or plastic. The transport box 195 may be assembled from flat hollow boards of a material, including but not limited to metal or plastic.

As shown in FIG. 7, a storage apparatus 191 comprises a storage sub-apparatus 193 and a pair of slotted rail tracks 197, all configured to be fixedly connected to the ground. The wheels of the transport cart 194 may move on the slotted rail tracks 197. The storage apparatus 191 further comprises a limiting device 198 which is fixedly connected to the ground and a limiting device 199 which can be removed when the transport cart needs to be moved out. When the wheels of the box are positioned on the slotted rail tracks 197, the limiting devices 198 and limiting devices 199 are used as physical barriers as to fix the position of the transport cart 194; and when the position of the transport cart is fixed by the limiting devices, that the transport box 195 of the transport cart 194 becomes parallel to the storage box 192 of the storage apparatus 191.

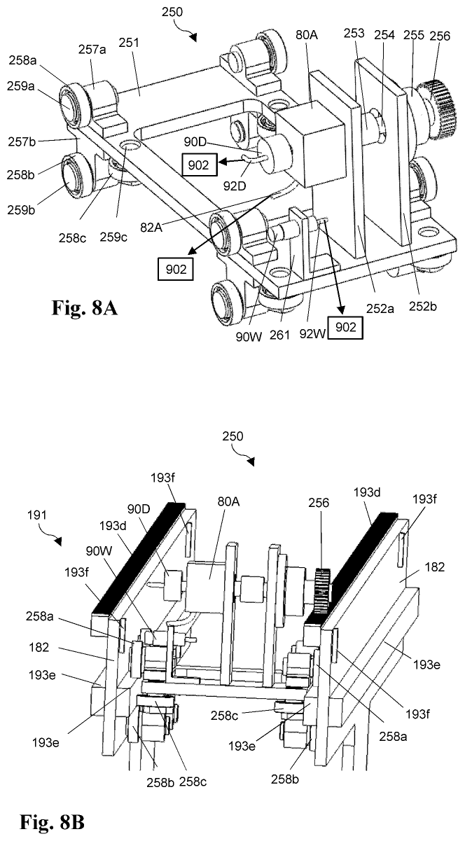

Referring to FIG. 8A, a moving vehicle 250 comprises: a support component 251 comprising a board with a hole; two vertical boards 252a and 252b which are rigidly connected to the support component 251; a plurality of wheels 258a, 258b and 258c; a plurality of shafts 259a, 259b and 259c; and a plurality of axle seats 257a and 257b, which are rigidly connected to the support component 251. The shaft 259a or 259b is fixedly connected to the axle seats 257a or respectively 257b. The wheels 258a or 258b is mounted on the shaft 259a or respectively 259b and is concentric with the shaft 259a or respectively 259b, so that the wheel 258a or 258b is constrained to rotate freely relative to the shafts 259a or respective 259b around the axis of the shaft. The shafts 259c are fixedly connected to the support component 251. Each wheels 258c is mounted on a shaft 259c and is concentric with the shaft 259c, so the wheel is constrained to rotate freely relative to the shaft around the axes of the shaft.

The moving vehicle 250 further comprises: a shaft 254 and a gear 256 which are rigidly connected to and concentric with each other; a bearing housing 255. The bearing housing 255 is rigidly connected to the vertical board 252b wherein the axis of the bearing housing 255 is configured to be horizontal. A pair of bearings (hidden in figure) are configured to connect the shaft 254 and the bearing housing 255, so that the shaft 254 is constrained to rotate relative to the bearing housing 255, around the axis of the shaft 254. A motor 80A comprises a shaft and a base component wherein the base component is fixedly connected to the support component 251 and the shaft of said motor is connected with the shaft 254 via a coupling 253. When the motor 80A rotates, the shaft 254 is rotated, and hence the gear 256 is rotated, relative to the support component 251.

The moving vehicle 250 further comprises an encoder 90D comprising a base component and a shaft, wherein the base component is configured to be fixedly connected to the support component 151, and the shaft of the encoder 90D is fixedly connected to the shaft 254. Thus, the encoder 90D may detect the degree of rotation of the shaft 254 or the gear 256.

The moving vehicle 250 further comprises a proximity switch 90W which is fixedly connected to the support component 251 via a connector 261. A plurality of targets 193f are fixedly attached to the walls 182 of the storage apparatus 191 (see FIG. 8B); wherein the distance between centers of two neighboring targets 193f is configured to be equal to the distance of the centers of neighboring compartments (that share a wall) in the storage apparatus 191. The proximity switch 90W is configured to sense the targets 193f when the proximity switch 90W is moved with the moving vehicle.

Referring to FIG. 8B, the wheels 258a of the moving vehicle 250 are configured to move on and be restricted by the upper surfaces of the track 193e. The wheels 258b are configured to be restricted by the lower surfaces of the track 193e. The wheels 258c are configured to be restricted by the side surfaces of the track 193e. The gear 256 of the moving vehicle 250 is engaged with the rack 193d of the storage apparatus 191. Thus, when the gear 256 is rotated, the moving vehicle 250 is moved relative to the rack 193d (or equivalently, relative to the storage apparatus 191) along the horizontal direction of the rack 193d.

As shown in FIG. 8A, the motor 80A is connected to the computer 902 via wires 82A. The computer 902 is configured to dynamically control the timing and/or speed of the motor 80A. The encoder 90D is also connected to the computer 902 via wires 92D, so that the computer 902 may receive signals from the encoder 90D so as to track the angular degree of rotation of the gear 256. The degree of rotation of the gear 256 can be converted into the sliding distance of the moving vehicle 250 relative to the storage apparatus 191. The proximity switch 90W is connected to the computer 902 via wires 92W, so that the computer 902 may receive signals from the proximity switch 90W. When the moving vehicle 250 is moved to a position where the target 193f is in or out of the sensing range of the proximity switch 90W, signals are sent from the proximity switch to the computer 902; and based on the signals and their timings, the computer 902 (or the computer system 909) comprises a program to figure out the position of the moving vehicle 250 at that moment. Using the information sent by the proximity switch 90W and the encoder 90D, the computer 902 (or the computer system 909) may accurately control the sliding distance or the position of the moving vehicle 250 relative to the storage apparatus 191.

It should be noted that the range of motion of the moving vehicle 250 in the horizontal direction may be limited by means of physical barriers.

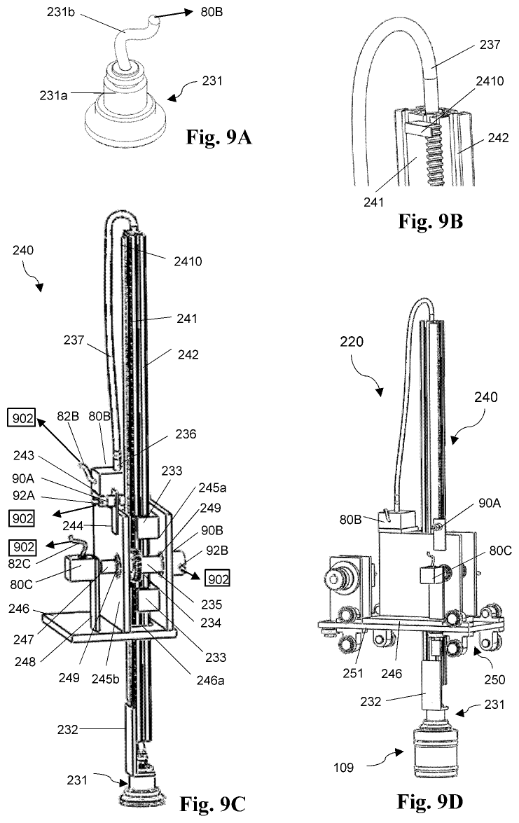

Referring to FIGS. 9A-9C, a vertical transfer mechanism 240 comprises: a support component 246 comprising a flat board with a hole 246a in the middle; three vertical boards 245a, 245b and 248 and a horizontal board 243 which are all rigidly connected to the support component 246; two sliding device 233 which are rigidly connected to the vertical board 245a and thus rigidly connected to the support component 246; a rack 241 configured to be positioned vertically; an aluminum profiles 242 configured to be engaged with the sliding devices 233 as to be constrained to move vertically relative to the sliding devices 233 and thus relative to the support component 246; a gear 234 with a horizontal axis and a shaft 235 which is fixedly connected to and concentric with the gear 234. Each of the vertical boards 245a and 245b comprises a bearing housing with a same horizontal axis. A bearing 249 is configured to connect the shaft 235 and the bearing housing of the vertical board 245a, and another bearing 249 is configured to connect the shaft 235 and the bearing housing of the vertical board 265, so that the shaft 235 and the gear 234 are constrained to rotate relative to the vertical boards 245a, 245b and the support component 246 around the axis of the gear 234. The aluminum profiles 242 and the rack 241 are configured to be positioned through the hole 246a of the support component 246, and the rack 241 is configured to be fixedly connected to the aluminum profiles 242. The gear 234 is engaged with the rack 241. When the gear 243 is rotated, the rack 241 and the aluminum profiles 242 are moved vertically relative to the sliding devices 233, or equivalently, relative to the support component 246.

The vertical transfer mechanism 240 further comprises: a vacuum chuck 231 which is mounted on a connector 232, wherein the connector 232 is rigidly connected to the aluminum profiles 242; and a vacuum generator 80B which is mounted on the board 243. The vacuum chuck 231 comprises a base component 231a and a tube 231b (see FIG. 9A). The vacuum generator 80B comprises a tube 236. A tube 237 connects the tube 231b of the vacuum chuck to the tube 236 of the vacuum generator 80B. A part of the tube 237 is positioned in a hole of the aluminum profiles 242 (see FIGS. 9B-9C). The vacuum check 231 may grip a cap 108 (or 108b) of a capped container 109 (or 109b) when a lower surface of the vacuum chuck 231 attracts a top surface of the cap 108 (or 108b) by sucking out the air in between the two surfaces (see FIG. 9D). The axis of the vacuum chuck 231 may be positioned to be concentric (or nearly concentric) with the axis of the capped container 109 (or 109b) during the sucking process. The vacuum generator 80B is connected to the computer 902 via wires 82B (see FIG. 9C). The computer 902 is configured to control the timing for the vacuum generator 80B to create a vacuum in the tube 237.

The vertical transfer mechanism 240 further comprises: a motor 80C comprising a shaft and a base component, wherein the base component is fixedly connected to the vertical board 248, and the shaft of the motor 80C is connected to the shaft 235 via a coupling 247. When the motor 80C rotates, the shaft 235 and the gear 234 are rotated relative to the support component 246. Since the gear 234 is engaged with the rack 241, the rack 241 can thus be moved vertically relative to the support component 246.

The vertical transfer mechanism 240 further comprises an encoder 90B comprising a base component and a shaft, wherein the base component is rigidly connected to the vertical board 245a, and the shaft of the encoder 90B is connected to the shaft 235 via a coupling. The encoder 90B is used to detect the degree of rotation of the gear 234. A proximity switch 90A with a horizontal axis is connected to the components 245b and 246. The proximity switch 90A is configured to sense a certain target 2410 of the rack 241 when the target is moved vertically to a certain range, wherein the target 2410 is a part made of a metal.

The motor 80C is connected to the computer 902 via wires 82C (see FIG. 9C). The computer 902 is configured to dynamically control the timing and/or speed of the motor 80C. The encoder 90B is also connected to the computer 902 via wires 92B, so that the computer 902 may receive signals from the encoder 90B as to track the degree of rotation of the gear 234. The degree of rotation of the gear 234 can be converted into the sliding distance of the rack 241 relative to the support component 246. The proximity switch 90A is connected to the computer 902 via wires 92A, so that the computer 902 may receive signals from the proximity switch 90A. When the rack 241 is vertically moved to a position where the target 2410 is in or out of the sensing range of the proximity switch 90A, the signals are sent to the computer 902 so that the computer 902 can know the position information of the aluminum profiles 242 at that precise moment. Using the information sent by the proximity switch 90A and the encoder 90B, the computer 902 may accurately control the motion of the rack 241.

It should be noted that the aluminum profiles 242 may be substituted by a hollow rod, a tube in square shape or other shape, etc., of a material such as, metal, plastic, etc.

Referring to FIG. 9D, a transfer apparatus 220 comprises a vertical transfer mechanism 240 and a moving vehicle 250. The support component 246 of the vertical transfer mechanism 240 is configured to be rigidly connected to the support component 251 of the moving vehicle 250. The transfer apparatus 220 can move a capped container 109 (or 109b) in the vertical direction and then in the horizontal direction. When the moving vehicle 250 is properly positioned relatively to the storage box 192 or transport box 195 of a transport cart, the vacuum chuck 231 of the vertical transfer mechanism 240 can be moved to a position inside a square compartment of said box. At that position, the vacuum chuck 231 may suck and grip a capped container 109 (or 109b) therein. Then, the vertical transfer mechanism 240 may lift the capped container 109 (or 109b) together with the vacuum chuck and aluminum profiles 242 upward. Then, the moving vehicle 250 can move with the gripped capped container 109 (or 109b) to another position where the vacuum chuck 231 together with the aluminum profiles 242 can be moved downward and then release the capped container.

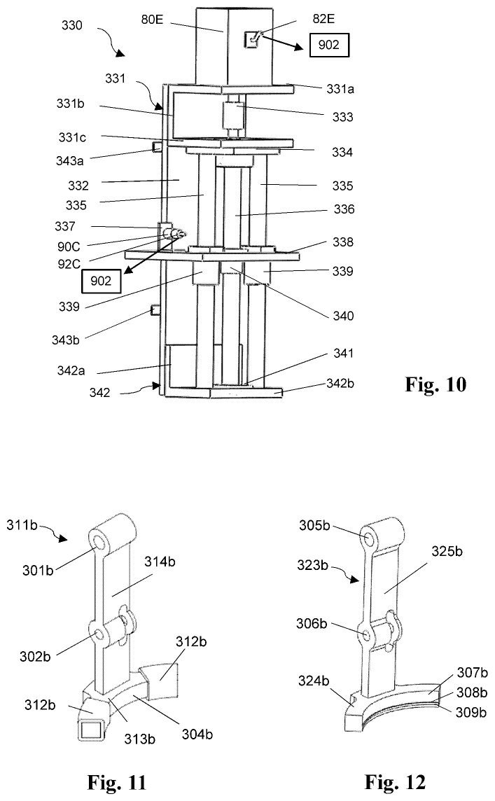

Referring to FIG. 10, a vertical motion mechanism 330 comprises: a support component 338 comprising a flat board with a hole; an L-shaped rigid component 342 comprising a horizontal board 342b and a vertical board 342a, wherein the horizontal board 342b comprises a bearing housing 341; a U-shaped rigid component 331 comprising two horizontal boards 311a and 311c and a vertical board 311b; a support component 332 configured to rigidly connect the vertical board 342a of the L-shaped rigid component 342 and the vertical board 311b of the U-shaped rigid component 331; and a pair of shafts 335. Each shaft 335 is configured to be fixedly connected to the horizontal boards 331c and 342b, wherein the axes of the pair of shafts 335 are configured to be vertical.

The vertical motion mechanism 330 further comprises: a bearing housing 334 which is rigidly connected to the horizontal board 311c of the U-shaped rigid component 331; a pair of linear motion bearings 339; a screw shaft 336 comprising a vertical axis; and a screw nut 340 with a vertical axis. Bearings and accessories (hidden in figure) are configured to connect the bearing housings 341 and 334 with the screw shaft 336, so that the screw shaft 336 is constrained to rotate relative to the U-shaped rigid component 331 and the support component 332 around the axis of the screw shaft 336. The screw shaft 336 is configured to be engaged with the screw nut 340. Each linear motion bearing 339 is configured to be engaged with a corresponding shaft 335 so that the shaft 335 is constrained to move vertically relative to the linear motion bearing 339. The support component 338 is configured to be fixedly connected to some outer shells of the linear motion bearings 399 and the screw nut 340, so that the rotation of the screw shaft 336 induce a vertical movement of the support component 332 relative to the support component 338.

The vertical motion mechanism 330 further comprises a motor 80E comprising a base component and a shaft, wherein the base component is configured to be fixedly connected to the rigid component 331, and the shaft of the motor 80E is connected to the screw shaft 336 by a coupling 333. The motor 80E can drive a rotation of the screw shaft 336 relative to the support component 332 around the axis of the screw shaft 336, and thus a vertical motion in the support component 332 relative to the support component 338.

The vertical motion mechanism 330 further comprises: a proximity switch 90C which is fixedly connected to the support component 338 via a connector 337; and two targets 343a and 343b which are fixedly connected to the support component 332, wherein the target 343a is positioned higher than the target 343b. The proximity switch 90C may sense the targets 343a and 343b when the targets 343a and 343b are moved with the support component 332. The motor 80E is connected to the computer 902 via wire 82E. The computer 902 is configured to dynamically control the timing and/or speed of the motor 80E. The proximity switch 90C is connected to the computer 902 via wires 92C, so that the computer 902 may receive signals from the proximity switch 90C. When the support component 332 is moved upward to a first position where the proximity switch 90C senses the target 343a, the signals of the proximity switch 90C are sent to the computer 902. The computer 902 can figure out the position of the support component 332. Similarly, when the support component 332 is moved downward to a second position where the proximity switch 90C senses the target 343b, the signals of the proximity switch 90C are sent to the computer 902. The computer 902 can figure out the position of the position of the support component 332. With the position information, the computer may control the motor as to move the support component to accurately arrive at a specific position.

The support component 338 is referred to as the support component of the vertical motion mechanism 330.

Referring to FIG. 11, a gripping device 311b is a rigid component comprising: round holes 301b and 302b; an arm 314b; and a gripper 313b comprising a cylindrical surface 304b; rubbers (or silicon gels) 312b which are attached to the gripper 313b.

Referring to FIG. 12, a gripping device 323b is a rigid component comprising: round holes 305b and 306b; an arm 325b; and a gripper 324b comprising a cylindrical surface 307b, a cone surface 309b, and a flat surface 308b.

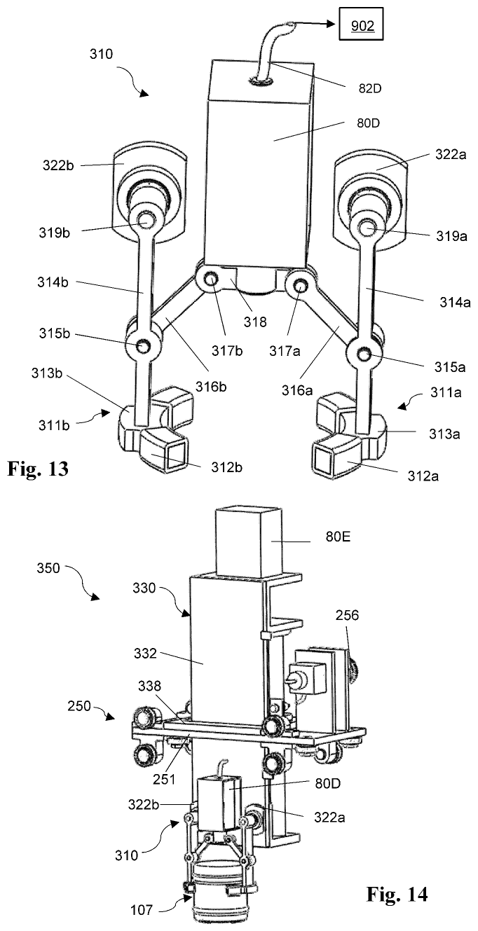

Referring to FIG. 13, a container gripping mechanism 310 comprise: bearing housings 322a and 322b; gripping devices 311a and 311b wherein the gripping device 311a is a mirror image of 311b; a rigid component 318; shafts 317a and 317b; links 316a and 316b; shafts 315a and 315b; and shafts 319a and 319b. The axes of the shafts 315a, 315b, 317a, 317b, 319a and 319b are configured to be horizontal and parallel to each other. Wherein the shaft 317a is configured to connect the link 316a to the rigid component 318 so that the link 316a is rotatable relative to the rigid component 318 around the axis of the shaft. The shaft 317b is configured to connect the link 316b to the rigid component 318 so that the link 316b is rotatable relative to the rigid component 318 around the axis of the shaft. The shaft 315a is configured to connect the link 316a to the arm 314a of the gripping device 311a so that the gripping device 311a is rotatable relative to the link 316a. The shaft 315b is configured to connect the link 316b to the arm 314b of the gripping device 311b so that the gripping device 311b is rotatable relative to the link 316b. The shaft 317a and the shaft 317b are configured to be mirror images of each other on a vertical plane; and the shafts 315a and 315b are mirror images of each other on said vertical plane. The gripping device 311a (or respectively 311b) is connected to the shaft 319a (or respectively 319b), so the gripping device 311a (or respectively 311b) is constrained to rotate relative to the shaft 319a (or respectively 319b) around the axis of the shaft 319a (or respectively 319b). The shaft 319a (or respectively 319b) is connected to the bearing housing 322a (or respectively 322b) via bearings and accessories, so the shaft 319a (or respectively 319b) is configured to be constrained to rotate relative to the shaft 319a (or respectively 319b) around the axis of the shaft 319a. Thus, the linear movement in a vertical direction of the rigid component 318 may induce a rotation in the gripping device 311a around the axis of the shaft 319a. and the linear movement in a vertical direction of the rigid component 318 may induce a rotation in the gripping device 311b around the axis of the shaft 319b.

The container gripping mechanism 310 further comprises a push-pull electromagnet 80D, the push-pull electromagnet 80D comprises a shaft and a base component. The push-pull electromagnet 80D can drive the shaft of the push-pull electromagnet 80D to slide along the axis of the shaft relative to the base component of the push-pull electromagnet 80D. The bearing housings 322a and 322b and the base component of the push-pull electromagnet 80D are configured to be fixedly connected to a support component (the support component is not shown in FIG. 13, but later in FIG. 14), and the shaft of the push-pull electromagnet 80D is rigidly connected to the rigid component 318. When the push-pull electromagnet 80D produces a vertical movement of the rigid component 318 in the upward (or, downward) direction relative to a support component, the gripping devices 311a and 311b are simultaneously rotated toward (or respectively, away from) a vertical axis as to grip (or respectively, release) a container 107 whose axis coincides with said vertical axis; wherein said vertical axis is referred to as the central axis of the container gripping mechanism 310. When the electromagnet 80D forces the rigid component 318 to move to an end-position, the electromagnet 80D is automatically braked, e.g., by a permanent magnet of relatively smaller force. The electromagnet 80D is connected to the computer 902 via wires 82D. The computer 902 is configured to dynamically control the operation of the electromagnet 80D.

Referring to FIG. 14, a container loading apparatus 350 comprises the vertical motion mechanism 330, the moving vehicle 250, and the container gripping mechanism 310. The support component 338 of the vertical motion mechanism 330 is rigidly connected to the support component 251 of the moving vehicle 250; and the bearing housings 322a and 322b and the base component of the push-pull electromagnet 80D of the container gripping mechanism 310 are configured to be rigidly connected to the support component 332 of the vertical motion mechanism 330. The container loading apparatus 350 may be controlled by the computer 902 to grip a container 107, and then move the container vertically, and then horizontally, and then release the container 107 at a different position.

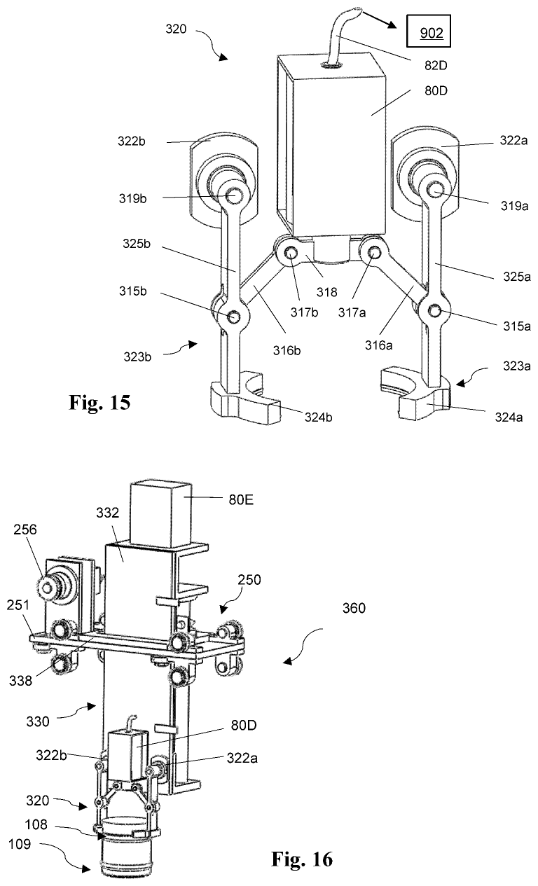

Referring to FIG. 15, a cap gripping mechanism 320 is constructed the same way as the container gripping mechanism 310, except that the pair of gripping devices 311a and 311b are substituted by a pair of gripping devices 323a and 323b. In particular, the cap gripping mechanism 320 comprises identical components as the container gripping mechanism 310 except the difference in gripping devices. Therefore, the cap gripping mechanism 320 comprises a pair of gripping devices 323a and 323b, a push-pull electromagnet 80D, wherein the vertical movement of the shaft of the push-pull electromagnet 80D is configured to rotate the gripping devices 323a and 323b simultaneously toward or away from a vertical axis, referred to as the central axis of the cap gripping mechanism 320, as to grip or release a cap 108 (or 108b). The push-pull electromagnet 80D is connected to the computer 902 via wires 82D, and the computer 902 is configured to dynamically control the movement of the push-pull electromagnet 80D, as in the container gripping mechanism 310.

Referring to FIG. 16, a cap opening sub-apparatus 360 comprising a vertical motion mechanism 330, a moving vehicle 250, and a cap gripping mechanism 320. The support component 338 of the vertical motion mechanism 330 is configured to be rigidly connected to the support component 251 of the moving vehicle 250; and the bearing housings 322a and 322b and the base component of the push-pull electromagnet 80D of the cap gripping mechanism 320 are configured to be rigidly connected to the support component 332 of the vertical motion mechanism 330. When the push-pull electromagnet 80D of the cap gripping mechanism 320 pulls the rigid component 318 upward, a simultaneous rotations of the gripping devices 323a and 323b of the cap gripping mechanism 320 toward the central axis of the cap gripping mechanism 320 as to grip a cap 108 (or 108b) of a capped container 109 (or 109b). When the motor 80E produces a rotation of the screw shaft 336 in a first rotational direction, the support component 332 is moved vertically upward relative to the support component 251 of the moving vehicle 250. When the motor 80A of the moving vehicle 250 drives the rotation of the gear 256, the support component 251 is moved horizontally along the tracks 193e relative to the storage apparatus 191. Thus, the cap opening sub-apparatus 360 may be controlled by the computer 902 to grip a cap 108 (or 108b), and remove the cap 108 (or 108b) from the container 107 when the cap is moved upward with the support component 332 and when the container 107 is fixed, and then horizontally, and then the cap opening sub-apparatus 360 may release the cap 108 (or 108b) at a different position when the electromagnet 80D pushes the rigid component 318 vertically downward.

The computer 902 be configured to dynamically control the rotations and/or speed of the motors in the cap opening sub-apparatus 360 according to the signals of the proximity sensors 90C and the encoders 90D in the cap opening sub-apparatus 360.

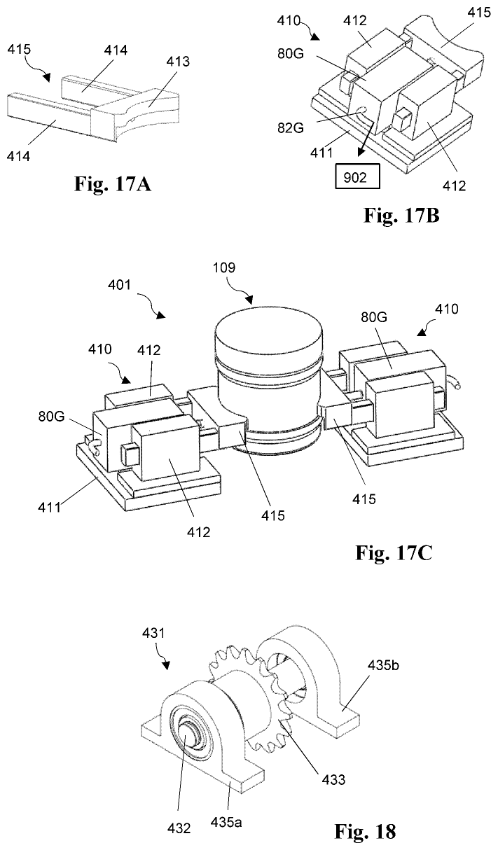

Referring to FIGS. 17A-17B, a gripping sub-mechanism 410 comprises a gripping device 415 which is a rigid component comprising: a gripper 413 whose surface comprises a partial cylindrical surface 413; and sliding bars 414 (see FIG. 17A). The gripping sub-mechanism 410 further comprises sliding tracks 412 which are rigidly connected to a support component 411. Each sliding bar 414 of the gripping device 415 is connected with a sliding track 412 so that the gripping device 415 is constrained to slide relative to the support component 411 along a horizontal direction. The gripping sub-mechanism 410 further comprises a push-pull electromagnet 80G comprising a shaft and a base component, wherein the base component is fixedly connected to the support component 411, and the shaft is fixedly connected to the gripping device 415. The push-pull electromagnet 80G can force the gripping device 415 to slide along a horizontal direction, which equals to the direction of the axis of the shaft of the push-pull electromagnet 80G.

Referring to FIG. 17C, a container gripping mechanism 401 comprises two gripping sub-mechanisms 410 which are positioned as mirror images of each other on a horizontal plane. The gripping devices 415 of the gripping sub-mechanisms 410 are simultaneously moved toward (or away) a vertical axis as to grip (or respectively, release) a container 107 whose axis coincides with said vertical axis; wherein said vertical axis is referred to as the central axis of the container gripping mechanism 401. The electromagnets 80G are connected to the computer 902 via wires 82G (also see FIG. 17B). The computer 902 is configured to control the operations of the electromagnets 80G so that the electromagnets 80G may be moved simultaneously.

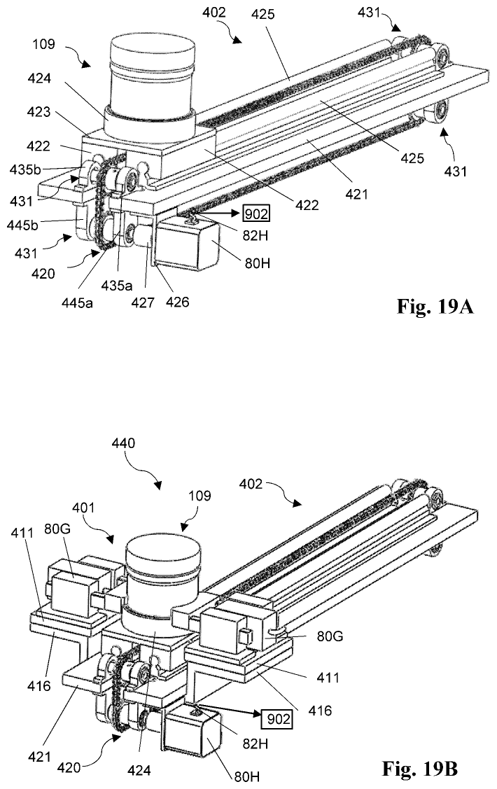

Referring to FIG. 18, a chain wheel mechanism 431 comprises two bearing housings 435a and 435b which are configured to be relatively fixed, a shaft 432, and a chain wheel 433. A bearing and accessories are configured to connect the shaft 432 and the bearing housing 435a, and another bearing and accessories are configured to connect the shaft 432 and the bearing housing 435b, so that the shaft 432 is constrained to rotate relative to the bearing housings 435a and 435b, around the axis of the shaft 432. The chain wheel 433 is configured to be fixedly connected to and concentric with the shaft 432, so the chain wheel 433 is constrained to rotate relative to the bearing housings 435a and 435b.

Referring to FIG. 19A, a horizontal transport mechanism 402 comprises: four chain wheel mechanisms 431; a roller chain 420 comprising two ends; linear tracks 425 and linear sliders 422 which are constrained to move on the linear tracks 425; a horizontal board 423 which is rigidly connected to the linear slider; and a container holder 424 which is fixedly connected to the board 423. The container holder 424 is a cup with cylinder shape comprising a vertical axis, wherein said cup may position and hold a container 107 and restrict the movement of the container 107 when the container holder 424 is moved. The bearing housings 435a and 435b of the chain wheel mechanisms 431 are all rigidly connected to a support component 421. The horizontal board 423 is configured to be fixedly attached to the ends of the roller chain 420. The roller chain 420 is configured to be engaged with the chain wheels 433 of the chain wheel mechanisms 431.

The horizontal transport mechanism 402 further comprises a motor 80H comprising a shaft and a base component, wherein the base component is fixedly connected to the support component 421 by a connector 426, and the shaft of the motor is fixedly connected to the shaft 432 of a first chain wheel mechanism (of the 4 chain wheel mechanisms) 431 via a coupling 427. Thus, the motor 80H may drive rotations of the shaft 432 and the chain wheel 433 of the first chain wheel mechanism 431 relative to the support component 421, and thus a motion in the roller chains 420, and hence a linear motions of the sliders 422 and the container holder 424 relative to the support component 421 along a horizontal direction.

The motor 80H is connected to the computer 902 via wires 82H. The computer 902 is configured to dynamically control the timing and/or speed of the motor 80H. The container holder 424 may be moved to and stopped at specific positions under the control of the computer 902.

Referring to FIG. 19B, a sub-apparatus 440 comprises a horizontal transport mechanism 402 and the container gripping mechanism 401, wherein the support components 411 of the container gripping mechanism 401 is rigidly connected to the support component 421 of the horizontal transport mechanism 402 by connectors 416. A capped container 109 (or 109b) can be placed on the container holder 424 and can be moved to a certain position so that the container gripping mechanism 401 can grip the container 107 of the capped container 109 (or 109b).

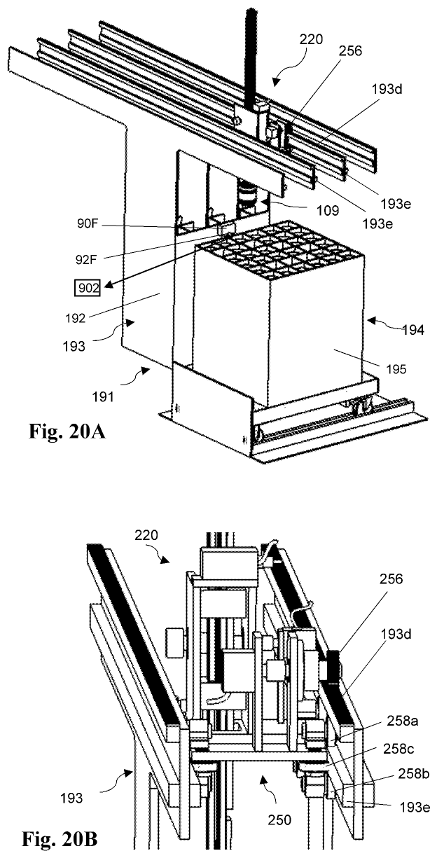

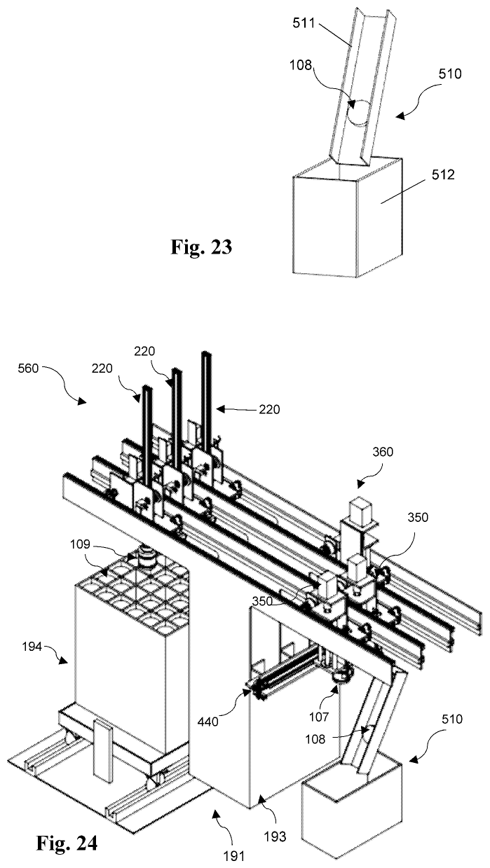

Referring to FIGS. 20A-24, a storage system 560 comprises: a storage apparatus 191; transfer apparatuses 220; container loading apparatus 350; a cap opening apparatus 370 comprising a sub-apparatus 440 and a cap opening sub-apparatus 360. The storage system 560 further comprises a cap collection apparatus 510 comprising a sliding path 511 and a box 512 (see FIG. 23). A cap 108 (or 108b) may slide into the box 512 along the sliding path 511. The support component 421 of the sub-apparatus 440, the storage apparatus 191, and the cap collection apparatus 510 may be configured to be rigidly or fixedly connected to the ground, by known techniques, so that their positions are fixed with respect to each other.

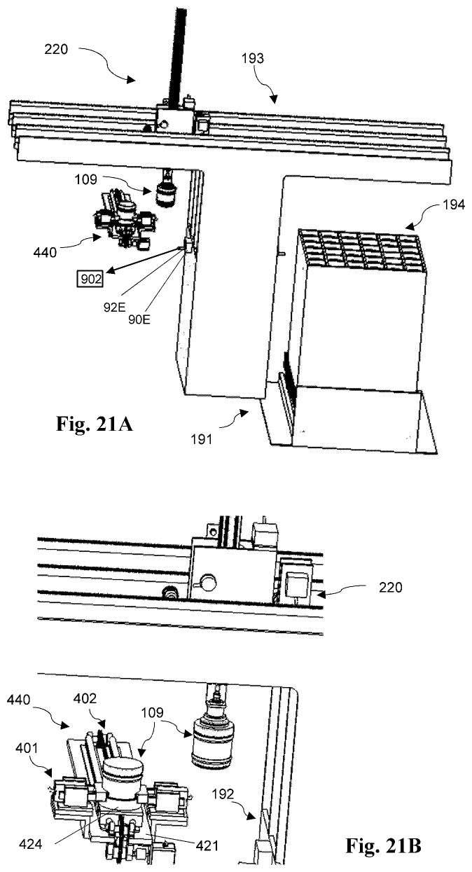

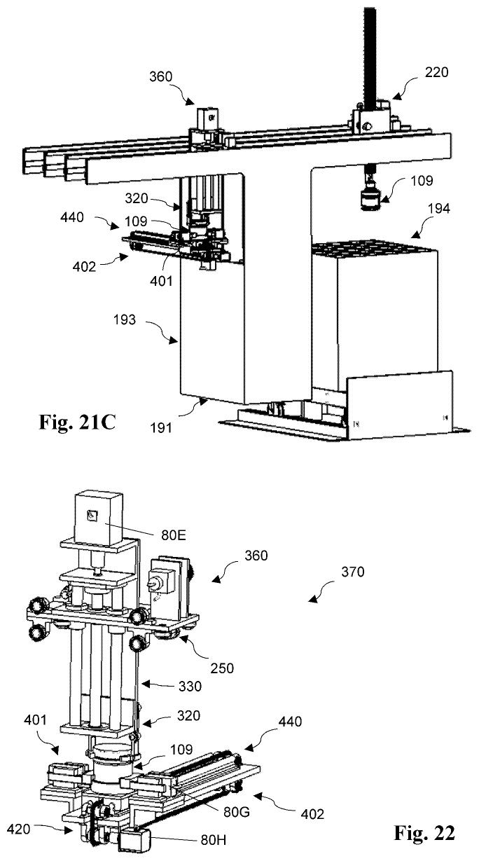

The storage system 560 further comprises two scanners 90E and 90F, both of which are fixedly mounted on the storage apparatus 191 (see FIGS. 20A-21A). The scanners 90E and 90F are connected to the computer 902 by wires 92E and 92F, so that the computer 902 may receive information from the scanners 90E and 90F. When a capped container 109 (or 109b) passes through a position above the scanner 90F or 90E, the scanner 90F or 90E can capture a digital image of the QR code or barcode of the container 107, and then send the information to the computer 902 that decodes the QR code or barcode. The QR code or barcode information of the capped container 109 (or 109b) are recorded by the computer 902. The QR code or barcode on each container is configured to be unique to the container. The identities and the codes of the containers 107 can be recorded by the computer 902.

It should be noted that the scanner 90E or 90F may comprise a microcomputer configured to decode the QR code or barcode on a container 109 (or 109b)

A transport cart 194 may be positioned at a certain location in the storage apparatus 191, being restrained by the limiting devices 198 and 199. Under the control of the computer 902, the transfer apparatus 220 can transfer a capped container 109 (or 109b) out of the storage box 192 of the storage apparatus 191, as follows. At step 1, the vacuum chuck 231 of the transfer apparatus 220 may be moved horizontally and then vertically down to a position as to grip a capped container 109 (or 109b) in a square compartment of the storage box. At step 2, the vacuum chuck 231, together with the gripped capped container 109 (or 109b), may be moved vertically up, so that the gripped capped container 109 (or 109b) is totally outside of the storage apparatus 191. At step 3, the vacuum chuck 231, together with the gripped capped container 109 (or 109b), may be moved horizontally, and then vertically down, to a position so that the QR code or barcode on the bottom of the gripped capped container 109 (or 109b) may be read by the scanner 90E (see FIG. 21A). At step 4, the vacuum chuck 231 of the transfer apparatus 220 may be moved horizontally, and then vertically down to a position as to release the capped container 109 to the container holder 424 of the horizontal transport mechanism 402, wherein the container holder 424 needed to move to the receiving position in advance. At step 5, the vacuum chuck 231 of the transfer apparatus 220 is moved vertically up and can be used for the next task. Similarly, the transfer apparatus 220 may transfer a container from one into the other among the compartments of the storage box and transport box.

As explained before, each time a capped container 109 (or 109b) is put in or taken away from the storage apparatus 191, the QR code or barcode of the capped container 109 (or 109b) is decoded by the scanner 90E or 90F. The signals of the scanners 90E and 90F are sent to the computer 902, so that the data of the capped containers 109 (or 109b) in the storage apparatus 191 are stored and dealt by the computer 902.

Two containers of food ingredients are said to have the same ‘container content type,’ if they contain the same types of food ingredients, and the weight of the food ingredient of each type is the same for both containers. Although this is not strictly necessary, a single compartment in the storage apparatus 191 may be configured to store containers of the same container content type.

It should also be noted that the transfer apparatus 220 may move a capped container 109 (or 109b) from one compartment to another.

When a capped container 109 (or 109b) is placed on the container holder 424 and moved to the position so that the container 107 of the capped container 109 (or 109b) is gripped by the container gripping mechanism 401 (of the sub-apparatus 440), the cap opening sub-apparatus 360 may be used to grip the cap 108 (or 108b) of the capped container 109 (or 109b) and then to move the cap 108 (or 108b) vertically upward (see FIG. 22). The cap 108 (or 108b) is thus removed from the container 107. The cap 108 (or 108b) may be then moved horizontally by the moving vehicle 250 of the cap opening sub-apparatus 360 and be released and unloaded to the sliding path of the cap collection apparatus 510. The above procedures involve the following detailed steps (see FIGS. 21C, 22, 23 and 24). At step 1, the transport mechanism 402 (of the sub-apparatus 440) may move the container holder 424 with said capped container 109 (or 109b) to a position where the axis of the capped container 109 (or 109b) coincides with the central axis of the container gripping mechanism 401 of the sub-apparatus 440. At step 2, the container gripping mechanism 401 of the sub-apparatus 440 grips the container 107 of the capped container 109 (or 109b). At step 3, the cap gripping mechanism 320 of the cap opening sub-apparatus 360 is moved horizontally and then vertically downward, and then grip the cap 108 (or 108b) of said capped container 109 (or 109b). At step 4, the cap gripping mechanism 320 together with the gripped cap 108 (or 108b), are moved vertically upward, thus remove the cap 108 (or 108b) from the container 107. At step 5, the cap gripping mechanism 320 of the cap opening sub-apparatus 360 may be moved horizontally, and then vertically down, to a position as to release the cap 108 (or 108b) into the sliding path of the cap collection apparatus 510. At step 6, the cap gripping mechanism 320 is moved vertically up. Meanwhile, the container gripping mechanism 401 of the sub-apparatus 440 may release the container 107, and then the container 107 and the container holder 424 may be moved to another position as to be gripped and moved by a loading apparatus 350 as follows. The container gripping mechanism 310 of the container loading apparatus 350 may be moved horizontally and then vertically down, and then may grip the container 107 placed on the container holder 424. Then the container gripping mechanism 310 together with the gripped container 107 are moved vertically upward, and then horizontally by the moving vehicle (of the apparatus 350). Then, the container gripping mechanism 310 may be moved vertically down to a position as to release the container 107 to be placed on a container holder of a vehicle in the transport system (to be described later).

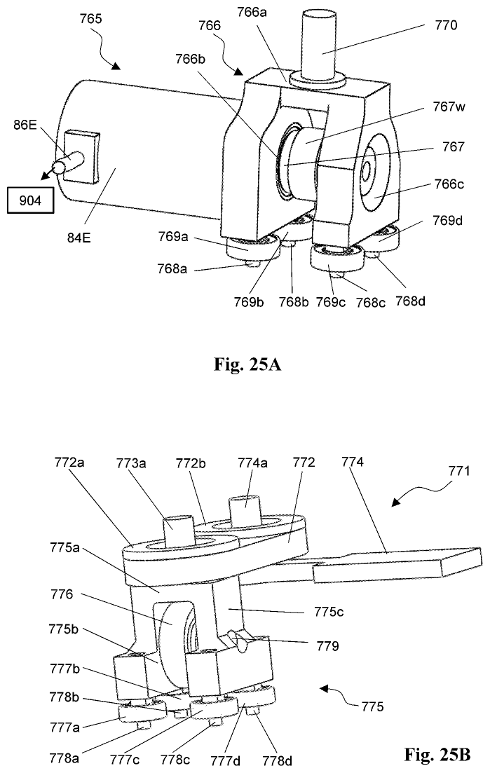

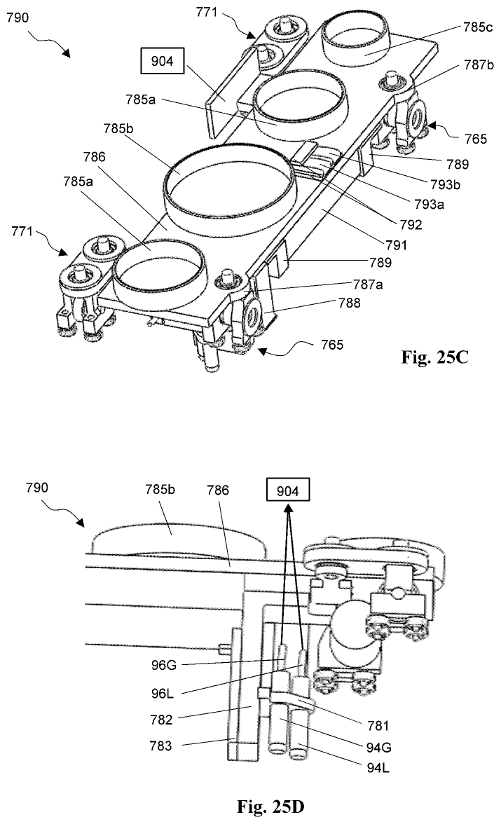

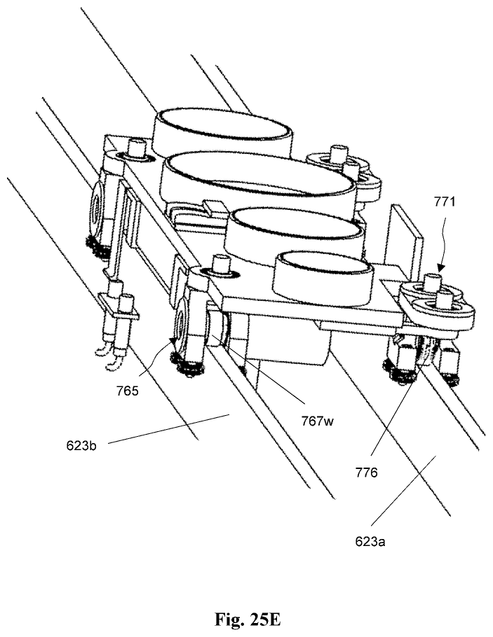

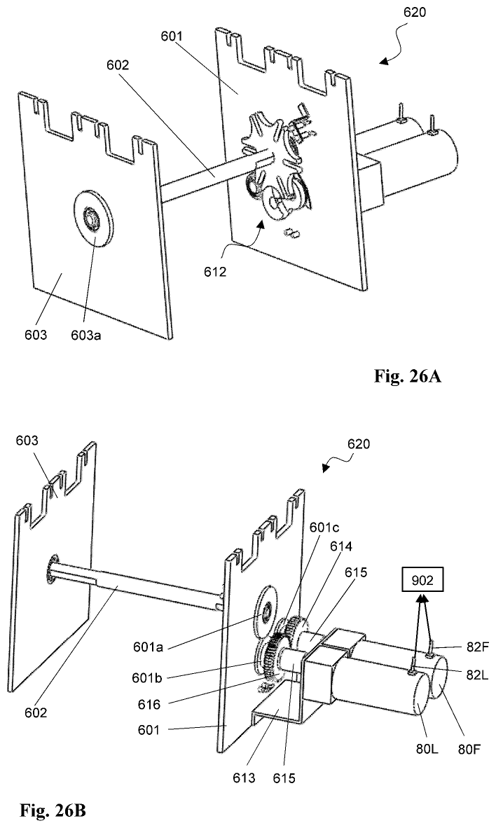

Referring to FIGS. 25A-25D, a vehicle 790 comprises: a support component 786 comprising two bearing housings 787a and 787b as parts; a computer 904 which is fixedly connected to the support component 786 by connectors; a target 788 rigidly connected to the support component 786; two driving wheel mechanisms 765; two universal wheel mechanisms 771. The bearing housing 787a or 787b is connected to the shaft 770 of one of the driving wheel mechanisms 765 by bearings and accessories, so that the shaft 770 is constrained to rotate relative to the support component 786 around the axis of the shaft 770. The connecting components 774 of the universal wheel mechanisms 771 are rigidly connected to the support component 786.

The computer 904 comprises a plurality of input ports and a plurality of output ports. The input ports of the computer 904 may be connected (either via wires or via wireless communication devices) to sensors, which can be encoders, pressure sensors, proximity switches, micro switches, infrared sensors, temperature sensors, etc. The output ports of the computer 904 may be connected to electrical or electronic devices which can be several types of motors, stoves, refrigeration apparatus, etc. The signals of the sensors may be sent to the computer 904. The computer 904 may control the operations of the electrical or electronic devices by sending signals to the electrical or electronic device. The computer 904 is configured to communicate with the computer 902 via wireless communication devices.

Referring to FIG. 25A, a driving wheel mechanism 765 comprises: a support component 766; a shaft 767 comprising a horizontal axis, and a wheel 767w which is rigidly connected to and concentric with the shaft 767; shafts 770, 768a, 768b, 768c and 768d, each comprising a vertical axis; and wheels 769a, 769b, 769c and 769d. The support component 766 comprises a pair of bearing housings 766b and 766c which have a same horizontal axis. The shaft 770 is rigidly connected to a top part 766a of the support component 766. The shaft 767 is configured to be connected to the bearing housings 766b and 766c by bearings and accessories, so that the shaft 767 is constrained to rotate relative to the support component 766 around the axis of the shaft 767. The shafts 768a, 768b, 768c and 768d are configured to be rigidly connected to (some bottom parts of) the support component 766. The wheels 769a, 769b, 769c and 769d are respectively mounted on the shafts 768a, 768b, 768c and 768d, so that each wheel is constrained to rotate relative to the support component 766 around the axis of the respective shaft.

The driving wheel mechanism 765 further comprises a motor 84E comprising a shaft and a base component. The base component of the motor 84E is fixedly connected to the bearing housing 766b. The shaft of the motor 84E is fixedly connected to the shaft 767, so that the motor 84E can drive a rotation in the shaft 767 and hence in the wheel 767w relative to the support component 766 around the axis of the shaft 767. As shown in FIG. 25A, the motor 84E is connected to a computer 904 via wires 86E, the computer 904 is configured to send signals to the motor 84E as to control the timing and the degree of rotation of the motor 84E.

Referring to FIG. 25B, a universal wheel mechanism 771 comprises: a support component 775; a connector 772 comprising two bearing housings 772a and 772b as parts; a connecting component 774 comprise a vertical shaft 774a; a shaft 779 comprising a horizontal axis; shafts 773a, 778a, 778b, 778c and 778d, each comprising a vertical axis; and wheels 776, 777a, 777b, 777c and 777d. The shaft 773a is rigidly connected to a top part 775a of the support component 775. The shaft 773a is configured to be connected to the bearing housing 772a by bearings and accessories, so that the support component 775 and the shaft 773a are constrained to rotate relative to the bearing housing 772a (or equivalently, relative to the connector 772) around the axis of the shaft 773a. The shaft 774a of the connecting component 774 is configured to be connected to the bearing housing 772b by bearings and accessories, so that the connecting component 774 is constrained to rotate relative to the bearing housing 772b (or equivalently, relative to the connector 772) around the axis of the shaft 774a. The shaft 779 is configured to be fixedly connected to the support component 775. The wheel 776 is mounted on the shaft 779, so that the wheel 776 is constrained to rotate relative to the shaft 779 (and hence relative to the support component 775) around the axis of the shaft 779. The shafts 778a, 778b, 778c and 778d are configured to be rigidly connected to (some bottom parts of) the support component 775. The wheels 777a, 777b, 777c and 777d are respectively mounted on the shafts 768a, 768b, 768c and 768d, so that each wheel is constrained to rotate relative to the support component 775 around the axis of the respective shaft.

The vehicle 790 further comprises: a plurality of round holding cups 785a, 785b and 785c wherein each holding cup 785a, 785b or 785c comprises a vertical axis; a rechargeable battery 791 configured to power electrical or electronic devices on the vehicles; a plurality of mounting devices 789 configured to fixedly connect the rechargeable battery 791 to the support component 786; an insulation component 792 made of plastic or other electric insulating material; and a pair of electrical inlets 793a and 793b connected to the rechargeable battery 791 by wires. The electrical inlets 793a and 793b and the insulation component 792 are all fixedly connected to the support component 786. The holding cups 785a, 785b and 785c are fixedly connected to the support component 786. Each holding cup, 785a, 785b or 785c, is configured to hold an ingredient container 107 of a specific diametrical size.

The holding cups 785a, 785b and 785c are also referred to as container holders. It should be noted that the holding cups 785a, 785b and 785c in the vehicle 790 may be substituted by other types of container holders.

The vehicle 790 further comprises: an L-shaped support component 782 comprising a vertical board and horizontal board; a magnet 783 configured to fixedly mounted on the vertical board of the L-shaped support component 782; a connector 781 configured to fixedly connected to the vertical board of the L-shaped support component 782; and two proximity switches 94L and 94G connected to the connector 781 (see FIG. 25D). The horizontal board of the L-shaped support component 782 is rigidly connected to the support component 786. The proximity switches 94L and 94G are connected to the computer 904 via wires 96L and 96G, so that the computer 904 may receive signals from the proximity switches 94L and 94G.

Each holding cup 785a on a vehicle 790 may hold an ingredient container 107 so that the movement of said ingredient container may be restricted or limited when the vehicle is moving. Similarly, each holding cup 785b on each vehicle 790 is configured to hold an ingredient container 107b wherein said ingredient container 107b is similarly configured as an ingredient container 107 except the size.

The vehicle 790 may comprise an electromagnet controlled by the computer 904. The computer 904 is configured to monitor the rechargeable battery 791. If the rechargeable battery is running low, the computer 904 is configured to turn on the electromagnet; otherwise the computer turns off the electromagnet. The electro-magnetic signal may be sensed by a sensor mounted next to a rail track, wherein said sensor is connected to the computer system 909. The computer system can then automatically control the motion of the vehicle 790 so the vehicle can arrive at a charging station, so that the rechargeable battery gets charged.

The vehicle 790 is configured to move on a pair of rail tracks 623a and 623b (see FIG. 25E). The driving wheels 767w are configured to move on and touch the top surface of the rail track 623b. The wheels 776 are configured to move on and touch the top surface of the rail track 623a. The pair of wheels 769a and 769c (or the pair of wheels 769b and 769d) of each driving wheel mechanism 765 are configured to be limited by or to touch the opposite sides of the rail track 623b. The pair of wheels 777a and 777c (or the pair of wheels 777b and 777d) of each universal wheel mechanism 771 are configured to be limited by or to touch the opposite sides of the rail track 623a. The rail tracks 623a and 623b are straight and have a fixed width.

It should be noted that the vehicle 790 may move on a pair of curved rail tracks whose widths are smaller than the widths of straight rail tracks.

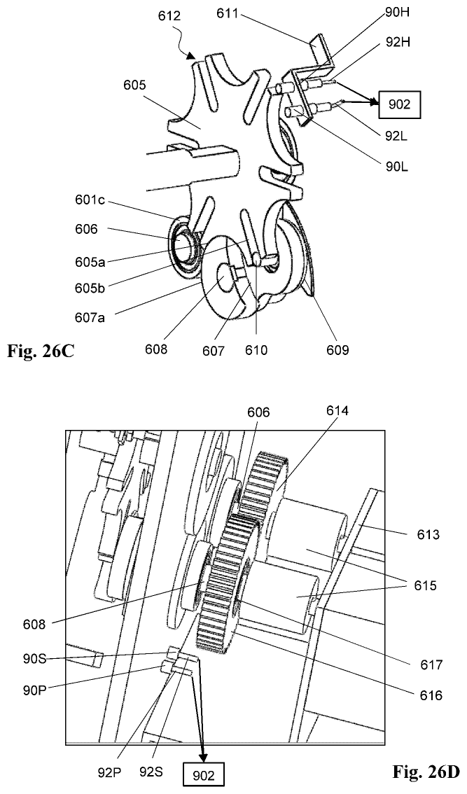

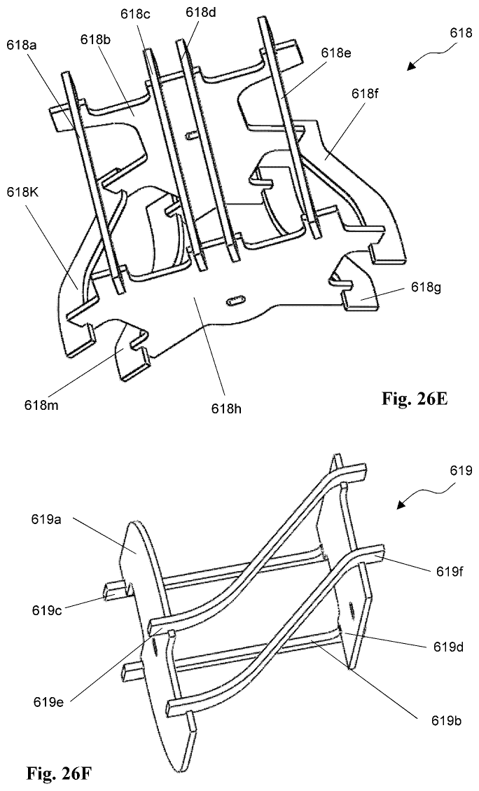

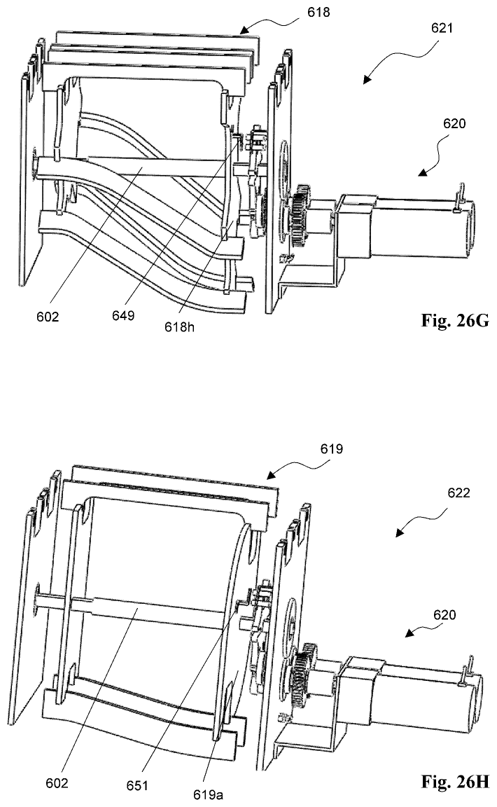

Referring to FIGS. 26A-26D, a track switch sub-mechanism 620 comprises: a support component 601 comprising three bearing housings 601a, 601b and 601c; a support component 603 comprising a bearing housing 603a; a Geneva drive mechanism 612 comprising a driven wheel 605 and a driving wheel 607; a shaft 602. The driven wheel 605 comprises a plurality of round curve 605a on its boundary and a plurality of slots 605b, and the driving wheel 607 of the Geneva drive mechanism 612 comprises a partial disk 607a. The radius of the round curve 605a on the boundary of the driven wheel 605 is configured to be equal to the radius of the partial disk 607a, and the width of the slot 605b is configured to be equal to (or slightly larger than) the diameter of a shaft 610 which is connected to the driving wheel 607 by bearings and accessories so that the shaft 610 is constrained to rotate relative to the driving wheel 607 around the axis of the shaft 610. For the purpose of present patent application, a partial disk is meant to be a part of a round disk. The support component 601 and the support component 603 are configured to be rigidly or fixedly connected to each other, by known techniques. The axis of the bearing housing 601a and the axis of the bearing housing 603a are configured to be coincide. The shaft 602 is configured to be connected to the bearing housing 601a of the support component 601 and to the bearing housing 603a by bearings and accessories, and the driven wheel 605 is configured to be fixedly connected to the shaft 602, so that the driven wheel 605 is constrained to rotate relative to the support component 601 (or equivalently, relative to the support component 603), around the axis of the shaft 602.

The track switch sub-mechanism 620 further comprises a shaft 608. The shaft 608 is connected to the bearing housing 601b of the support component 601 by bearings and accessories, so that the shaft 608 is constrained to rotate relative to the support component 601 around the axis of the shaft 608. The driving wheel 607 is fixedly connected to the shaft 608. The rotation of the driving wheel 607 and the shaft 608 produces an intermittent rotation of the driven wheel 605 of the Geneva drive mechanism 612, when the shaft 610 reaches the slots 605b of the driven wheel 605. The partial disk 607a of the driving wheel 607 is configured to lock the driven wheel 605 when the shaft 610 is moved away from the slots 605b of the driving wheel 605. When the shaft 608 (and the driving wheel 607) is rotated one round (360 degrees in a direction, starting from a locking position, when the partial disk 607a locks the driven wheel 605), the shaft 602 is rotated by a fixed angle (in the opposite direction), which is referred to as the period of the intermittent motion.

The track switch sub-mechanism 620 further comprises: a shaft 606 and a gear 614; a gear 616; a one-way freewheel clutch bearing 617 comprising an outer ring and an inner ring. In our application, the inner ring of the one-way freewheel clutch bearing 617 may freely rotate relative to the outer ring in the clockwise direction (as seen in the figures) around the axis of the one-way freewheel clutch bearing 617; but the rotation of the inner ring relative to the outer ring in the counter-clockwise direction is restricted. The gear 616 comprises a hole at its center and is concentric with the shaft 608. The gear 616 is connected to the shaft 608 by the one-way freewheel clutch bearing 617 and accessories, so that a rotation of the gear 616 in the clockwise direction induces a rotation of the shaft 608 in the same direction, but the shaft 608 is free to rotate in the clockwise direction relative to the gear 616. The gear 614 is fixedly connected to and concentric with the shaft 606. The shaft 606 is connected to the bearing housing 601c of the support component 601 by bearings and accessories, so that the shaft 606 and the gear 614 are constrained to freely rotate relative to the support component 601 around the axis of the shaft 606. The gears 614 and 616 are engaged and have the same radii. A rotation of 360 degrees in the shaft 606 and the gear 614 in the counter-clockwise direction may induce a rotation of 360 degrees in the gear 616 in the clockwise direction, which may induce a rotation of 360 degrees in the clockwise direction of the shaft 608 and the driving wheel 607, and hence an intermittent rotation of the shaft 602 and the driven wheel 605 of 1 period, in case the driving wheel 607 was in a locking position at the start of the rotation.

The track switch sub-mechanism 620 further comprises: two motors 80L and 80F each comprising a shaft and a base component; a connecting component 613; and two coupling 615. The base components of the motors 80L and 80F are configured to be fixedly connected to the support component 601 by the connecting component 613. The shaft of the motor 80L is configured to be fixedly connected to the shaft 608 via a first coupling 615. The shaft of the motor 80F is configured to be fixedly connected to the shaft 606 via second coupling 615.

When the motor 80F is not powered, the motor 80L is configured to drive a rotation in the clockwise direction of the shaft 608, relative to the support component 601, around the axis of the shaft 608, but the gear 616 may not be rotated at the same time. The rotation of 360 degrees in the shaft 608 (starting from a locking position) as driven by the motor 80L induces an intermittent rotation (in the counterclockwise direction) in the shaft 602 of 1 period. Thus, the motor 80L may produce an intermittent rotation in the shaft 602.

When the motor 80L is not powered, the motor 80F is configured to drive a rotation in the counterclockwise direction of the shaft 606, relative to the support component 601, around the axis of the shaft 606. As explained, a rotation of the shaft 606, of 360 degrees in the counter-clockwise direction induces an intermittent rotation in the shaft 602 around the axis of the shaft 602, of 1 period in the counter-clockwise direction. Thus, the motor 80F may also produce an intermittent rotation in the shaft 602. The motor 80F is used only in case the motor 80L fails. In other words, the motor 80F is a back-up motor; and it is not powered unless the motor 80L fails to work as desired.

Referring to FIGS. 26C-26D, the track switch sub-mechanism 620 further comprises: two proximity switches 90P and 90S configured to be fixedly connected to the support component 601; two proximity switches 90L and 90H; a connector 611 configured to fixedly connect the proximity switches 90L and 90H to the support component 601; and a target 609 configured to be rigidly connected to the driving wheel 607 of the Geneva drive mechanism 612. The proximity switch 90L or 90H may monitor targets which are rigidly connected to the shaft 602. The proximity switch 90P or 90S are configured to monitor the target 609 when the target 609 is rotated with the driving wheel 607 of the Geneva drive mechanism 612. The target 609 is configured to be sensed by the proximity switches 90P and 90S when the driving wheel 607 is rotated to the central locking position, when the shaft 610 is farthest away from the shaft 602, at which point the partial disk 607a of the driving wheel 607 is touching a round curve 605a of the driven wheel 605.

As shown in FIGS. 26A-26B, the motors 80L and 80F are respectively connected to the computer 902 via wires 82L and 82F. The computer 902 is configured to dynamically control the timing of the motor 80L or respectively 80F. The proximity switches 90L and 90H, 90S and 90P are connected to the computer 902 respectively via wires 92L and 92H, 92S and 92P. The computer 902 may also send signals to the motor 80L or respectively 80F as to control the degree of rotation of the motor.

When the target 609 is sensed by the proximity switch 90P, the signals from the proximity switch 90P to the computer 902 are received, and the computer 902 may be configured to stop the motor 80L as to complete an intermittent rotation and stop at a locking position. It is also possible for the computer 902 to control the motor 80L as to complete two or more consecutive intermittent rotations in the shaft 602 (of 1 period for each intermittent rotation). Similarly, when the motor 80L is not powered, using signals from the proximity switch 90S, the computer 902 may control the motor 80F as to complete one, two, or more intermittent rotations in the shaft 602 in the counterclockwise direction.

A position for the driven wheel 605, when the partial disk 607a of the driving wheel 607 locks the driven wheel 605, will be referred to as a locking position of the driven wheel 605.

Referring to FIG. 26E, a device 618 comprises: two vertical boards 618h and 618b, a first group of rail tracks comprising two pairs of linear rail tracks 618a and 618c, 618d and 618e; a second group of rail tracks comprising a pair of curved rail tracks 618f and 618g; a third group of rail tracks comprising a pair of curved rail tracks 618k and 618m. All rail tracks 618a, 618c, 618d, 618e, 618f, 618g, 618k and 618m are configured to be fixedly connected to the vertical boards 618h and 618b. The rail tracks in each group of rail tracks are configured to be coplanar. The boards and the rail tracks are configured to be rigidly connected to each other, so the device 618 may be regarded as a rigid body.

Referring to FIG. 26F, a device 619 comprises: two vertical boards 619a and 619d; a first group of rail tracks comprising a pair of curved rail tracks 619e and 619b; a second group of rail tracks comprising a pair of linear rail tracks 619c and 619f. All rail tracks 619e, 619b, 619c and 619f are configured to be fixedly connected to the vertical boards 619a and 619d. The boards and the rail tracks are configured to be rigidly connected to each other, so the device 619 may also be regarded as a rigid body.

Referring to FIG. 26G, a track switch mechanism 621 comprises the track switch sub-mechanism 620, a device 618, and a target 649 configured to be fixedly connected to the vertical board 618b of the device 618. The vertical boards 618h and 618b of the device 618 are configured to be fixedly connected to the shaft 602 of the track switch sub-mechanism 620, so that the device 618 and the target 649 may be rotated relative to the support component 601 of the track switch sub-mechanism 620 around the axis of the shaft 602. When the device 618 is rotated to a specific position where the proximity switch 90L or 90H senses the target 649, the signals of the proximity switch 90L (or respectively 90H) are sent to the computer 902. The computer 902 is configured to record the position of the target 649, and the position of the device 618. When the driving wheel 607 of the Geneva drive mechanism 612 is rotated to a position where the proximity switch 90P (or 90S) senses the target 609, the signals of the proximity switch 90P (or respectively 90S) are sent to the computer 902. The computer 902 is configured to record the position of the target 609, and the position of the driving wheel 607 of the Geneva drive mechanism 612. The computer 902 is configured to keep track of the number of revolutions of the shaft 608, by dynamically counting the signals sent by the proximity switch 90P (or respectively 90S). The proximity switch 90L or 90H is configured to sense the target 649 when the driven wheel 605 is rotated to a specific locking position. The specific locking position is memorized by the computer 902. Using information sent by the proximity switches 90P and 90L (or respectively 90S and 90H), the computer 902 is configured to compute the position of the device 618.

When the driven wheel 605 is at one of three locking positions, a group of rail tracks of the device 618 is configured to connect pairs of ends of rail tracks that are fixedly mounted.

Referring to FIG. 26H, a track switch mechanism 622 comprises: a track switch sub-mechanism 620, a device 619, and a target 651 configured to be fixedly connected to the vertical board 619a of the device 619. The vertical boards 619d and 619a of the device 619 are configured to be fixedly connected to the shaft 602 of the track switch sub-mechanism 620, so the device 619 and the target 651 may be rotated relative to the support component 601 of the track switch sub-mechanism 620 around the axis of the shaft 602. When the device 619 is rotated to a specific position where the proximity switch 90L or 90H senses the target 651, the signals of the proximity switches 90L (or respectively 90H) are sent to the computer 902. The computer 902 is configured to record the position of the target 651, and the position of the device 619. When the driving wheel 607 of the Geneva drive mechanism 612 is rotated to a position where the proximity switch 90P (or 90S) senses the target 609, the signals of the proximity switches 90P (or respectively 90S) are sent to the computer 902. The computer 902 is configured to record the position of the target 609, and the position of the driving wheel 607 of the Geneva drive mechanism 612. The computer 902 is configured to keep track of the number of revolutions of the shaft 608, by dynamically counting the signals sent by the proximity switch 90P (or respectively 90S). The proximity switch 90L or 90H is configured to sense the target 649 when the driven wheel 605 is rotated to a specific locking position. The specific locking position is memorized by the computer 902. Using information sent by the proximity switches 90P and 90L (or respectively 90S and 90H), the computer 902 is configured to compute the position of the device 619.

When the driven wheel 605 is at one of two locking positions, a group of rail tracks of the device 619 is configured to connect pairs of ends of rail tracks that are fixedly mounted.

The track switch mechanism 621 is referred to as a track switch mechanism of type I. A track switch mechanism 622 is referred to as a track switch mechanism of type II.

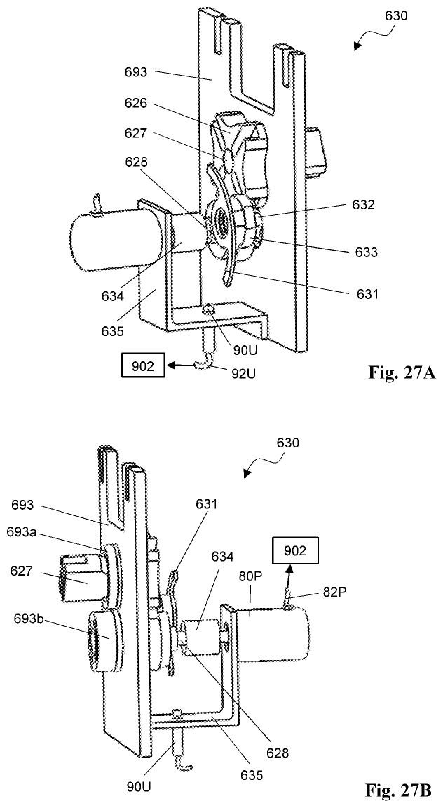

Referring to FIGS. 27A-27B, a rotating mechanism 630 comprises a support component 693, a bearing housing 693b configured to be rigidly connected to the support component 693, and a shaft 628. The shaft 628 is connected to the bearing housing 693b by bearings and accessories, so that the shaft 628 is constrained to rotate relative to the bearing housing 693b (or equivalently, relative to the support component 693) around the axis of the shaft 628.

The rotating mechanism 630 further comprises: a driving wheel 633 comprising a partial disk; a shaft 632; a shaft 627; a bearing housing 693a configured to be rigidly connected to the support component 693; a driven wheel 626 comprising a plurality of round curve on its boundary and a plurality of slots. The radius of the round curve on the boundary of the driven wheel 626 is configured to be equal to the radius of the partial disk of the driving wheel 633, and the width of the slot of the driven wheel 626 is configured to be equal to (or slightly larger than) the diameter of a shaft 632. The driving wheel 633 is fixedly connected to the shaft 628, and the shaft 632 is connected to the driving wheel 633 by bearings and accessories, so that the shaft 632 is constrained to freely rotate relative the driving wheel 633 around the axis of the shaft 632. The shaft 627 is configured to be connected to the bearing housing 693a by bearings and accessories, and the driven wheel 626 is fixedly connected to the shaft 627, so the shaft 627 and the driven wheel 626 are constrained to rotate relative to the bearing housing 693a (or equivalently, relative to the support component 693) around the axis of the shaft 627. The rotation of the driving wheel 633 and the shaft 628 produces an intermittent rotation of the driven wheel 626, when the shaft 632 reaches the slots of the driven wheel 626. The partial disk of the driving wheel 633 is configured to lock the driven wheel 626 when the shaft 632 is moved away from the slots of the driving wheel 633. When the shaft 628 (and the driving wheel 633) is rotated one round (360 degrees in a direction, starting from a locking position, when the partial disk of the driving wheel 633 locks the driven wheel 626), the shaft 627 is rotated by a fixed angle (i.e., 90 degrees in the opposite direction), which is referred to as the period of the intermittent motion.

As shown in FIG. 27B, the rotating mechanism 630 further comprises a motor 80P comprising a shaft and a base component; a coupling 634; and a connecting component 635. The base component of the motor 80P is configured to be fixedly connected to the support component 693 by the connecting component 635. The shaft of the motor 80P is configured to be fixedly connected to the shaft 628 by the coupling 634. Thus, the motor 80P may drive a rotation of the shaft 628 relative to the support component 693 around the axis of the shaft 628.

The motor 80P is configured to drive a rotation the shaft 628, relative to the support component 693, around the axis of the shaft 628. The rotation of 360 degrees in the shaft 628 (starting from a certain position) as driven by the motor 80P induces an intermittent rotation in the shaft 627 of 1 period. Thus, the motor 80P may produce an intermittent rotation in the shaft 627.

The rotating mechanism 630 further comprises a proximity switch 90U configured to be fixedly connected to the connecting component 635, and a target 631 configured to be rigidly connected to the driving wheel 633. The proximity switch 90U may monitor the position of the target 631 when the target 631 is rotated with the driving wheel 633. The target 631 is configured to be sensed by the proximity switch 90U when the driving wheel 633 is rotated to a certain locking position when the shaft 632 is farthest away from the shaft 627, when the round curve of the driving wheel 633 is touching a round curve of the driven wheel 626.

As shown in FIGS. 27A-27B, the motor 80P is connected to the computer 902 via wires 82P. The computer 902 is configured to dynamically control the timing of the motor 80P. The proximity switch 90U is connected to the computer 902 via wires 92U. The computer 902 may also send signals to the motor 80P as to control the degree of rotation of the motor.

When the target 631 is sensed by the proximity switch 90U, the signals from the proximity switch 90U to the computer 902 are received, and the computer 902 may be configured to stop the motor 80P as to complete an intermittent rotation in the shaft 627 of 1 period and stop at a locking position. It is also possible for the computer 902 to control the motor 80P as to complete two or more consecutive intermittent rotations in the shaft 627 (of 1 period for each intermittent rotation).

A position for the driven wheel 626, when the partial disk of the driving wheel 633 locks the driven wheel 626, will be referred to as a locking position of the driven wheel 626.

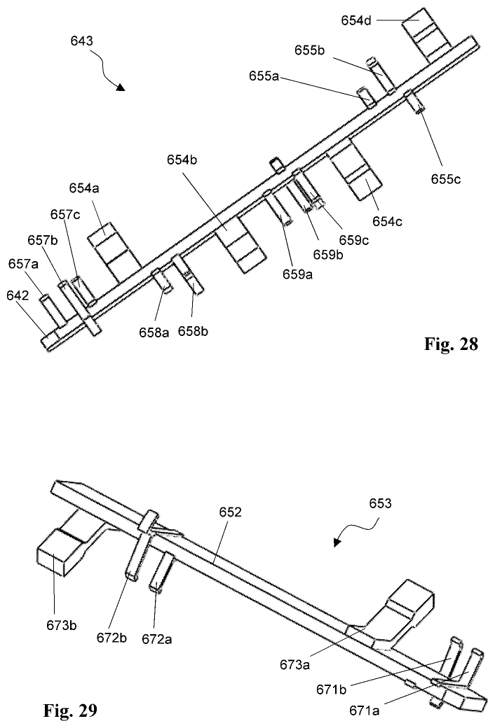

Referring to FIG. 28, a stopping device 643 comprises: a support component 642; stoppers 654a, 654b, 654c and 654d; and targets 657a, 657b, 657c, 658a, 658b, 659a, 659b and 659c, 655a, 655b and 655c. The stoppers comprise ferromagnetic materials which can be attracted by the magnet 783 of a vehicle 790, and the targets are configured to be sensed by the proximity switches 94G and 94L of a vehicle 790. The stoppers and the targets are all rigidly connected to the support component 642, so the stopping device 643 may be regarded as a rigid body.

Referring to FIG. 29, a stopping device 653 comprises: a support component 652; stopper 673a and 673b; and targets 671a, 671b, 672a and 672b. The stoppers 673a and 673b comprise ferromagnetic materials which can be attracted by the magnet 783 of a vehicle 790, and the targets are configured to be sensed by the proximity switches 94G and 94L of a vehicle 790. The stoppers and the targets are all rigidly connected to the support component 652, so the stopping device 653 may be regarded as a rigid body.

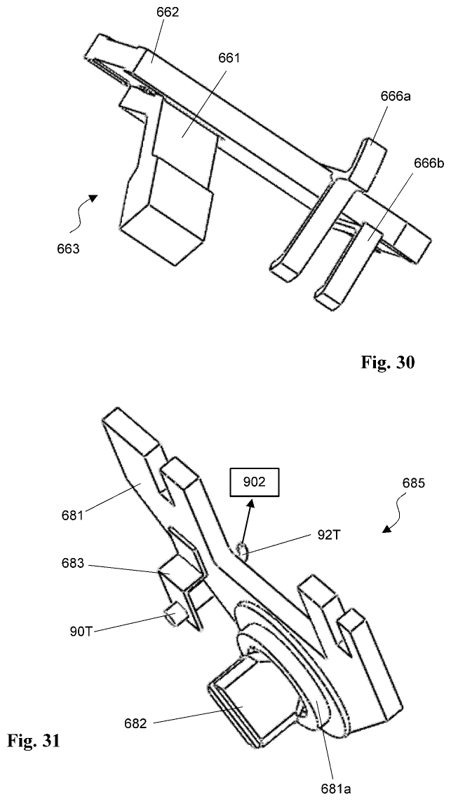

Referring to FIG. 30, a stopping device 663 comprises a support component 662, a stopper 644 and two targets 666a and 666b. The stopper 644 comprise ferromagnetic materials which can be attracted by the magnet 783 of a vehicle 790, and the targets are configured to be sensed by the proximity switches 94G and 94L of a vehicle 790. The stopper 644 and the targets 666a and 666b are all rigidly connected to the support component 662, so the stopping device 663 may be regarded as a rigid body.

Each of the stopper of the stopping device 643 (or 653, 663) comprises a ferromagnetic material which can be attracted by the magnet 783 on a vehicle 790, and the targets of the stopping device 643 (or 653, 663) are configured to be sensed by the proximity switches 94G and 94L on a vehicle 790.

Referring to FIG. 31, a stopping sub-mechanism 685 comprises: a support component 681; a bearing housing 681a configured to be rigidly connected to the support component 681; a shaft 682; a connector 683; and a proximity switch 90T. The shaft 682 is configured to be connected to the bearing housing 681a by bearings and accessories, so that the shaft 682 is constrained to rotate relative to the bearing housing 681a (or equivalently, relative to the support component 681), around the axis of the shaft 682 (see FIG. 31). The connector 683 is configured to connect the proximity switch 90T to the support component 681. The proximity switch 90T is connected to the computer 902 via wires 92T, so the computer 902 may receive signals from the proximity switch 90T.

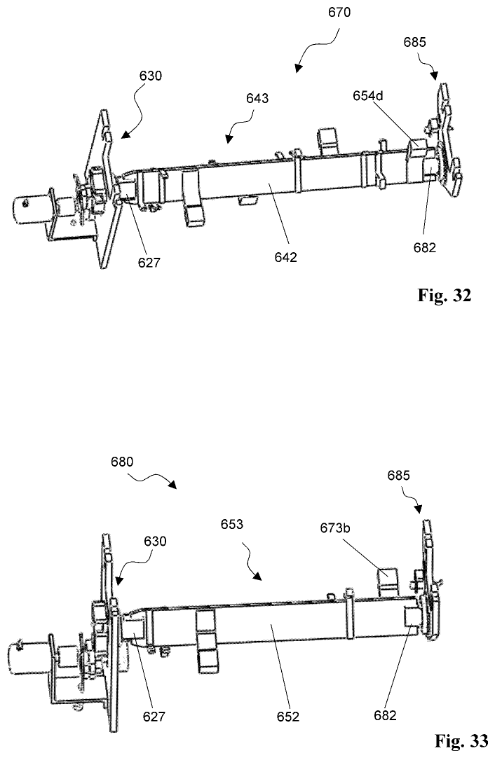

Referring to FIG. 32, a stopping mechanism 670 comprises the rotating mechanism 630, the stopping sub-mechanism 685, and the stopping device 643. The shaft 627 of the rotating mechanism 630 and the shaft 682 are fixedly connected to the support component 642 of the stopping device 643, and the axis of the shaft 627 of the rotating mechanism 630 is configured to coincide with the axis of the shaft 682. The rotating mechanism 630 are configured to drive an intermittent rotation in the stopping device 643 relative to the support component 693 (or equivalently, relative to the support component 681) around the axis of the shaft 627. The proximity switch 90T may monitor the position of the stopper 654d when the stopper 654d is rotated with the stopping device 643. The stopper 654d is configured to be sensed by the proximity switch 90T when the stopping device 643 is rotated to a specific position.

When the stopping device 643 is rotated to a specific position where the proximity switch 90T senses the stopper 654d, the signals of the proximity switch 90T are sent to the computer 902. The computer 902 is configured to record the position of the stopper 654d, and the position of the stopping device 643. When the driving wheel 633 is rotated to a position where the proximity switch 90U senses the target 631, the signals of the proximity switch 90U are sent to the computer 902. The computer 902 is configured to record the position of the target 631, and the position of the driving wheel 633. The computer 902 is configured to keep track of the number of revolutions of the shaft 628, by dynamically counting the signals sent by the proximity switch 90U. The proximity switch 90T is configured to sense the stopper 654d when the driven wheel 626 is rotated to a specific locking position. The specific locking position is memorized by the computers 902. Using information sent by the proximity switches 90U and 90T, the computer 902 is configured to compute the position of the stopping device 643.

When the driven wheel 626 is at one of four locking positions, one of the stoppers of the stopping device 643 is configured to be attracted by the magnet 783 on a vehicle 790 as to stop the vehicle 790 in a specific position where the proximity switches 94G and 94L on the vehicle 790 sense the targets of the stopping device 643.

Referring to FIG. 33, a stopping mechanism 680 comprises the rotating mechanism 630, the stopping sub-mechanism 685, and the stopping device 653. The shaft 627 of the rotating mechanism 630 and the shaft 682 are fixedly connected to the support component 652 of the stopping device 653, and the axis of the shaft 627 of the rotating mechanism 630 is configured to coincide with the axis of the shaft 682. The rotating mechanism 630 are configured to drive an intermittent rotation in the stopping device 653 relative to the support component 693 (or equivalently, relative to the support component 681) around the axis of the shaft 627. The proximity switch 90T may monitor the position of the stopper 673b when the stopper 673b is rotated with the stopping device 653. The stopper 673b is configured to be sensed by the proximity switch 90T when the stopping device 653 is rotated to a specific position.

When the stopping device 653 is rotated to a specific position where the proximity switch 90T senses the stopper 673b, the signals of the proximity switch 90T are sent to the computer 902. The computer 902 is configured to record the position of the stopper 673b, and the position of the stopping device 653. When the driving wheel 633 is rotated to a position where the proximity switch 90U senses the target 631, the signals of the proximity switch 90U are sent to the computer 902. The computer 902 is configured to record the position of the target 631, and the position of the driving wheel 633. The computer 902 is configured to keep track of the number of revolutions of the shaft 628, by dynamically counting the signals sent by the proximity switch 90U. The proximity switch 90T is configured to sense the stopper 673b when the driven wheel 626 is rotated to a specific locking position. The specific locking position is memorized by the computers 902. Using information sent by the proximity switches 90U and 90T, the computer 902 is configured to compute the position of the stopping device 653.

When the driven wheel 626 is at one of two locking positions, one of the stoppers of the stopping device 653 is configured to be attracted by the magnet 783 on a vehicle 790 as to stop the vehicle 790 in a specific position where the proximity switches 94G and 94L on the vehicle 790 sense the targets of the stopping device 653.

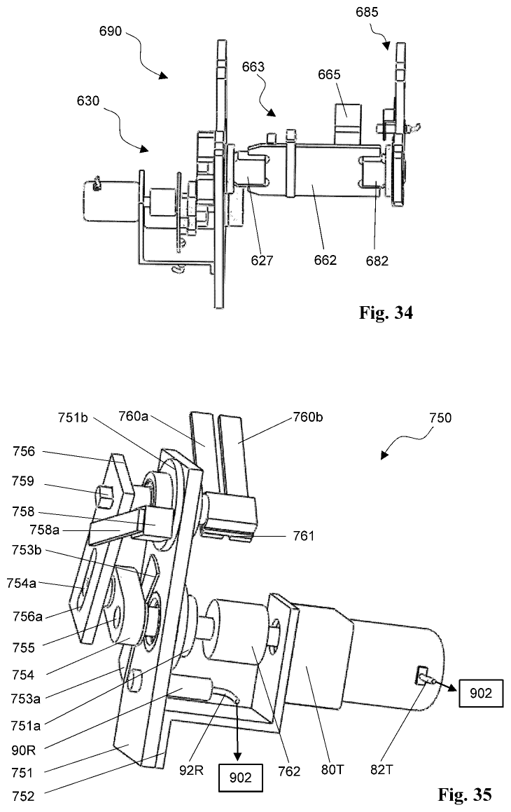

Referring to FIG. 34, a stopping mechanism 690 comprises the rotating mechanism 630, the stopping sub-mechanism 685, and the stopping device 663. The shaft 627 of the rotating mechanism 630 and the shaft 682 are fixedly connected to the support component 662 of the stopping device 663, and the axis of the shaft 627 of the rotating mechanism 630 is configured to coincide with the axis of the shaft 682. The rotating mechanism 630 are configured to drive an intermittent rotation in the stopping device 663 relative to the support component 693 (or equivalently, relative to the support component 681) around the axis of the shaft 627. The proximity switch 90T may monitor the position of the stopper 665 when the stopper 665 is rotated with the stopping device 663. The stopper 665 is configured to be sensed by the proximity switch 90T when the stopping device 663 is rotated to a specific position.

When the driving wheel 633 is rotated to a position where the proximity switch 90U senses the target 631, the signals of the proximity switch 90U are sent to the computer 902. The computer 902 is configured to record the position of the target 631, and the position of the driving wheel 633. The computer 902 is configured to keep track of the number of revolutions of the shaft 628, by dynamically counting the signals sent by the proximity switch 90U. The proximity switch 90T is configured to sense the stopper 665 when the driven wheel 626 is rotated to a specific locking position. The specific locking position is memorized by the computers 902. Using information sent by the proximity switches 90U and 90T, the computer 902 is configured to compute the position of the stopping device 663.

When the driven wheel 626 is at a locking position, the stopper 665 of the stopping device 663 is configured to be attracted by the magnet 783 on a vehicle 790 as to stop the vehicle 790 in a specific position where the proximity switches 94G and 94L on the vehicle 790 sense the targets of the stopping device 663.

The proximity switches 94L and 94G of a vehicle 790 are configured to sense the targets of the stopping mechanisms 670 (or respectively 680, 690). As explained earlier, the magnet 783 attaches a stopper of the stopping mechanisms 670 (or respectively 680, 690) when the proximity switches 94L and 94G sense the targets of the stopping mechanisms 670 (or respectively 680, 690), the computer 904 may receive signals from the proximity switches 94L and 94G. The computer 904 is configured to send signals to the motor 80F of the driving wheel mechanism 765 as to stop the motor 80E at the position for a time period during which some mechanisms and apparatuses can complete a corresponding process.

Referring to FIG. 35, a charging sub-mechanism 750 comprises: a support component 751 in the shape of a board; a bearing housing 751a configured to be rigidly connected to the support component 751; a shaft 755 comprising a horizontal axis; a connector 754 configured to be rigidly connected to the shaft 755; and a shaft 754a configured to be connected to the connector 754. The shaft 755 is connected to the bearing housing 751a by bearings and accessories, so that the shaft 755 is constrained to rotate relative to the bearing housing 751a (or equivalently, relative to the support component 751) around the axis of the shaft 755. The charging sub-mechanism 750 further comprises: a bearing housing 751b configured to be rigidly connected to the support component 751; a shaft 759 comprising a horizontal axis; a driven wheel 756 comprising a curved slot 756a; an insulation component 761 made of plastic or other electric insulating material; a pair of electrical outlets 760a and 760b connected to a power source by wires (not shown in figure); and a weight 758 configured to be rigidly connected to the driven wheel 756 by a connector 758a. The pair of electrical outlets 760a and 760b are fixedly connected to the shaft 759 by the insulation component 761, the insulation component 761 is mounted on the middle of the pair of electrical outlets 760a and 760b and the shaft 759. The driven wheel 756 is configured to be fixedly connected to the shaft 759. The shaft 759 is connected to the bearing housing 751b by bearings and accessories, so that the shaft 759 is constrained to rotate relative to the bearing housing 751b (or equivalently, relative to the support component 751) around the axis of the shaft 759. Thus, the driven wheel 756 and the pair of electrical outlets 760a and 760b are constrained to rotate relative to the support component 751 around the axis of the shaft 759. The shaft 754a is configured to be inserted in and be constrained by the curved slot 756a of the driven wheel 756, so that a movement of the shaft 754a may induce a rotation in the driven wheel 756 (or equivalently, in the pair of electrical outlets 760a and 760b) around the axis of the shaft 759.

The charging sub-mechanism 750 further comprises: a stepper motor 80T comprising a shaft and a base component; a connecting component 752; a coupling 762; two targets 753a and 753b; and a proximity switch 90R. The base component of the motor 80T is fixedly connected to the support component 751 by the connecting component 752 and the shaft of the motor 80T is fixedly connected to the shaft 755 by the coupling 762. When the motor 80T drives a rotation of the shaft 755, the axis of the shaft 754a is rotated around the axis of the shaft 755. The movement of the axis of the shaft 754a induces a rotation in the pair of electrical outlets 760a and 760b around the axis of the shaft 759 as to touch or move away from a pair of electrical inlets 793a and 793b on a vehicle 790. The targets 753a and 753b are configured to be rigidly attached on the connector 754. The proximity switch 90R is configured to be fixedly connected to the support component 751. The proximity switch 90R is configured to monitor the targets 753a and 753b when the targets are rotated with the connector 754.

The motor 80T is connected to the computer 902 via wires 82T. The proximity switch 90R is connected to the computer 902 via wires 92R, so the computer 902 may receive signals from the proximity switch 90R. The computer 902 is configured to send signals to the motor 80T as to control the timing and the degree of rotation of the motor 80T. When the pair of electrical outlets 760a and 760b are rotated around the axis of the shaft 759 to a first position where the proximity switch 90R senses the target 753a, the pair of electrical outlets 760a and 760b are configured to be moved away from the pair of electrical inlets 793a and 793b on a vehicle 790. Similarly, when the pair of electrical outlets 760a and 760b are rotated around the axis of the shaft 759 to a second position where the proximity switch 90R senses the targets 753b, the pair of electrical outlets 760a and 760b are configured to touch the pair of electrical inlets 793a and 793b on a vehicle 790.

Each time, the pair of electrical outlets 760a and 760b are moved to the second position, the motor 80T, under the control of the computer 902, is stopped for a time period during which the charging sub-mechanism 750 completes a charging process. After this time, the motor 80T, under the control of the computer 902, may restart again and make a reverse rotation to rotate the pair of electrical outlets 760a and 760b to the first position.

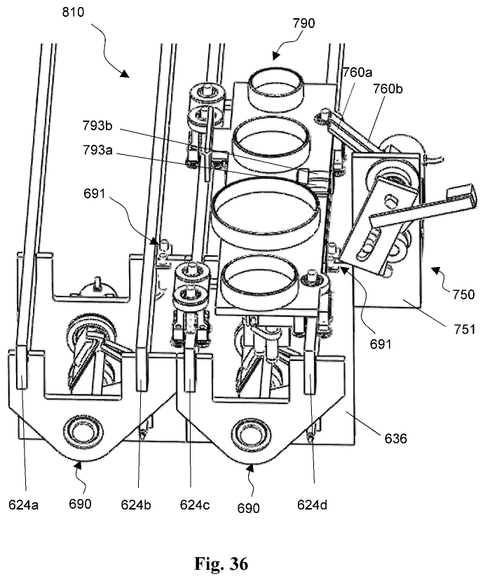

Referring to FIG. 36, a charging mechanism 810 comprises: two stopping mechanism 690 and a charging sub-mechanism 750. One of the stopping mechanisms 690 is configured to be fixedly connect a pair of rail tracks 624c and 624d, and the support component 751 of the charging sub-mechanism 750 is rigidly connected to the support component 636 of the stopping mechanism 690. Another of the stopping mechanisms 690 is configured to be fixedly connected to a pair of rail tracks 624a and 624b.

A vehicle 790 may be stopped at a special position by the stopping mechanism 690 where the charging sub-mechanism 750 may charge the rechargeable battery 791 of the vehicle 790, when the magnet 783 of the vehicle 790 holds the stopper 665 of the stopping mechanism 690 and the proximity switches 94G and 94L of the vehicle 790 sense the targets of the stopping mechanism 690. When the computer 904 sends signals to stop the motors 84E of the driving wheel mechanisms 765, the computer 902 may control the motor 80T of the charging sub-mechanism 750 to drive the rotation in the pair of electrical outlets 760a and 760b as to touch the pair of electrical inlets 793a and 793b on a vehicle 790. Thus, the charging process may be controlled by the computers 902 and 904.

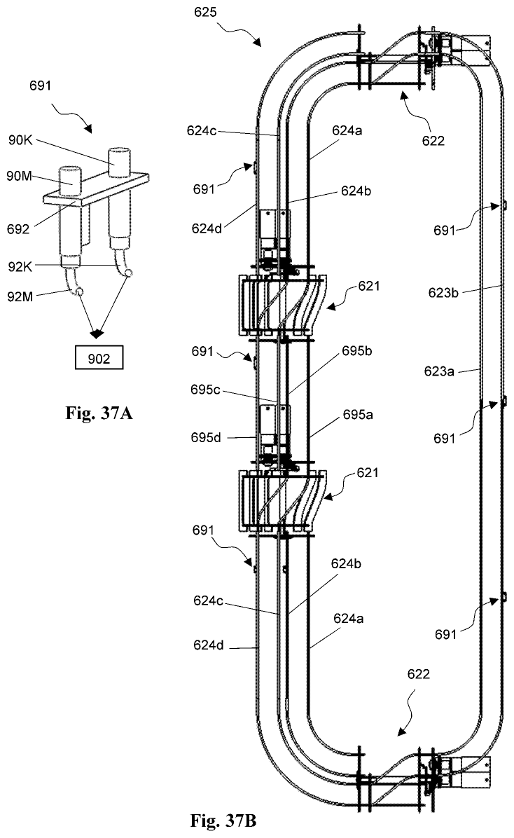

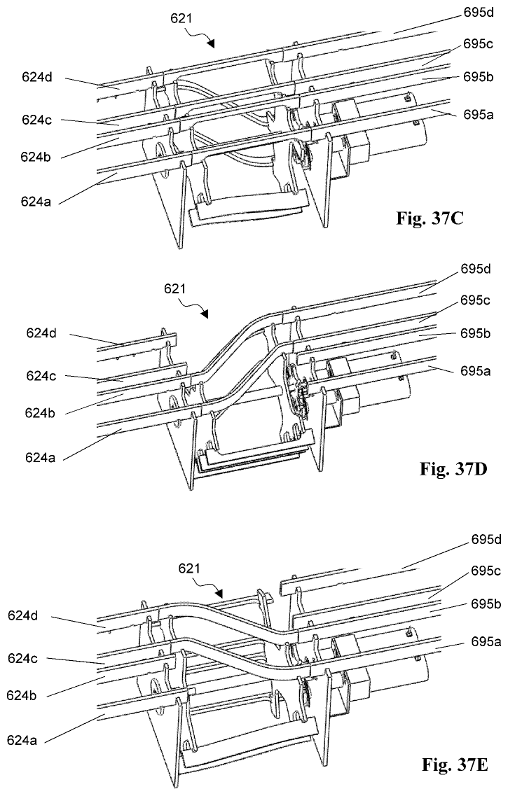

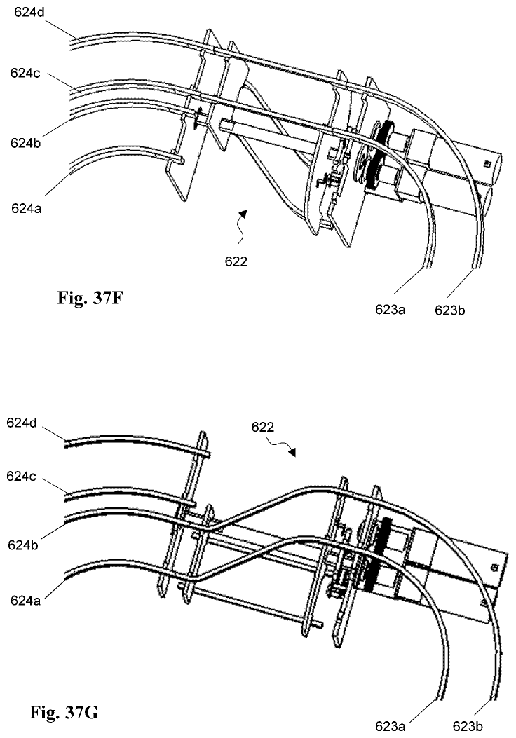

Referring to FIG. 37A, a detection mechanism 691 comprise two proximity switches 90K and 90M and a connector 692. The proximity switches 90K and 90M are fixedly connected to the connector 692, and the proximity switches 90K and 90M are connected to the computer 902 respectively via wires 92K and 92M.

Referring to FIG. 37B, a rail track system 625 comprises: a plurality of track switch mechanisms 621; a plurality of track switch mechanisms 622; a pair of rail tracks 623a and 623b; a pair of rail tracks 624a and 624b, and a pair of rail tracks 624c and 624d which run parallel to the pair of rail tracks 624a and 624b; a pair of rail tracks 695a and 695b, and a pair of rail tracks 695c and 695d which are parallel to the pair of rail tracks 695a and 695b; a plurality of detection mechanisms 691. One track switch mechanism 621 is configured to be mounted in between: (1) the pairs of rail tracks, 624a and 624b, and 624c and 624d and, (2) the pairs of rail tracks, 695a and 695b, 695c and 695d. As shown in FIG. 37C, when the driven wheel of the track switch mechanism 621 is at a first locking position, the first group of rail tracks in the track switch mechanism 621 are configured to connect the pair of rail tracks 695a and 695b to the pair of rail tracks 624a and 624b, and also to connect the pair of rail tracks 695c and 695d to the pair of rail tracks 624c and 624d. As shown in FIG. 37D, when the driven wheel of the track switch mechanism 622 is at a second locking position, the second group of rail tracks in the track switch mechanism 621 are configured to connect the pair of rail tracks 695c and 695d to the pair of rail tracks 624a and 624b. As shown in FIG. 37E, when the driven wheel of the track switch mechanism 621 is at a third locking position, the third group of rail tracks in the track switch mechanism 622 are configured to connect the pair of rail tracks 695a and 695b to the pair of rail tracks 624c and 624d.

One of the track switch mechanisms 622 is configured to be mounted in between (1) the pair of rail tracks 623a and 623b, and (2) the pairs of rail tracks 624a and 624b, 624c and 624d. As shown in FIG. 37F, when the driven wheel of the track switch mechanism 622 is at a first locking position, the first group of rail tracks in the track switch mechanism 622 are configured to connect the pair of rail tracks 623a and 623b to the pair of rail tracks 624c and 624d. As shown in FIG. 37G, when the driven wheel of the track switch mechanism 622 is at a second locking position, the second group of rail tracks in the track switch mechanism 622 are configured to connect the pair of rail tracks 623a and 623b to the pair of rail tracks 624a and 624b.

The connectors 692 of the detection mechanisms 691 are fixedly connected to the rail tracks 623b, 695d, 624b and 624d. The target 788 of a vehicle 790 is configured to be sensed by the proximity switches 90K and 90M of detection mechanism 691 of the rail track system 625 when the vehicle 790 passes through some points of the rail tracks of the rail track system 625. When the proximity switches 90K and 90M sense the target 788, the computer 902 may receive signals from the proximity switches 90K and 90M.

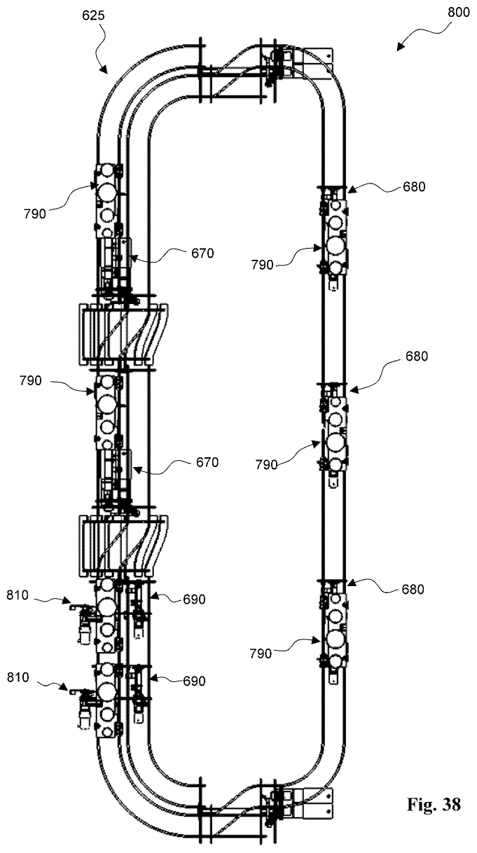

Referring to FIG. 38, a transport system 800 comprises: a rail track system 625; a plurality of vehicles 790; a plurality of charging mechanisms 810; a plurality of stopping mechanisms 680; and a plurality of stopping mechanisms 670. The stopping mechanisms 680 are mounted on the pair of rail tracks 623a and 623b of the rail track system 625. The stopping mechanisms 790 are mounted on the pair of rail tracks 624c and 624d and the pair of rail tracks 695c and 695d of the rail track system 625. The charging mechanisms 810 are mounted next to the pairs of rail tracks 624a and 624b, 624c and 624d. The transport system 800 is configured to transfer the container 107, either a container in another mechanism may be moved and be placed in one of the holding cups (785a, 785b or 785c) or a container on one of the holding cups (785a, 785b or 785c) is moved out of the holding device and placed on another mechanism by an unloading apparatus.

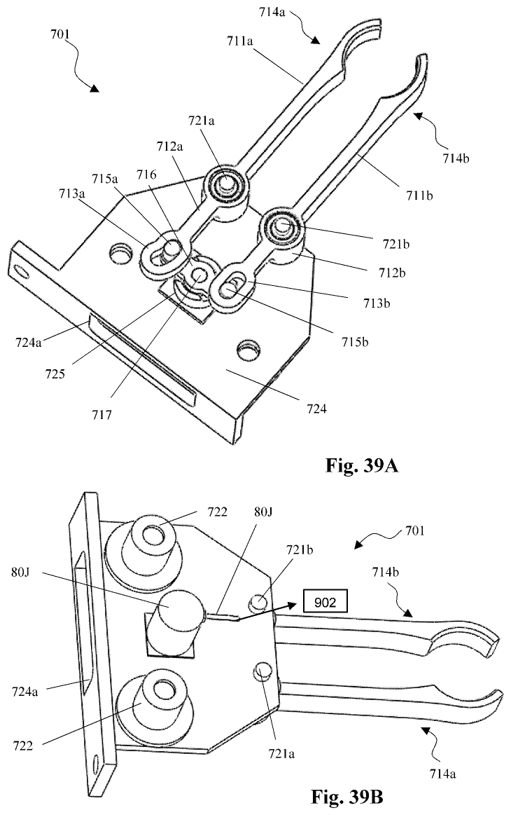

Referring to FIGS. 39A-39B, a container gripping mechanism 701 comprises gripping devices 714a and 714b, shafts 715a, 715b and 717, and a connector 716 configured to rigidly connect the shafts 715a, 715b and 717. The axes of the shafts 715a, 715b and 717 are configured to be vertical. The gripping device 714a or 714b comprises a curved hole 713a or respectively 713b, a bearing housing 712a or respectively 712b, a gripper 711a or respectively 711b, wherein the gripper 711a or 711b comprises a part of a cylindrical surface. The curved hole 713a and the gripper 711a are configured to be rigidly connected to the bearing housing 712a; and the curved hole 713b and the gripper 711b are configured to be rigidly connected to the bearing housing 712b. The gripping device 714a or 714b may comprise a rubber or silica gel or other elastic material which is attached to the cylindrical part of the gripper 711a or respectively 711b.

The container gripping mechanism 701 further comprises: two shafts 721a and 721b; an L-shaped support component 724 comprising a vertical board and a horizontal board, with a slot 724a on the vertical board, wherein the slot comprises a top horizontal surface and a bottom horizontal surface; two linear motion bearings 722 both of which comprise a vertical axis, wherein the pair of the linear motion bearings 722 are both fixedly connected to the horizontal board of the support component 724. The container gripping mechanism 701 further comprises a bearing housing 725 comprising a flange. The shafts 721a and 721b and the flange of the bearing housing 725 are all configured to be fixedly connected to the horizontal board of the support component 724; and the axes of the shafts 721a, 721b and the axis of the bearing housing 725 are configured to be vertical. The bearing housing 712a of the gripping device 714a is configured to be constrained to rotate relative to the shaft 721a around the axis of the shaft 721a. Similar, the bearing housing 712b of the gripping device 714b is configured to be constrained to rotate relative to the shaft 721b around the axis of the shaft 721b. The shaft 717 is configured to be constrained to rotate relative to the bearing housing 725 around the axis of the bearing housing 725.

The container gripping mechanism 701 further comprises a motor 80J comprising a shaft and a base component, wherein the base component of the motor is configured to be fixedly connected to the support component 724. The shaft of the motor 80J is connected to the shaft 717, so that the motor 80J can drive a rotation of the shaft 717 relative to the bearing housing 725, or equivalently, relative to the support component 724 around the axis of the shaft 717. When the shaft 717 is rotated by the motor 80J, the connector 716 is also rotated relative to the bearing housing 725 around the axis of the shaft 717, and then the shafts 715a and 715b are rotated around the axis of the shaft 717. The shaft 715a is configured to be inserted in the curved hole 713a of the gripping device 714a, so that a movement of the shaft 715a may induce a rotation in the gripping device 714a around the axis of the shaft 721a. Similarly, the shaft 715b is configured to be inserted in the curved hole 713b of the gripping device 714b, so that a movement of the shaft 715b may induce a rotation in the gripping device 714b, around the axis of the shaft 721b. As the gripping devices 714a and 714b are rotated in one direction, the grippers 711a and 711b may grip and hold an ingredient container 107; and the grippers 711a and 711 b may be rotated in the other direction to release a gripped ingredient container 107. In summary, the rotation produced by the motor 80J may induce rotations of the grippers 711a and 711b as to grip or release an ingredient container 107. When an ingredient container 107 is gripped by the gripping devices 714a and 714b of the container gripping mechanism 701, the axis of the ingredient container 107 is configured to be vertical, and parallel to the axes of the shafts 721a and 721b. The motor 80J is connected to the computer 902 via wires 82H (see FIG. 39B). The computer 902 is configured to dynamically control the timing and/or speed of the motor 80J. Thus, the computer 902 may send signals to the motor 80J to control the angle of rotation of the motor 80J, as to accurately control the gripping devices 714a and 714b to grip or release an ingredient container 107. The motor 80J may be a stepper motor or a servo motor.

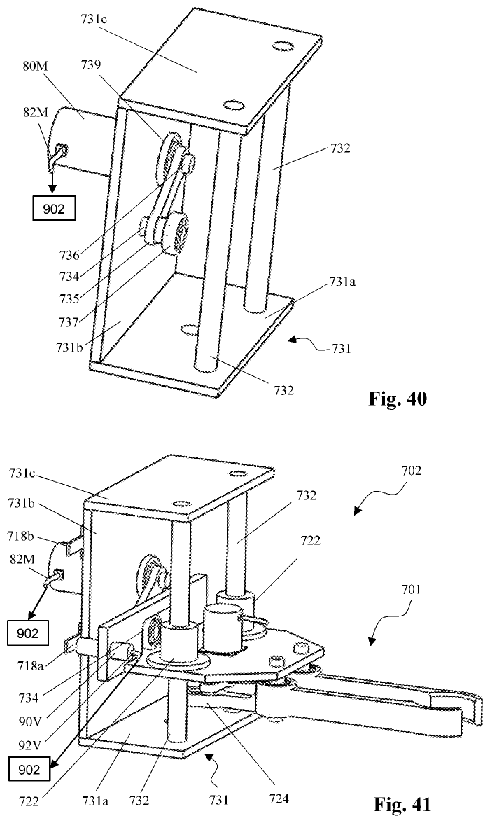

Referring to FIGS. 40-41, an unloading sub-mechanism 702 comprises: a pair of shafts 732; a support component 731 comprising a vertical board 731b and two horizontal boards 731a and 731 c wherein the vertical board 731b is configured to rigidly connect the horizontal boards 731a and 731c. Each shaft 732 is configured to be fixedly connected to the horizontal boards 731a and 731c, wherein the axes of the pair of shafts 732 are configured to be vertical. The unloading sub-mechanism 702 further comprises: a bearing housing 739 with a horizontal axis; two shafts 734 and 736; a connector 735 configured to fixedly connect the shafts 734 and 736; and a motor 80M comprising a base component and a shaft. The bearing housing 739 is configured to be rigidly or fixedly connected to the vertical board 731b of the support component 731. The shaft 736 is configured to be constrained to rotate relative to the bearing housing 739 around the axis of the shaft 736, hence the connector 735 and the shaft 734 are constrained to rotated relative to the bearing housing 739 around the axis of the shat 736. The axes of the two shafts 734 and 736 are configured to be horizontal and parallel to each other. A wheel 737 is mounted on the shaft 734 so that the wheel 737 is constrained to rotate freely relative to the shaft 734, around the axis of the wheel 737; wherein the axis of the wheel 737 coincides with the axis of the shaft 734. The base component of the motor 80M is fixedly connected to the vertical board 731b, and the shaft of the motor 80M is fixedly connected to the shaft 736. When the shaft 736 is rotated by the motor 80M, the connector 735, the shaft 734 and the axis of the wheel 737 are also rotated around the axis of the shaft 736.

The unloading sub-mechanism 702 further comprises the container gripping mechanism 701 (see FIG. 41). Each linear motion bearing 722 of the container gripping mechanism 701 is configured to be engaged with a corresponding shaft 732 so that the linear motion bearing 722 is constrained to slide along the corresponding shaft 732 along the axis of the shaft 732. Since the support component 724 is configured to be fixedly connected to the flanges connected to the outer shells of the linear motion bearings 722, the support component 724 of the container gripping mechanism 701 is configured to be constrained to slide vertically relative to the support component 731. On the other hand, the wheel 737 is configured to be positioned between the top horizontal surface and the bottom horizontal surface of the slot 724a of the support component 724 of the container gripping mechanism 701, so that the rotation of the shaft 734 around the axis of the shaft 736 may induce a vertical linear movement of the support component 724 of the container gripping mechanism 701. The range of the vertical linear movement of the support component 724 can be equal to (or nearly equal to) two times the distance between the axes of the shafts 734 and 736.

The unloading sub-mechanism 702 further comprises a proximity switch 90V fixedly connected to the vertical board of the support component 724; and two targets 718a and 718b. Both targets 718a and 718b are configured to be rigidly or fixedly connected to the vertical board 731b of the support component 731, wherein the target 718b is positioned upper than the target 718a. The proximity switch 90V may monitor the target 718a or 718b when the proximity switch 90V is slid with the support component 724. As shown in FIGS. 40-41, the motor 80M is connected to the computer 902 via wire 82M. The computer 902 is configured to dynamically control the timing and/or speed of the motor 80M. The proximity switch 90V is also connected to the computer 902 via wires 92V, so that the computer 902 may receive signals from the proximity switch 90V. The computer 902 may also send signals to the motor 80M as to control the degree of rotation of the motor 80M. When the support component 724 is moved to a first position where the proximity switch 90V senses the target 718a, the signals of the proximity switch 90V are sent to the computer 902. The computer 902 can figure out the position of the target 718a, and the position of the support component 724. Similarly, when the support component 724 is moved to a second position where the proximity switch 90V senses the target 718b, the signals of the proximity switch 90V are sent to the computer 902. The computer 902 can figure out the position of the target 718b, and the position of the support component 724. Each time the support component 724 is moved to the first or second position, the motor 80M under the control of the computer 902, is stopped for a time during which the unloading sub-mechanism 702 is configured to complete a corresponding process. After this time, the motor 80M, under the control of the computer 902, may restart again and make a reverse rotation to move the support component 724 to the second position or respectively the first position.

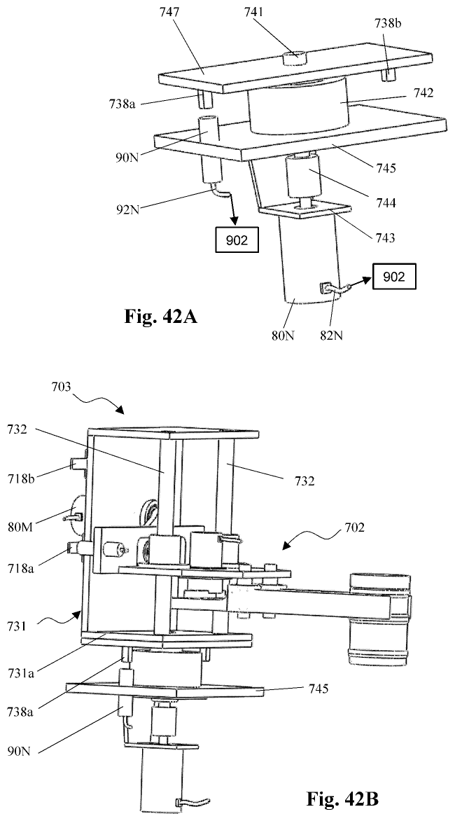

Referring to FIGS. 42A-42B, an unloading apparatus 703 comprises: an unloading sub-mechanism 702; a shaft 741 comprising a vertical axis; a rigid component 747 which is rigidly connected to the shaft 741; a support component 745 in the shape of a board; a bearing housing 742; a motor 80N comprising a shaft and a base component; a connecting component 743 configured to fixedly connect the base component of the motor 80N to the support component 745. The bearing housing 742 is configured to be rigidly connected to the support component 745 and the axis of the bearing housing 742 is configured to be vertical. The shaft 741 is configured to be connected to the bearing housing 742 by bearings and accessories, so that the shaft 741 is constrained to rotate relative to the bearing housing 742, around the axis of the shaft 741. The horizontal board 731a of the support component 731 of the unloading sub-mechanism 702 is configured to be fixedly connected to the rigid component 747. Therefore, the support component 731 (or the unloading sub-mechanism 702) is configured to be constrained to rotate relative to the support component 745, around the axis of the shaft 741. The shaft of the motor 80N is fixedly connected to the shaft 741 via a coupling 744, so that the motor 80N may drive a rotation of the shaft 741 relative to the support component 745, around the axis of the shaft 741, hence the support component 731 is rotated relative to the support component 745 around the axis of the shaft 741.

The unloading apparatus 703 further comprises a proximity switch 90N, a connector 748 configured to connect the proximity switch 90N to the support component 745, and two targets 738a and 738b both of which are configured to be rigidly connected to the rigid component 747. The proximity switch 90N may monitor the targets 738a and 738b when the targets are rotated with the rigid component 747. As shown in FIGS. 42A-42B, the motor 80N is connected to the computer 902 via wires 82N. The computer 902 is configured to dynamically control the timing and/or speed of the motor 80N. The proximity switch 90N is also connected to the computer 902 via wires 92N, so that the computer 902 may receive signals from the proximity switch 90N. The computer 902 may also send signals to the motor 80N as to control the degree of rotation of the motor 80N. When the rigid component 747 is rotated to a first position where the proximity switch 90N senses the target 738a, the signals of the proximity switch 90N are sent to the computer 902. The computer 902 can figure out the position of the target 738a, and the position of the rigid component 747. Similarly, when the rigid component 747 is rotated to a second position where the proximity switch 90N senses the target 738b, the signals of the proximity switch 90N are sent to the computer 902. The computer 902 can figure out the position of the target 738b, and the position of the rigid component 747. Each time the rigid component 747 is rotated to the first or second position, the motor 80N under the control of the computer 902 is stopped for a time during which the unloading apparatus 703 is configured to complete a corresponding process. After this time, the motor 80N, under the control of the computer 902, may restart again as to rotate the rigid component 747 to the second position or respectively the first position.

It should be noted that the unloading apparatus 703 comprises the following:

(1) the container gripping mechanism 701 configured to grip or release a container 107, wherein the container gripping mechanism 701 comprises the support component 724, to be referred to as the base component of the container gripping mechanism 701, or the first support component of the unloading apparatus 703. The container gripping mechanism 701 further comprises two gripping devices 714a and 714b which are constrained to rotate relative to the first support component 724 by a motorized mechanism; and each gripping device comprise a gripper, wherein the grippers are configured to fit the ingredient container 107;

(2) the support component 731, referred to as a second support component of the unloading apparatus 703;

(3) the support component 745, referred to as a third support component, or the base component of the unloading apparatus 703;

(4) a vertical motion mechanism, referred to as a first motion mechanism, configured to produce a vertical linear motion in the first support component 724 relative to the second support component 731, wherein the first motion mechanism comprises the motor 80M, shafts 736 and 734, connector 735, bearing housing 739, slot 724a, two parallel shafts 732, and two linear motion bearings 722, etc.; and their connections to each other if any, and their connections to the other components of the unloading apparatus 703 if any;

(5) a rotational motion mechanism, referred to as a second motion mechanism, configured to produce a rotation of the second support component 731 relative to the third support component 745, around a vertical axis (i.e., the axis of the shaft 741), wherein the second motion mechanism comprises the motor 80N, connecting component 743, coupling 744, bearing housing 742, shaft 741, rigid component 747 etc.; and their connections with each other if any, and their connections to the other components of the unloading apparatus 703 if any.

The distance between the axis of the shaft 741 and the axis of an ingredient container 107 is configured to be a constant, when the ingredient container 107 is gripped by the container gripping mechanism 701 of the unloading apparatus 703, as in FIG. 42B. the constant is referred to as the radius of the unloading apparatus 703. The unloading apparatus 703 can be positioned in a proper position as to grip an ingredient container 107, when the axis of the ingredient container 107 is positioned vertically, and the distance from the axis of the ingredient container 107 to the axis of the shaft 741 is equal to the radius of the unloading apparatus 703, and when the height of the ingredient container 107 is within a certain limit. The unloading apparatus 703 may grip an ingredient container 107, and may move it linearly in vertical direction, or horizontally by a rotation around the axis of the shaft 741, or by a combination of both, and then it may release the ingredient container 107 at a position which is different from the previous position.

We note that the second motion mechanism of the unloading apparatus 703 may be substituted by a motion mechanism configured to move the second support component 731 relative to the third support component 745 by a horizontal translation, or more generally, by a horizontal planar motion.

The unloading apparatus 703 further comprises the proximity switches 90N, 90V and other electrical or electronic devices (not shown in figures), wherein the proximity switches are connected to the computer 902 via wires; wherein the proximity switches are used to detect the angle of rotation of the motors, the relative position of two components, etc., of the unloading apparatus 703 and send signals to the computer 902. Thus, the computer 902 can control the above described mechanisms and apparatuses.

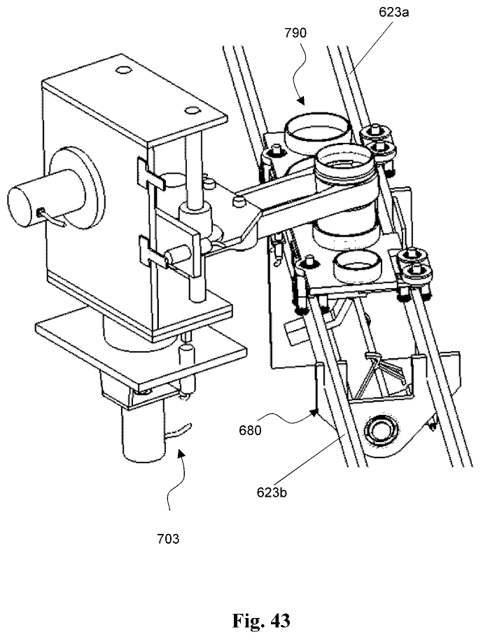

As shown in FIG. 43, the relative position of the stopping mechanism 680 and the base component of the unloading apparatus 703 is configured to be properly fixed. When the vehicle 790 on the pair of rail tracks 623a and 623b is stopped at a position by the stopping mechanism 680 where one of stoppers of the stopping mechanism 680 is attracted by the magnet 783 on the vehicle 790, the unloading apparatus 703 is configured to transfer an emptied ingredient container from the holding cup of the vehicle 790 to another apparatus, such as a container cleaning apparatus (no shown in figures).

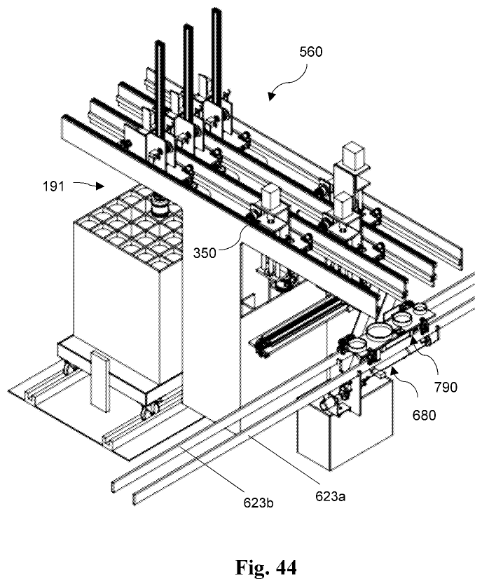

Referring to FIG. 44, a part of the transport system 800 is configured to be located next to the storage system 560. When the vehicle 790 on the pair of rail tracks 623a and 623b is stopped at a position by the stopping mechanism 680, wherein one of stoppers of the stopping mechanism 680 is attracted by the magnet 783 on the vehicle 790. Then, the container loading apparatus 350 transfers an ingredient container 107 from the container holder 424 of the sub-apparatus 440 to a holding cup on the vehicle 790 of the transport system 800. The relative position of the stopping mechanism 680 and the storage apparatus 191 of the storage system 560 is relatively fixed and properly configured.

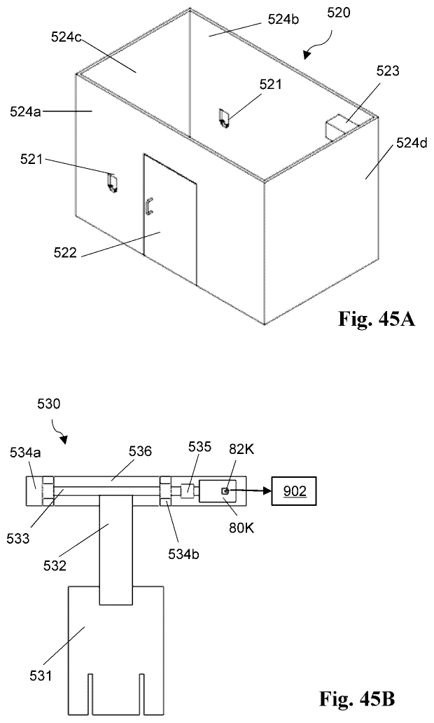

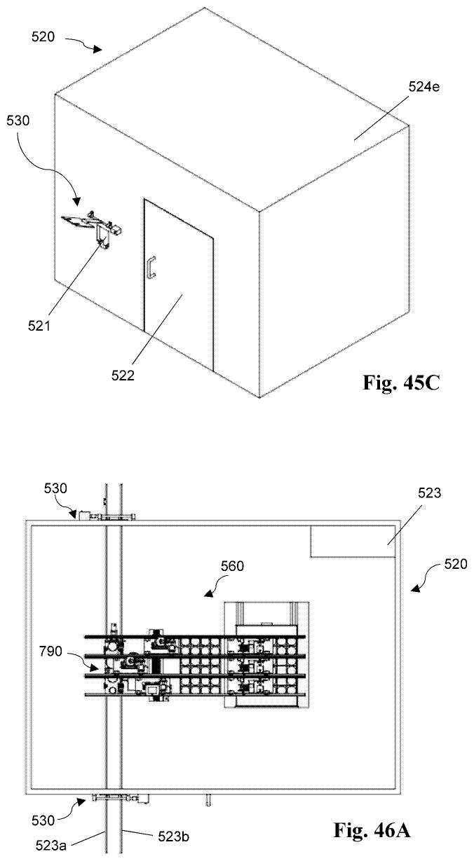

Referring to FIGS. 45A-45C, a storage room 520 comprises four walls 524a, 524b, 524c and 524d, a roof 524e and a floor which encloses a heat insulated space. The walls, roof and floor comprise heat insulation material and the seams among them are properly sealed. The wall 524a (or 524b) comprises an opening 521. Some rail tracks 623a and 623b of the transport system 800 are configured to be mounted as to pass through the bottom of the opening 521, so that a vehicle 790 may enter or leave the storage room 520 through the opening 521. A board 531 comprises a heat insulation material; wherein the board 531 may be placed to block the opening as to block or limit air flow between the storage room 520 and the outside.

A rotational motion mechanism 530 comprises: bearing housings 534a and 534b which are rigidly connected to each other by a rigid connector 536, said rigid connector 536 being mounted on the wall 524a (or 524b); a shaft 533 which is connected to the bearing housings 534a and 534b so that the shaft 533 is constrained to rotate relative to the bearing housings 534a and 534b; a board 531; and a connector 532 which rigidly connects the shaft 533 to the board 531 (see FIG. 45B). Hence, the board 531 is constrained to rotate relative to the bearing housings 534a and 534b around the axis of the shaft 533. The rotational motion mechanism 530 further comprises a motor 80K comprising a shaft and a base component, wherein the base component is fixedly connected to the rigid connector 536, and the shaft of the motor is connected to the shaft 533 by a coupling 535. The motor 80K can produce rotations of the shaft 533 and the board 531 relative to the bearing housings 534a and 534b around the axis of the shaft 533, between two end positions. At the first end position, the board 531 blocks the opening 521 as to block or limit air flow through the opening 521. At the second end position, the board 531 is moved away from the opening 521 so a vehicle 790 may pass through the opening 521 as to enter or leave the storage room 520.

The motor 80K is connected to the computer 902 via wires 82K. The computer 902 is configured to dynamically control the timing and/or speed of the motor 80K, so the computer can control the rotation of the board 531.

A door 522 is mounted on one of the walls as to allow a transport cart 194 and/or a human to enter or leave the storage room 520. The door 522 also comprises heat insulation material.

The storage room 520 is kept cool by a refrigeration mechanism 523 (which is connected by a pipe to the outside of the storage room). The refrigeration mechanism 523 comprises a compressor, a pipe, a motor, a cooling panel or cooling board, a fan, temperature sensors, etc., such as those found in a home or commercial refrigerator.

The refrigeration mechanism 523 is optionally connected to the computer 902 via wires. The computer 902 is configured to dynamically control the timing and/or power of the refrigeration mechanism 523. Some temperature sensors are also connected to the computer 902 by wires. Under the control of the computer 902, the temperature of the storage room 520 can be kept in a certain range.

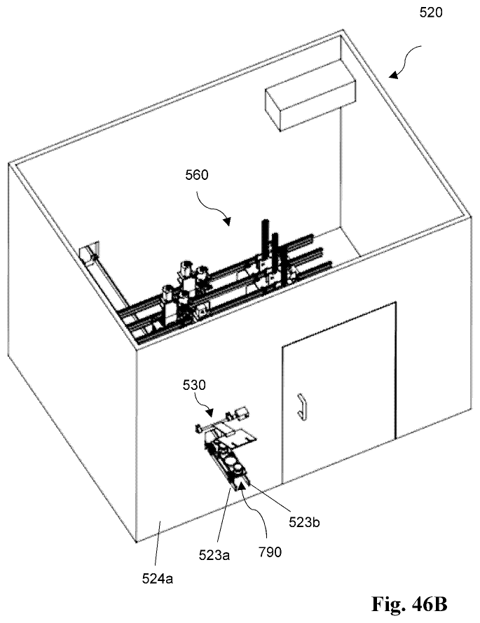

Referring to FIGS. 46A-46B, the storage system 560 is located inside the storage room 520, The temperature of the storage room 520 can be kept in a certain range so as to keep the food ingredients contained in the capped containers of the storage system 560 fresh. The part of the transport system 800, as shown in FIG. 44, is also positioned inside the storage room 520. A vehicle 790 of the transport system 800 may pass through an opening 521 as to enter or leave the storage room 560.

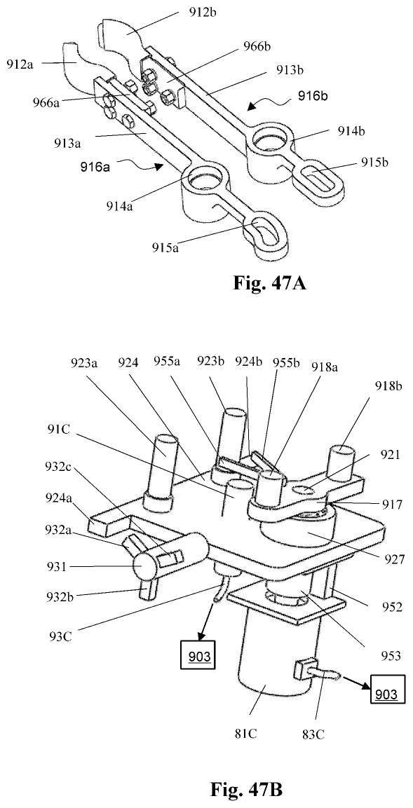

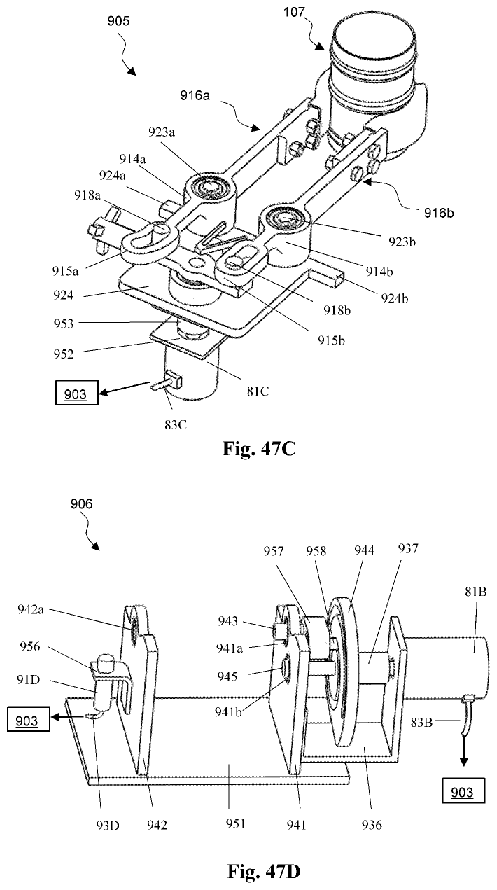

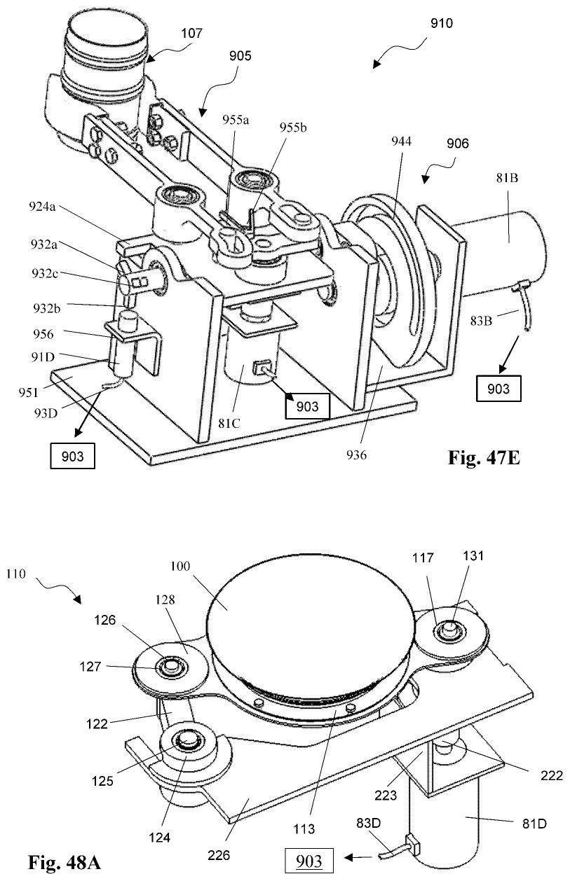

Referring to FIGS. 47A-47C, a container gripping mechanism 905 comprises: gripping devices 916a and 916b; shafts 918a, 918b and 921; and a connector 917 configured to rigidly connect the shafts 918a, 918b and 921. The axes of the shafts 918a, 918b and 921 are configured to be parallel to each other. The gripping device 916a (or 916b) comprises a support component 913a (or respectively 913b) and a gripper 966a (or respectively 966b). The support component 913a (or 913b) comprises a curved hole 915a (or respectively 915b) and a bearing housing 914a (or respectively 914b). The surface of the gripper 966a or 966b comprises a part of a cylindrical surface. The gripper 913a (or 913b) is configured to be fixedly connected to the support component 913a (or respectively 913b) by bolts and nuts. The gripping device 916a (or 916b) further comprises a rubber (or silica gel) 912a (or respectively 912b) which is attached to the gripper 966a (or respectively 966b).

The container gripping mechanism 905 further comprises shafts 923a and 923b, a support component 924 in the shape of a board, a bearing housing 927 rigidly connected to the top of the support component 924, a shaft 931 comprising a horizontal axis, and three targets 932a, 932b and 932c all of which are configured to be fixedly connected to the shaft 931 (see FIG. 47B). The support component 924 comprises two sub-component 924a and 924b. The shafts 923a and 923b are configured to be rigidly connected to the support component 924 wherein the axes of the two shafts 923a and 923b are configured to be perpendicular to the top surface of the support component 924. The shaft 921 is configured to be connected to the bearing housing 927 by bearings and accessories, so the shaft 921 is constrained to rotate relative to the bearing housing 927 (or equivalently, relative to the support component 924), around the axis of the shaft 921. As explained before, the connector 917 is configured to be rigidly connected to the shaft 921, so that the connector 917 and the components (the shafts 918a, 918b) attach on it are constrained to rotate relative to the support component 924 around the axis of the shaft 921. The axes of the shafts 923a, 923b, the axis of the shaft 921 and the axis of the bearing housing 927 are configured to be mutually parallel. The shaft 923a (or 923b) is configured to be connected to the bearing housing 914a (or respectively 914b) of the gripping device 916a (or respectively 916b) by bearings and accessories, so that the gripping device 916a (or 916b) is constrained to rotate relative to the shaft 923a (or respectively 923b) around the axis of the shaft 923a (or respectively 923b) (see FIG. 47C). The shafts 918a (or 918b) is configured to be inserted in the curved hole 915a (or respectively 915b) of the gripping devices 916a (or respectively 916b), so that a movement of the shaft 918a (or 918b) can induce a rotation in the gripping device 916a (or respectively 916b) around the axis of the shaft 923a (or respectively 923b). Since the gripping devices 916a and 916b are rotated, the grippers 966a and 966b (and the rubbers 912a and 912b) may grip or release a container 107.

The container gripping mechanism 905 further comprises: a motor 81C comprising a shaft and a base component, a connecting component 952 configured to fixedly connect the base component of the motor 81C to the support component 924; a coupling 953 configured to connect the shaft of the motor 81C to the shaft 921. As explained before, the motor 81C may drive the rotation of the shaft 921, the connector 917, and the shafts 918a and 918b relative to the support component 924 around the axis of the shaft 921.

The container gripping mechanism 905 further comprises: a proximity switch 91C, two targets 955a and 955b both of which are configured to be rigidly connected to the connector 917. The proximity switch 91C may monitor the targets 955a and 955b when the targets are rotated with the connector 917. As shown in FIG. 47C, the motor 81C is connected to the computer 903 via wires 83C. The computer 903 is configured to dynamically control the timing and/or speed of the motor 81C. The proximity switch 91C is also connected to the computer 903 via wires 93C, so the computer 903 may receive signals from the proximity switch 91C. The computer 903 may also send signals to the motor 81C as to control the degree of rotation of the motor 81C. When the connector 917 is rotated to a first position where the proximity switch 91C senses the target 955a, the gripping devices 916a and 916b are configured to grip a container 107. At the same time, the signals of the proximity switch 91C are sent to the computer 903, the computer 903 use the information to track the positions of the target 955a and of the gripping devices 916a and 916b. Similarly, when the connector 917 is rotated to a second position where the proximity switch 91C senses the target 955b, the gripping devices 916a and 916b are configured to release the container 107. At the same time, the signals of the proximity switch 91C are sent to the computer 903. The computer 903 can figure out the position of the target 955b, and the position of the gripping devices 916a and 916b. Using the information sent by the proximity switch 91C, the computer 903 may accurately control the motion of the gripping devices 916a and 916b as to grip or release a container 107.

Referring to FIG. 47D, a rotational motion mechanism 906 comprises a horizontal support component 951, two vertical boards 941 and 942 both configured to be rigidly connected to the support component 951, and shafts 943 and 945. The vertical board 941 comprise two bearing housings 941a and 941b, and the vertical board 942 comprise a bearing housing 942a. The axes of the bearing housing 941a of the vertical board 941 and the bearing housing 942a of the vertical board 942 are configured to be the same. The shaft 943 is connected to the bearing housing 941a of the vertical board 941 by bearings and accessories, so that the shaft 943 is constrained to rotate relative to the vertical board 941 (or equivalently, relative to the support component 951), around the axis of the shaft 943. The shaft 945 is connected to the bearing housing 941b of the vertical board 941 by bearings and accessories, so that the shaft 945 is constrained to rotate relative to the vertical board 941 (or equivalently, relative to the support component 951), around the axis of the shaft 945.

The rotational motion mechanism 906 further comprises: a cam 944 comprising a curved hole; a connector 957; a shaft 958; a motor 81B comprising a shaft and a base component; a connecting component 936 configured to fixedly connect the base component of the motor 81B to the vertical board 941; and a coupling 937. The shaft 943 is rigidly connected to the connector 957. The connector 957 may comprise a bearing housing (although this is not strict requirement) which is configured to be connected to the shaft 958 by bearings and accessories. Thus, the connector 957 and the shaft 958 are constrained to rotate relative to the support component 941 around the axis of the shaft 943 as well as the shaft 943. It should be noted that the axes of the shafts 943 and 958 are configured to be parallel to each other. The cam 944 is rigidly connected to the shaft 945 and the curved hole of the cam 944 is configured to constrain the shaft 958. The shaft of the motor 81B is connected to the shaft 945 via the coupling 937. Thus, the motor 81B may drive the rotation of the shaft 945 around the axis of the shaft 945, hence the cam 944 is rotated around the axis of the shaft 945. Since the curved hole of the cam 944 constrains the shaft 958, the rotation of the cam 944 produces a motion of the shaft 958, i.e., a rotation around the axis of the shaft 943, hence the shaft 943 is rotated around the axis of the shaft 943.

It should be noted that the curved hole in the cam 944 is modelled on a “modeling curve” comprising a union of a middle curve and two ending curves, wherein the ending curves are arcs of two circles centered at the axis of the shaft 945. The shaft 958 is constrained by the edges in the curved hole in the cam 944, by touching between the shaft 958 and the edges in the curved hole. When the shaft 958 touches the part of the edges corresponding to the ending curves, the shaft 958 may be static when the cam 944 is rotated. The modeling curve is configured to have continuously varying tangents (i.e. no sharp turns on the curve); and a smooth rotation of the cam 944 produces a motion in the shaft 958 with limited acceleration.

The rotational motion mechanism 906 further comprises a proximity switch 91D and a connecting component 956 configured to fixedly connect the proximity switch 91D to the vertical board 942. As shown in FIG. 39A, the motor 81B is connected to the computer 903 via wires 83B. The computer 903 may be configured to dynamically control the timing and/or speed of the motor 81B. The proximity switch 91D is also connected to the computer 903 via wires 93D, so the computer 903 may receive electric or electronic signals from the proximity switch 91D.

It should be noted that the width of the curved hole in the cam 944 may be configured to be equal to or slightly larger than the diameter of the shaft 958.

Referring to FIG. 47E, a dispensing apparatus 910 comprises the container gripping mechanism 905 and the rotational motion mechanism 906. The shaft 943 of the rotational motion mechanism 906 is configured to be rigidly connected to the support component 924 in the container gripping mechanism 905, and the shaft 931 of the container gripping mechanism 905 is connected to the bearing housing 942a of the rotational motion mechanism 906, so that the motor 81B of the rotational motion mechanism 906 may drive a rotation of the support component 924 (or equivalently the container gripping mechanism 905) relative to the support component 951 around the axis of the shaft 943.

As explained before, the axis of the shaft 931 of the container gripping mechanism 905 and the axis of the shaft 943 of the rotational motion mechanism 906 are configured to be concentric. The proximity switch 91D may monitor the three targets 932a, 932b, and 932c of the container gripping mechanism 905 when the targets are rotated with the shaft 931. As shown in FIG. 40, the motor 81B is connected to the computer 903 via wires 83B. The computer 903 is configured to dynamically control the timing and/or speed of the motor 81B. The proximity switch 91D is also connected to the computer 903 via wires 93D, so the computer 903 may receive signals from the proximity switch 91D. The computer 903 may also send signals to the motor 81B as to control the degree of rotation of the motor 81B. When the shaft 931 (or equivalently, the support component 924) is rotated by the motor 81B to a first position where the proximity switch 91D senses the target 932a, the signals of the proximity switch 91D are sent to the computer 903. The computer 903 can figure out the position of the target 932a, and the position of the support component 924. Similarly, when the shaft 931 (or equivalently, the support component 924) is rotated by the motor 81B to a second (or third) position where the proximity switch 91D senses the target 932b (or respectively 932c), the signals of the proximity switch 91D are sent to the computer 903. The computer 903 can figure out the position of the target, and the position of the support component 924.

When the support component 924 of the container gripping mechanism 905 is controlled by the computer 903 to rotate to the first position where the sub-components 924a and 924b respectively touch the top edges of the vertical boards 941 and 942, the support component 924 is stopped from rotating and the vertical boards 941 and 942 function as a physical barrier for the motion of the rigid component 924. When the support component 924 of the container gripping mechanism 905 is controlled by the computer 903 to rotate to the second position, the angle of rotation of the support component 924 relative to the first position may be pre-assigned angle usually 75 degrees. When the support component 924 of the container gripping mechanism 905 is controlled by the computer 903 to rotate to the third position where the sub-components 924a and 924b respectively touch the top edges of the vertical boards 941 and 942, the angle of rotation of the support component 924 relative to the first position may be pre-assigned angle usually 150 degrees. Each time the support component 924 is rotated to the first, second or third position, the motor 81B is controlled to be stopped for a time during which the dispensing apparatus 910 is configured to complete a corresponding process.

When the support component 924 of the container gripping mechanism 905 is rotated to the first position, and the connector 917 is rotated to the position where the proximity switch 91C senses the target 955a. At this time, a pre-assigned angle (explained before) of rotation of the connector 917 around the axis of the shaft 921, as produced by the motor 81C of the container gripping mechanism 905, hence the gripping devices 916a and 916b in the container gripping mechanism 905 are rotated a corresponding angle, as to grip a container 107 which may contain or otherwise hold food or food ingredients. If a container 107 is thus gripped, the axis of the gripped container 107 is configured to be parallel to the axis of the shafts 923a, 923b and 921 (of the container gripping mechanism 905). After the container 107 is gripped, as shown in FIG. 47E, the computer 903 would control the rotational motion mechanism 906 driven a rotation of the support component 924 of the container gripping mechanism 905 to the third position. During this period, the container 107 is kept gripped by the gripping devices 916a and 916b. Therefore, the container 107 and the gripping devices 916a and 916b are rotated by the same angular degree as the support component 924, around the axis of the shaft 943 to the third position. In particular, the food or food ingredients contained in the container 107 can be unloaded as the container 107 is turned by 150 degrees. After the dispensing of the food or food ingredients contained or held in the container 107, the container gripping mechanism 905 may be returned to the first position, when the rotational motion mechanism 906 rotates the support component 924 backward.

When the support component 924 of the container gripping mechanism 905 is at the first position, and hence that the connector 917 are rotated to the position where the proximity 91C senses the target 955b, as to induce the gripping devices 916a and 916b to rotate, as to release a container 107, the rotational motion mechanism 906 may also rotate the support component 924 of the container gripping mechanism 905 to the second position. After a time (as needed), the container gripping mechanism 905 may be returned to the first position, when the rotational motion mechanism 906 rotates the support component 924 backward.

It should be noted that the dispensing apparatus 910 comprises:

(1) the support component 924, referred to as a first support component of the dispensing apparatus 910;

(2) the gripping devices 916a and 916b, each of which is rotatable relative to the first support component, wherein the axes of rotations of the gripping devices relative to the first support component are configured to be mutually parallel;

(3) the support component 951, referred to as a second support component;

(4) a first motorized mechanism configured to rotate the first support component 924 relative to the second support component 951, around the (horizontal) axis of the shaft 943, the first motorized mechanism comprising the rotational motion mechanism 906, the connection of the shaft 943 and the support component 924;

(5) a second motorized mechanism configured to rotate the gripping devices 916a and 916b relative to the first support component 924, when the axes of rotations of the gripping devices 916a and 916b relative to the first support component is positioned vertically; wherein the second motorized mechanism comprises the motor 81C, the shaft 921, the connection of the shaft 921 with the motor 81C which constrains the motion of the shaft 921 to a rotation relative to the support component 924, the components 917, 918a and 918b and their connections with each other and with components of other parts of the dispensing apparatus 910.

The dispensing apparatus 910 further comprises the proximity switches 91C, 91D and other electrical or electronic devices (not shown in figures), wherein the proximity switches are configured to detect the angle of rotation of the motor in the dispensing apparatus 910 and send the reading to the computer 903. Thus the computer 903 can control the above described mechanism and apparatus, especially the angle of the rotation of motor 81C in the container gripping mechanism 905 so that the gripping devices 916a and 916b of the container gripping mechanism 905 are configured to grip or release a container 107; the angle of rotation of the motor 81B so that the support component 924 of the container gripping mechanism 905 is be rotated a pre-assigned angle (e, g, 150 degrees) as to unload the food or food ingredients contained in the container 107.

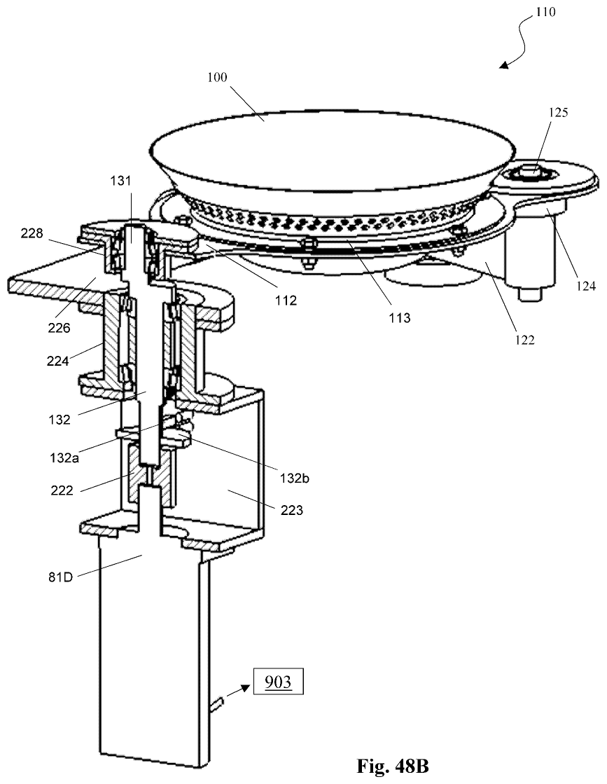

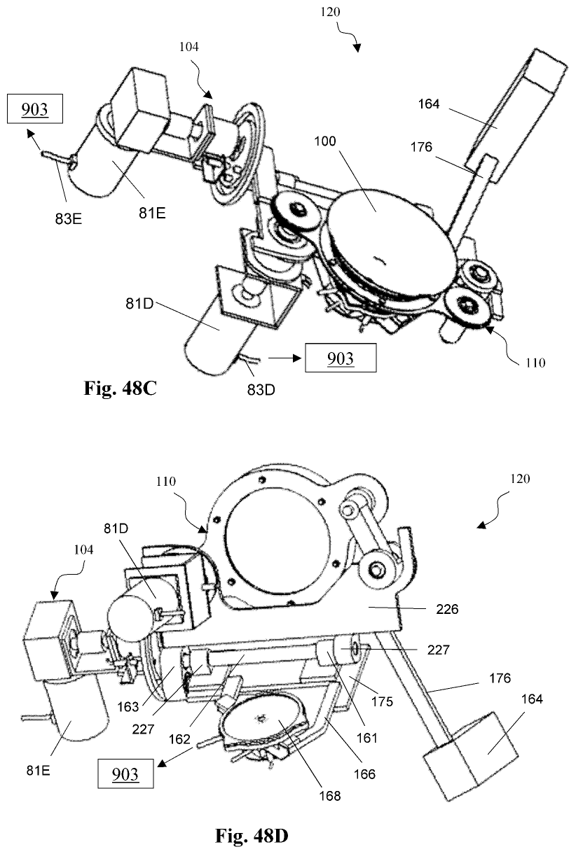

Referring to FIGS. 48A-48B, a cooking sub-apparatus 110 comprises: a cookware 100; a pair of shafts 125 and 126 that are rigidly connected by a connector 122 (see FIG. 48A); a pair of shafts 131 and 132 that are rigidly connected (see FIG. 48B). The shafts 125, 126, 131 and 132 are configured to have parallel axes; and the distance between the axes of the shafts 125 and 126 is strictly larger than the distance between the axes of the shafts 131 and 132. The cooking sub-apparatus 110 also comprises bearing housings 124, 128, 224 and 228. The bearing housings 124 and 224 are rigidly connected to a support component 226. The bearing housings 128 and 228 are connected to a board 112, wherein the board 112 is fixedly connected to the cookware 100 by a connector 113 and some connecting accessories.

Bearings and accessories are configured to connect the shaft 125 and the bearing housing 124 so that shaft 125 is constrained to rotate relative to the bearing housing 124, around the axis of the shaft 125. Bearings and accessories are configured to connect the shaft 126 and the bearing housing 128 so that shaft 126 is constrained to rotate relative to the bearing housing 128, around the axis of the shaft 126 (FIG. 48A).

Bearings 117 and accessories are configured to connect the shaft 131 and the bearing housing 228 so that shaft 131 is constrained to rotate relative to the bearing housing 228, around the axis of the shaft 131. Bearings 127 and accessories are configured to connect the shaft 132 and the bearing housing 224 so that shaft 132 is constrained to rotate relative to the bearing housing 224, around the axis of the shaft 132 (FIG. 48B).

The cooking sub-apparatus 110 further comprises: a motor 81D comprising a base component and a shaft, wherein the base component is fixedly connected to the support component 226 by a connector 223, and the shaft of the motor 81D is connected to the shaft 132 by a coupling 222. Thus, the motor 81D may drive the rotation of the shaft 132, and hence the shaft 131 is rotated around the axis of the shaft 132, and the rotation induces a cyclic movement in the cookware 100 which may stir, mix and distribute the food or food ingredients contained in the cookware 100. The motor 81D is connected to a computer 903 via wires 83D. The computer 903 may be configured to send electric or electronic signals to the motor 81D as to dynamically control the timing and/or speed of the motor 81D (or indirectly the angle of rotation of the main shaft 132).

The shaft 132 is referred to as the main shaft, and shaft 131 as the eccentric shaft. The main shaft 132 is configured be vertical when the cookware 100 is in an upright position as to contain or otherwise hold a food or food ingredient.

It should be noted that the cooking sub-apparatus 110 comprises: a cookware 100; a stirring motion mechanism comprising a support component 226 and a motor 81D, said stirring motion mechanism configured to produce a motion in the cookware 100 as to stir, mix or distribute the food or food ingredients contained in the cookware 100.

Referring to FIGS. 48C-48D, a cooking apparatus 120 comprises a cooking sub-apparatus 110 and a rotational motion mechanism 104, wherein the rotational motion mechanism 104 comprises: a support component 175 in the shape of a board; a shaft 162 which is rigidly connected to the support component 175 by shaft seats 161 and 163; two bearing housings 227 which are rigidly connected to the support component 226 of the cooking sub-apparatus 110; a shaft 162 which is connected to the bearing housings 227 by bearings and accessories so that the shaft 162 is constrained to rotate relative to the bearing housings 227 around the axis of the shaft. The axis of the shaft 231 is configured to be horizontal. The support component 175 is configured to be fixedly connected to the ground. The axis of the shaft 162 is horizontal.

The rotational motion mechanism 104 further comprises: a motor 81E which together with some other parts configured to drive a relative rotation of the bearing housings 227 and the shaft 231, and thus a relative two-way rotation of a certain range between the support component 226 and the support component 175. The angular range of said rotation can be between 90 and 120 degrees in some applications, though this is not a strict requirement. The support component 226 is rotated relative to the support component 175 between a first end position and a second end position. At the first end position, the cookware 100 of the cooking sub-apparatus 110 is configured to be in an upright position as to contain or otherwise hold food or food ingredients during a cooking process. At the second end position, the cookware 100 is turned by an angle from the upright position as to dispense a cooked food from the cookware to a container of cooked food. The cooking apparatus 120 further comprises a weight 164 which is connected to the support component 226 by a connector 176. The motor 81E is connected to the computer 903, so that the computer can control the motor (see FIG. 48C).

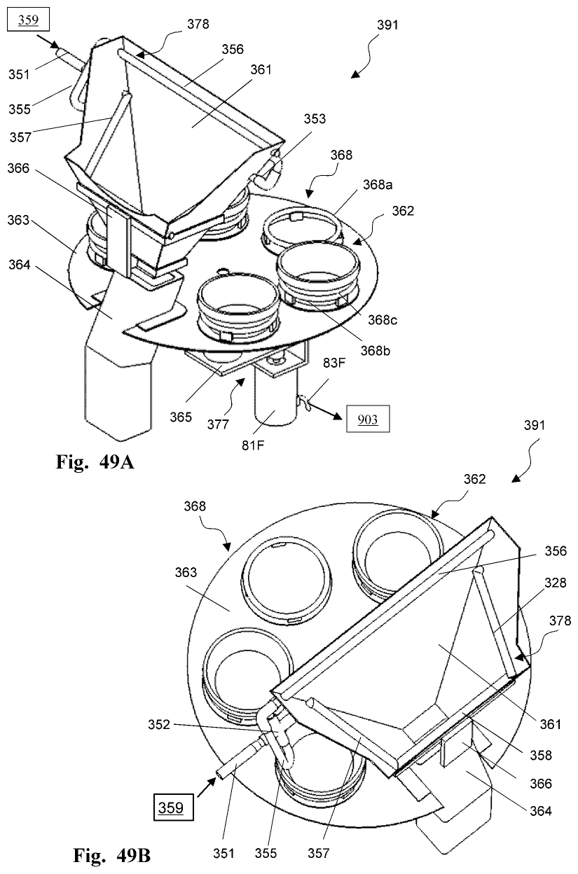

Referring to FIGS. 49A-49B, a receiving apparatus 391 comprises: a turntable 363; a funnel 361; and a water passage 364 configured to pass wastewater. The water passage 364 is rigidly connected to the turntable 363. A support component 366 is configured to be fixedly connected to the funnel 361; said support component 366 being configured to reinforce the rigidity of the funnel 361. The receiving apparatus 391 also comprises a motion mechanism 377; wherein the motion mechanism 377 comprises a support component 365 and a motor 81F comprising a base component and a shaft, wherein the base component is fixedly connected to the support component 365. The motion mechanism 377 is configured to produce a rotational motion in the turntable 363 relative to the support component 365 around a vertical axis; wherein the motor 81F is configured to produce the motion of the motion mechanism 377. The support component 366 is rigidly connected to the support component 365 of the motion mechanism 377 (but the connection is not shown in figures).

The receiving apparatus 391 further comprises a plurality of container holders 368 which are rigidly attached to the top of the turntable 363. A food container 362 in the upright position may be placed on a container holder 368, so that the bottom of the food container 362 may touch the horizontal board 368a, and the exterior surface 362g of the food container 362 may be (touched and/or) restrained by the ring 368b of the container holder 368. The container holders 368 and the water passage 364 may be cyclically moved in an intermittent rotation with the turntable 363 by the motion mechanism 377.

The motor 81F of the motion mechanism 377 is connected to the computer 903 via wires 83F (see FIG. 49A). The computer 903 may be configured to dynamically control the timing and/or speed of the motor 81F. At each stop of the turntable 363, either a food container 362 or the water passage 364 may be positioned below the funnel 361.

The receiving apparatus 391 also comprises a water spray mechanism 378 comprising water pipes 351, 355, 356, 357, 358, 328; connectors 352 and 353 etc. The water pipes 356, 357, 358 and 328 are configured to be fixedly attached on the inner surface of the funnel 361. All water pipes of the water spray mechanism 378 are configured to be connected to each other by a plurality of pipe connectors 353 and 352, so that water may flow from one pipe to another. The water spray mechanism 378 also comprises a water source 359 configured to flow water to the water pipe 351. The water source 359 may comprise a water heater connected to tap water, similar as a typical home water heater. Each of the water pipes 356, 357, 358 and 328 of the water spray mechanism 378 comprises a plurality of small holes or water outlets into spray devices (not shown in figures) so that water may be sprayed out from the small holes and/or spray devices, as to clean the inner surface of the funnel 361. When the turntable 363 is stopped at the position when the water passage 364 is below the funnel 361, the water passage 364 is configured to receive wastewater which may flow from the interior of the funnel 361, such as water from said small holes and/or the spray devices. When the turntable 363 is stopped at any other position, a cooked food may be dropped from the interior of the funnel 361 into a food container 362 on a corresponding container holder 368. It should be noted that the water passage 364 is not rigidly connected to the funnel 361, as the funnel 361 is configured to be fixed relative to the support component 365, while the turntable 363 can be rotated.

It should be noted that a spray device discussed above may comprise a spray head.

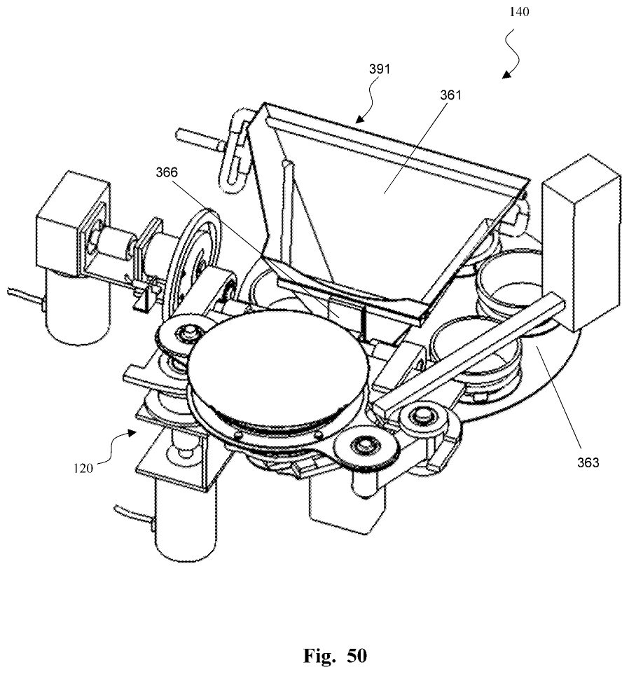

Referring to FIG. 50, a cooking sub-system 140 comprises the cooking apparatus 120 and the receiving apparatus 391. The support component 365 in the receiving apparatus 391 is configured to be rigidly or fixedly connected to the support component 175 of the cooking apparatus 120 (the connectors are not shown in figure). Since the first support component 226 of the cooking apparatus 120 is rotated from the first end position to the second end position, a cooked food (or wastewater) in the cookware 100 may be dispensed into a food container 362 (or respectively the water passage 364) through the funnel 361. Said wastewater may be contained in the cookware 100 after a cleaning of the cookware 100 by water.

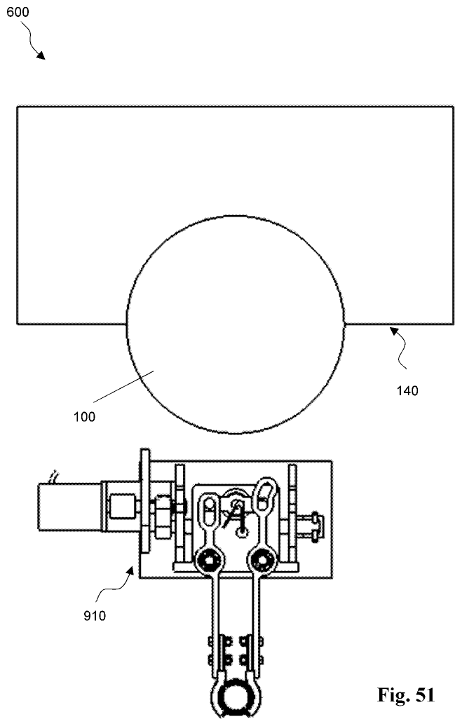

Referring to FIG. 51, a cooking system 600 comprises the dispensing apparatus 910 and a cooking sub-system 140. The dispensing apparatus 910 is configured to grip a container 107 of food ingredients and turn it as to dispense the food ingredients from the container to the cookware 100 of the cooking sub-system 140.

The cooking system 600 may further comprise a cleaning apparatus configured to clean the cookware 100 after a food is cooked; a lid apparatus configured to limit passage of air from and towards the cookware 100, or to limit the food or food ingredients from jumping out from the cookware 100 during a cooking process; etc. The details of the cooking system 600 are presented in the U.S. patent application Ser. No. 16/155,895, filed on Oct. 10, 2018, by the same inventor, the content of which is incorporated herein by reference in its entirety.

It should be noted that the cooking sub-system 140 in the cooking system 600 may be substituted by other types of cooking sub-system. In particular, the cookware 100 and the stirring motion mechanism in the cooking sub-system 140 may be substituted by other types of cookware and stirring motion mechanisms. Same can be said on the lid apparatus, dispensing apparatus, cleaning apparatuses of the cooking sub-system 140.

In some embodiments, referring to FIGS. 52-56, an automated kitchen system 400 comprises: a storage system 560; a transport system 800; a storage room 520; the refrigeration mechanism 523; the board 531 and the rotational motion mechanism 530; a cooking system 600; and a cooking system 600x. The storage system 560 and a part of the transport system 800 are located inside the storage room 520, as previously shown in FIGS. 46A-46B.

The cooking system 600x is configured the same way as the cooking system 600. Thus, the cooking system 600x comprising: (1) a dispensing apparatus 910x which is configured the same way as the dispensing apparatus 910; (2) a cooking apparatus 120x, which is identically configured as the cooking apparatus 120. Thus, the cooking apparatus 120x comprises a cookware 100x; a stirring motion mechanism comprising a support component 226x, said stirring motion mechanism being configured to produce a motion in the cookware 100x as to stir, mix or distribute the food or food ingredients contained in the cookware 100x; and a rotational motion mechanism 104 configured to rotate the support component 226x of the cooking apparatus 120x and turn the cookware 100x as to dispense a cooked food from the cookware. The computer 903x is configured to control the timing, direction or speed of the rotation of all motors in the cooking system 600x.

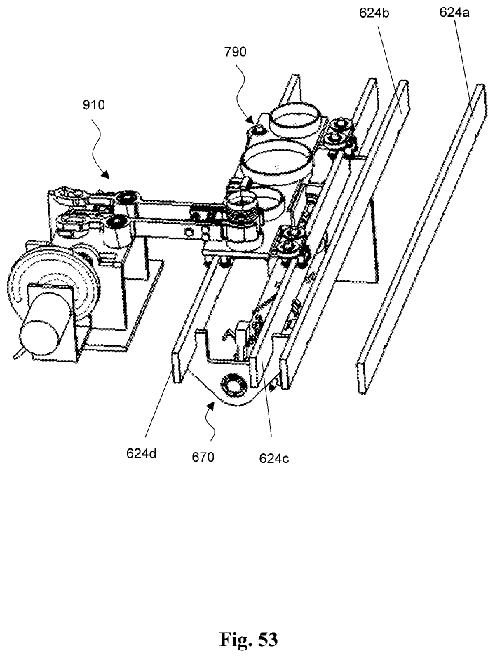

The automated kitchen system 400 further comprises an unloading apparatus 703 configured to grip and move an emptied ingredient container 107 from a holding cup of the vehicle 790 to another position (see FIG. 53). The unloading apparatus 703 may be used to unload the emptied container and move the container into a collection box for emptied containers.

The base support components of various apparatuses on the automated kitchen system 400 need to be properly positioned.

The automated kitchen system 400 further comprises the computer system 909. The computers 902, 903 and 903x of the computer system 909 are connected by wires to sensors 91A, 91B, 91C, etc.; wherein said sensors can be encoders, proximity switches, and temperature sensors, etc., of the cooking systems 600 and 600x, storage system 560, transport system 800, rotational motion mechanisms 530, and unloading apparatus. The computers 902, 903 and 903x are connected by wires to electrical or electronic devices, 81A, 81B, 81C, etc.; wherein said electrical or electronic devices can be various of types of motors, electro-magnets inductive stoves or electric stoves, refrigeration apparatus of the cooking systems 600 and 600x, storage system 560, transport system 800, rotational motion mechanisms 530, and unloading apparatus. The computers 902, 903 and 903x are configured to control the functions of the electrical or electronic devices by sending signals to the electrical or electronic devices. The first computer 901 is configured to send signals to control the computers 902, 903 and 903x.

The computer 904 may optionally be connected to the computer system 909 by wireless means.

The capped ingredient containers 109 (or 109b) containing food ingredients may be previously placed in a transport cart 194, together with a plurality of other capped ingredient containers (usually of the same diametrical size). The transport cart 194 may be placed (e.g., by a human) in a certain fixed position in the storage apparatus 191 of the storage system 560, so that the transfer apparatus 220 may be controlled by the computer system as to grip and transfer the ingredients containers in the transport box of the transport cart 194 to other locations.

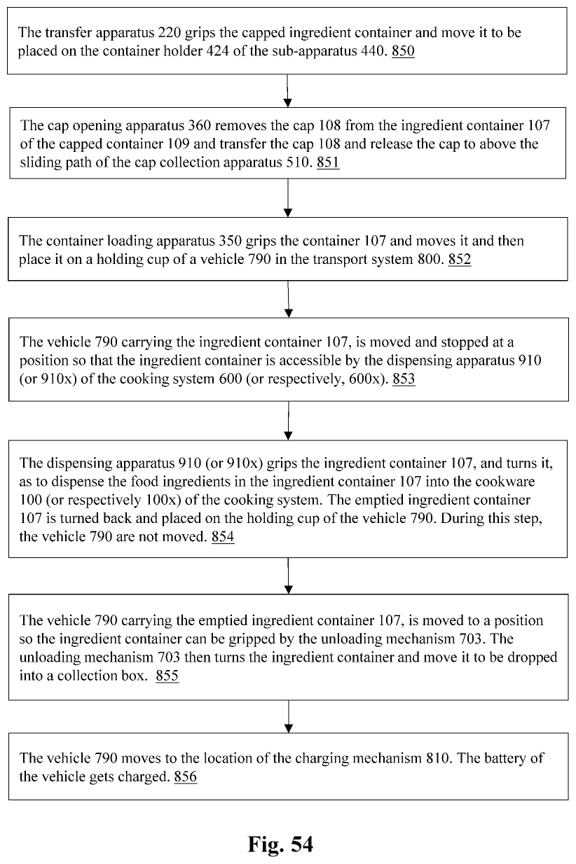

As shown in FIG. 54, the computer system 909 may control the transferring and dispensing of food ingredients from a capped ingredient container 109 (or 109b) by the following steps.

Step 850, the transfer apparatus 220 grips the capped ingredient container 109 (or 109b) and move it to be placed on the container holder 424 of the sub-apparatus 440.

Step 851, the cap opening sub-apparatus 360 of the cap opening apparatus 370 removes the cap 108 (or 108b) from the ingredient container 107 of the capped container 109 (or 109b) and transfer the cap 108 (or 108b) and release the cap to above the sliding path of the cap collection apparatus 510.

Step 852, the container loading apparatus 350 grips the container 107 and moves it and then place it on a holding cup of a vehicle 790 in the transport system 800.

Step 853, the vehicle 790 carrying the ingredient container 107, is moved and stopped at a position so that the ingredient container is accessible by the dispensing apparatus 910 (or 910x) of the cooking system 600 (or respectively, 600x).

Step 854, the dispensing apparatus 910 (or 910x) grips the ingredient container 107, and turns it, as to dispense the food ingredients in the ingredient container 107 into the cookware 100 (or respectively 100x) of the cooking system. The emptied ingredient container 107 is turned back and placed on the holding cup of the vehicle 790. During this step, the vehicle 790 are not moved.

Step 855, the vehicle 790 carrying the emptied ingredient container 107, is moved to a position so the ingredient container can be gripped by the unloading mechanism 703. The unloading mechanism 703 then turns the ingredient container and move it to be dropped into a collection box.

Step 856, the vehicle 790 moves to the location of the charging mechanism 810. The battery of the vehicle gets charged.

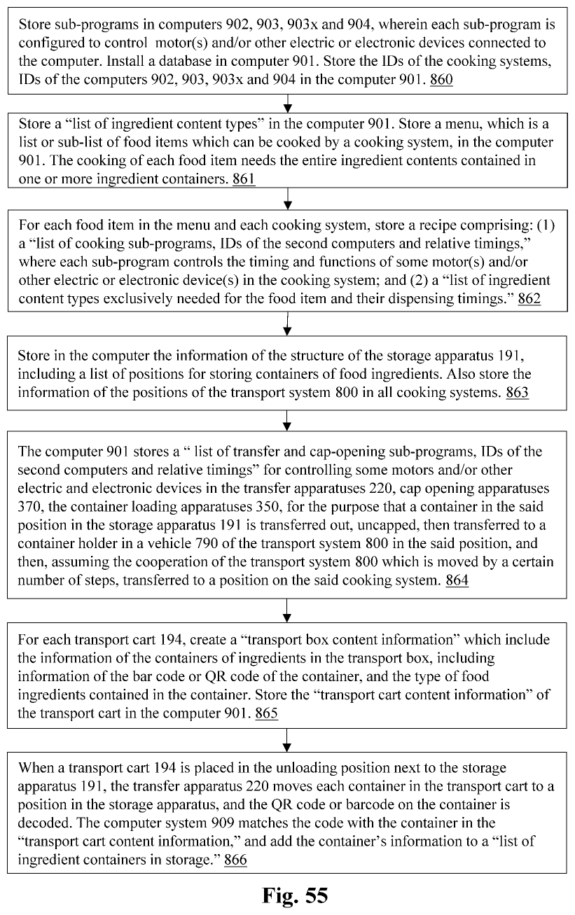

Referring to FIG. 55, the following tasks are performed by the computer system 909 or under the control of the computer system 909 of the kitchen system 400 before the business opens.

In Step 860, store some sub-programs in each of second computers (902, 903, and 903x) and computers 904 wherein each sub-program comprises procedures for the computer to control one or more motors and/or other electric or electronic devices which are connected to the computers as to perform specific functions, and/or procedures for the computers to read the information of sensors or other electric or electronic devices, and then have the information sent to the first computer 901. The start time of a sub-program can be scheduled later, in accordance of needs. Also, install a database in the computer 901. The database will store some lists of data, including the lists as described in the following. Each cooking system (600 or 600x) is given an ID. The IDs of all cooking systems are stored in the computer 901. Each of second computers (902, 903, and 903x) and the computers 904 are given an ID. The IDs of the computers are stored in the computer 901.

In Step 861, store a list of “ingredient content types” in the computer 901. For example, an ingredient content type can be “20 oz. of sliced angus beef;” another ingredient content type can be “1.5 oz. of minced onion and 2 oz. of minced garlic.” In our applications, the content contained in an ingredient container comprises food ingredient(s) of an ingredient content type. Then the computer 901 stores a menu, which is a list or a sub-list of food items that can be cooked in the kitchen. The cooking of a single food item of the menu needs the entire content of food ingredients contained in one or more ingredient containers. This reduces the burden of dividing the food ingredients contained in an ingredient container.

It should be noted that the content of some ingredient containers may not belong to an “ingredient content type” stored in the computer 901.

In Step 862, for each food item in the menu and corresponding to each cooking system (600 or 600x), the computer 901 stores in its database: (1) a “list of cooking sub-programs, IDs of the second computers and relative timings” wherein each cooking sub-program is a program run by a computer (902, 903 or 903x) of a specific ID to control the functions of, and/or to receive information from some motor(s) and/or other electric or electronic device(s) in the cooking system (600 or 600x); and (2) a “list of ingredient content types exclusively needed for the food item and their dispensing timings” comprising a list of ingredient content types that are entirely needed for cooking the food item, and the relative timing for their dispensing into the cookware (100 or 100x) of the cooking system (600 or 600x), wherein the relative timing is relative to the start times of the sub-programs in the “list of cooking sub-programs, second computer IDs and relative timings”. The start time of a cooking sub-program may be fixed or limited relative to the start times of some or all of the other sub-programs in the same list, and the relations among various start times are included in the list; but the list does not include sub-programs controlling the transport system 800.

In Step 863, store the information of the storage apparatus 191 including a list of positions for storing containers of food ingredients, in the database of the computer 901. Also store the information of the positions of the transport system 800 in all cooking systems in the database of the computer 901.

In Step 864, for each position of the container in the storage apparatus 191, and for each position of the vehicles 790 in the transport system 800, and for each cooking system (600 or 600x), the computer 901 stores in its database a “list of transfer and cap-opening sub-programs, IDs of the second computers and relative timings” for controlling functions of some motor(s) and/or other electric and electronic device(s) in the transfer apparatuses 220, the cap opening apparatus 370, the transport system 800, the container loading apparatuses 350, for the purpose that a container in the position in the storage apparatus 191 is transferred out, and is uncapped by a cap opening apparatus 370, and then is transferred to a position on the vehicle 790 of the transport system 800. As before, a sub-program here may include procedures for reading the information of some of the sensors or other electric or electronic devices and have the information sent to the computer system 909. The timing of a sub-program in the list may be fixed or limited relative to the timings of some of the other sub-programs in the same list, and the relations among various timings are included in the list. In some applications, the start times of sub-programs controlling the transport system 800 need to be limited, but not necessarily fixed relative to the start times of other sub-programs.

In Step 865, for each transport cart 194, the computer 901 stores in its database a “transport cart content information” which include the information of the containers of ingredients in the transport cart 194, including information of the barcode or QR code of the container, and the type of food ingredients contained in the container.

In Step 866, when a capped container 109 (or 109b) is moved by the transfer apparatus 220 from a transport cart 194 to a position in the storage box 192 of the storage apparatus 191, it passes through a position above the scanner 90F so that the scanner 90F can take an image of the QR code or barcode of the container, and then send the image to the computer system 909 as to decode the code. The computer system 909 matches the code with the container in the “transport cart content information,” and add the container to a “list of ingredient containers in storage,” which lists the container code, ingredient content type, position of the container in the storage apparatus 191.

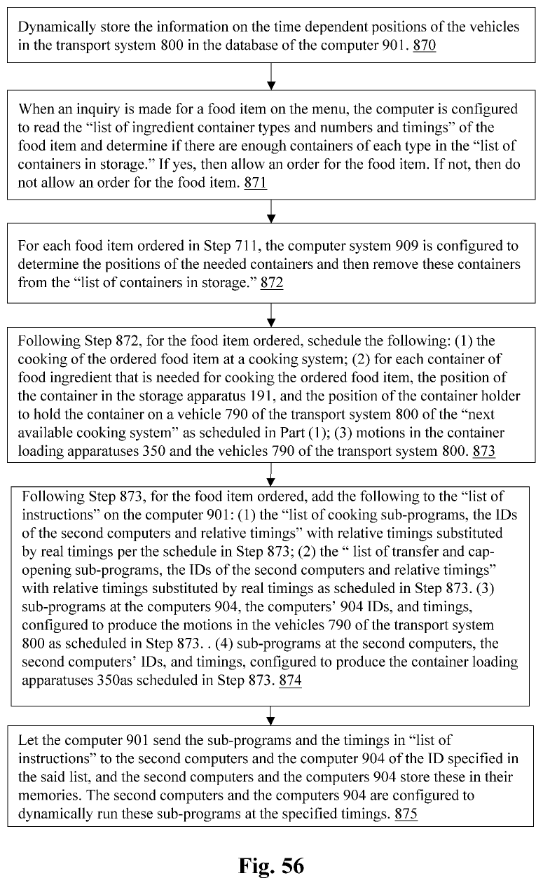

Referring to FIG. 56, the following tasks are performed by the computer system 909 of the cooking system 400.

In Step 870, the computer system 909 is configured to dynamically record in the database of the computer 901 the time dependent positions of the vehicles 790 in the transport system 800. The transport system 800 may optionally be run on a fixed schedule with exact timings, and in this case the information on the exact position of each holding cup of the vehicle 790 in the transport system 800 at any time is stored in the database of the computer 901.

In Step 871, when an inquiry is made for availability of a food item of the menu, usually by a person using another computer which is connected to the computer system 909, the computer system 909 is configured to read the “list of ingredient content types and numbers” of the food item and determine if there are enough containers containing the ingredient content types and numbers in the “list of containers of food ingredient in the storage apparatus 191” as required to cook the food item. If yes, then allow an order for the food item. If not, then do not allow an order for the food item.

In Step 872, for a food item ordered in Step 871, the computer system 909 determines the positions of the (capped) ingredient containers 109 (or 109b) in the storage apparatus 191 which are needed for cooking the food item and remove these containers from the “list of ingredient containers in storage.” If facing multiple choices, the computer system 909 may be programmed to prioritize the ingredient containers which are positioned above the other ingredient containers in the same compartment of the storage apparatus 191.

In Step 873, following Step 872, for the food item ordered, the computer system 909 is configured to schedule the following: (1) the cooking of the next ordered food item at a cooking system 600 or 600x, which can be a next available cooking system; (2) for each ingredient container containing the food ingredient that is needed for cooking the ordered food item, the position of the capped ingredient container 109 (or 109b) in the storage apparatus 191, the cap opening apparatus 370 to uncap the capped container 109 (or 109b), the position of the holding cup of the vehicle 790 in the transport system 800 at which position the uncapped container 107 can be transferred to the holding cup of the vehicle 790; (3) motions of the container loading apparatus 350 in the process of transferring the ingredient containers to their destinations at which position the ingredient containers can be transferred by the vehicle 790; (4) motions of the vehicle 790 in the process of transferring the ingredient containers to their destinations at which position the ingredients can be unloaded to the cookware 100 or 100x of the cooking system. The above schedule includes the start time of each sub-program in the list of cooking sub-programs or in the list of transfer and cap-opening sub-programs. The schedule also includes the timings for the ingredient containers to be transferred to and transferred out of the transport system 800.

In Step 874, the database of the computer 901 comprises a “list of instructions,” where each instruction includes a sub-program, the timing of the sub-program, and the identity of the second computer (902, 903, or 903x) to run the sub-program. Following Step 873, the computer system 909 adds the following to the list of instructions: (1) the “list of cooking sub-programs, the IDs of the second computers and relative timings” corresponding to the ordered food item, with times and IDs of the second computers scheduled in Step 873; (2) the “list of transfer and cap-opening sub-programs, IDs of the second computers and relative timings” with specified start times and IDs of the second computers as scheduled in Step 873; (3) sub-programs at the second computer (902, 903, or 903x) and timings, as to produce the necessary motions of container loading apparatuses 350 as scheduled in Step 873; wherein the information of the IDs of the second computers are included in the schedule; (4) sub-programs at the computers 904 and timings, as to produce the necessary motions of the vehicle 790 as scheduled in Step 873; wherein the information of the IDs of the computers 904 are included in the schedule.

In Step 875, the computer system 909 is configured to send the sub-program and timing in each new instruction in the “list of instructions” to the second computers (902, 903, and 903x), and the computers 904 whose IDs are listed in the instruction; and the information are stored by the second computer. The second computers (902, 903, and 903x) and the computers 904 are configured to dynamically run the sub-programs at specified timings as sent to them by the computer system 909. The computer system 909 is configured to communicate with the second computers and the computers 904, so that the instructions as described above can be sent by the first computer 901 to the second computers, and so that the information of the sensors and other electric or electronic devices received by the second computers and the computers 904 can be sent to the computer system 909 per instructions. There are known techniques to achieve such communications, whether by wires or by wireless means.

In the above discussed kitchen systems, the dispensing apparatus is configured to dispense all the food ingredients in an opened ingredient container at once.

It should be noted that a motor in the present patent application may be an AC or DC motor, stepper motor, servo motor, inverter motor, pneumatic or hydraulic motor, etc. A motor may optionally further comprise a speed reducer, encoder, and/or proximity sensor.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

A support component described in the present patent application can be any type of rigid component. A support component may be moved or fixed relative to the ground. A rigid component may comprise one or more of the following: a bar, a tube, a beam, a board, a frame, a structure, a bearing housing, a shaft. A rigid component can be made by metal such as steel or aluminum, or by other materials, or by a combination of several types of materials.

Only a few examples and implementations are described. Other implementations, variations, modifications and enhancements to the described examples and implementations may be made without deviating from the spirit of the present invention. For example, the term cookware is used to generally refer to a device for containing or holding food ingredients during cooking. For the purpose of present patent application, a cookware can be a wok, a pot, a pan, a basket, a bowl, a container, a board, a rack, a net, or any object used to contain or otherwise hold food or food ingredients during a cooking process. The cooking also is not limited to any particular ethnic styles. The cooking may include but is not limited to frying (including stir frying), steaming, boiling, roasting, baking, smoking, microwaving, etc. The cooking apparatus may or may not use a heater.

Similarly, a food container, ingredient container, or container, can be a bowl, a plate, a cup, ajar, a bottle, a flat or curved board, a basket, a net, a wok, a pan, or any object used to contain or otherwise hold a food or food ingredients. A container can have a rather arbitrary geometric shape.

For the purpose of the present patent application, a connection of a computer (or computer system) and an electric or electronic component may compromise a wired and/or wireless connection between the computer (or computer system) and the electric or electronic device, as to allow the computer to communicate with said electric or electronic component. A connection of a computer (or computer system) and a mechanism or apparatus may comprise a wired and/or wireless connection between the computer (or computer system) and some (or all) of the electric or electronic components of the mechanism or apparatus as to allow the computer to communicate with said electric or electronic components.

What is claimed is:

1. A kitchen system, comprising.
a computer system comprising a first computer;
a plurality of ingredient containers, each configured to contain or otherwise hold food or food ingredients;
a storage apparatus configured to store said ingredient containers;
a cooking system comprising:
a cookware configured to contain or otherwise hold food or food ingredients;
a dispensing apparatus comprising:
one or more grippers configured to grip a said ingredient container; and
a motion mechanism configured to move said grippers;
said dispensing apparatus being configured to move said ingredient container of food ingredients as to dispense food ingredients from the ingredient container to the cookware;
a plurality of vehicles, each configured to transport one or more said ingredient containers; and
a loading apparatus comprising:
one or more grippers configured to grip a said ingredient container; and
a first motion mechanism comprising a support component and a motor, said motor being configured to be connected to the computer system as to allow the computer system to control said motor;
said loading apparatus being configured to load a said ingredient container to a said vehicle.

2. The kitchen system of claim 1, further comprising a storage room configured to contain the storage apparatus, said storage room comprising a wall, said wall being configured to have an opening as to allow a vehicle to move from the inside of the storage room to the outside.

3. The kitchen system of claim 2, further comprising:
a solid component configured to close the opening of the wall of the storage room for the purpose of limiting the heat flow between the inside of the storage room and the outside; and
a motion mechanism configured to move said solid component.

4. The kitchen system of claim 1, wherein each said vehicle further comprises a holder configured to position or hold an ingredient container.

5. The kitchen system of claim 1, further comprises a stopping mechanism configured to stop a vehicle, said stopping mechanism being configured to be connected to the computer system as to allow the computer system to control said stopping mechanism.

6. The kitchen system of claim 1, wherein the cooking system further comprises a motion mechanism comprising a motor configured to move the cookware, said motor being configured to be connected to the computer system as to allow the computer system to control said motor.

7. The kitchen system of claim 1, wherein each of the plurality of ingredient containers comprises a code, the kitchen system further comprising a code reader configured to read the code of an ingredient container, wherein the code reader is configured to be connected to the computer system as to allow the computer system to receive information from the code reader.

8. The kitchen system of claim 1, further comprising one or more rail tracks, wherein each said vehicle is configured to move on the rail tracks.

9. The kitchen system of claim 8, further comprising a track switch mechanism, said track switch mechanism comprising a motor configured to be connected to the computer system as to allow the computer system to control said motor.

10. The kitchen system of claim 1, wherein the computer system comprises a plurality of second computers configured to be connected to the first computer as to allow the first computer to send information to the second computers, the kitchen system further comprising connections between each said second computer to some electric or electronic devices in the kitchen system as to allow the second computer to control said electric or electronic devices.

11. The kitchen system of claim 1, wherein the computer system is configured to store a food item that can be cooked by the kitchen system, wherein the cooking of the food item is configured to use the entire ingredient contents of one or more ingredient containers of food ingredients.

12. The kitchen system of claim 11, wherein the computer system is configured to store:
a classification of ingredient contents into different ingredient content types, wherein each ingredient content type comprises the information on the types of the food ingredients and their quantities that can be contained in a single ingredient container; and
the number of ingredient containers of food ingredients and the corresponding ingredient content types that are entirely used for the cooking of the food item.

13. The kitchen system of claim 1, wherein the computer system is configured to store a food item, and a cooking program for making the food item, said program being configured to control some of the electric or electronic devices in the kitchen system.

14. The kitchen system of claim 1, wherein the loading apparatus further comprises a second motion mechanism comprising a motor configured to produce a motion of the support component of the first motion mechanism of the loading apparatus, said motor being configured to be connected to the computer system as to allow the computer system to control said motor.

15. The kitchen system of claim 1, wherein the dispensing apparatus of the cooking system is configured to grip and hold a container, and to turn the container for the purpose of dispensing the food ingredient from said container to the cookware of the cooking system.

16. A kitchen system, comprising:
a computer system comprising a first computer;
a plurality of ingredient containers, each configured to hold food or food ingredients, wherein some of the ingredient containers are configured to be capped by caps;
a storage apparatus configured to store said ingredient containers;
a cap opening apparatus configured to remove a cap from an ingredient container, said cap opening apparatus comprising:
a cap gripping mechanism comprising a support component and one or more grippers, said grippers being configured to grip and hold a cap, wherein the gripping mechanism is configured to be connected to the computer system as to allow the computer system to control said mechanism apparatus;
a container gripping mechanism comprising a support component and one or more grippers, said grippers being configured to grip and hold a container, wherein the container gripping mechanism is configured to be connected to the computer system as to allow the computer system to control said mechanism apparatus;
a motion mechanism configured produce a relative motion between the support component of the cap gripping mechanism and the support component of the container gripping mechanism; said motion mechanism comprising:
a first motion sub-mechanism comprising a motor configured to produce a relative motion, said motor being configured to be connected to the computer system as to allow the computer system to control said motor; and
a second motion sub-mechanism comprising a motor configured to produce a relation motion, said motor being configured to be connected to the computer system as to allow the computer system to control said motor; and
a cooking system comprising:
a cookware configured to contain or otherwise hold food or food ingredients; and
a dispensing apparatus comprising:
one or more grippers configured to grip a said uncapped ingredient container; and
a motion mechanism comprising a motor configured to move said grippers;
said dispensing apparatus being configured to grip and move said container as to dispense the food ingredients from the ingredient container to the cookware; and move a capped ingredient container.

17. The kitchen system of claim 16, further comprising a transfer apparatus comprising:
a container gripping mechanism comprising a first support component and one or more grippers, said grippers being configured to grip and hold a capped ingredient container, wherein the container gripping mechanism is configured to be connected to the computer system as to allow the computer system to control said mechanism apparatus;
a first motion mechanism comprising a second support component and a motor configured to produce a motion of the first support component relative to the second support component, said motor being configured to be connected to the computer system as to allow the computer system to control said motor; and
a second motion mechanism comprising a third support component and a motor configured to produce a motion of the second support component of the first motion mechanism relative to the third support component, wherein said motor is configured to be connected to the computer system as to allow the computer system to control said motor.

18. The kitchen system of claim 17, wherein the transfer apparatus further comprises a third motion mechanism comprising a motor configured to produce a motion of the third support component of the loading apparatus, wherein said motor is configured to be connected to the computer system as to allow the computer system to control said motor.

19. The kitchen system of claim 16, wherein the container gripping mechanism of the transfer apparatus comprises a vacuum chuck configured to be connected to the computer system as to allow the computer system to control said mechanism apparatus.

20. A kitchen system, comprising.
a computer system comprising a first computer;
a plurality of ingredient containers, wherein each ingredient container is configured to contain or otherwise hold food or food ingredients;
a storage apparatus configured to store said ingredient containers;
a cooking system comprising:
a cookware configured to contain or otherwise hold food or food ingredients;
a first motion mechanism comprising a support component and a motor configured to move the cookware as to stir or mix the food or food ingredients contained in the cookware, said motor being configured to be connected to the computer system as to allow the computer system to control said motor;
a second motion mechanism comprising a motor configured to move the support component of the first motion mechanism, sad motor being configured to be connected to the computer system as to allow the computer system to control said motor; and
a dispensing apparatus comprising:
one or more grippers configured to grip a said ingredient container; and
a motion mechanism comprising a motor configured to move said grippers;
said dispensing apparatus being configured to grip and move said container as to dispense food ingredients from the container to the cookware; and
a plurality of vehicles, each configured to transport one or more said ingredient containers.
